(19) United States
(12) Patent Application Publication
(10) Pub. No.: US 2015/0378557 A1
(43) Pub. Date: Dec. 31, 2015

(54) FOLDABLE ELECTRONIC APPARATUS AND INTERFACING METHOD THEREOF

(71) Applicant: SAMSUNG ELECTRONICS CO., LTD., Suwon-si (KR)

(72) Inventors: Hee-seok JEONG, Suwon-si (KR); Ji-hyun JUNG, Yongin-si (KR); Kyu-hyun CHO, Suwon-si (KR); Hyun-sub PARK, Suwon-si (KR); Dae-myung KIM, Hwaseong-si (KR)

(73) Assignee: SAMSUNG ELECTRONICS CO., LTD., Suwon-si (KR)

(21) Appl. No.: 14/751,767

(22) Filed: Jun. 26, 2015

Related U.S. Application Data
(60) Provisional application No. 62/087,876, filed on Dec. 5, 2014.
(60) Provisional application No. 62/017,503, filed on Jun. 26, 2014.

(30) Foreign Application Priority Data
Feb. 10, 2015 (KR) 10-2015-0020285
May 29, 2015 (KR) 10-2015-0076487

(51) Int. Cl. G06F 3/0481; G06F 3/0488; G06F 3/0484

(52) U.S. Cl. CPC G06F 3/04817; G06F 3/04842; G06F 3/0488

(57) ABSTRACT

A foldable electronic apparatus and an interfacing method thereof are provided. The foldable electronic apparatus includes a display configured to be foldable, a detector configured to detect whether the display is folded, and a controller configured to control the display to display an interface on an accessible region of the display, in response to the detector detecting that the display is folded.

### CROSS-REFERENCE TO RELATED APPLICATIONS

This application claims the benefit of U.S. Provisional Application Nos. 62/017,503, filed on Jun. 26, 2014, and 62/087,876, filed on Dec. 5, 2014, in the U.S. Patent and Trademark Office, and claims priority from Korean Patent Application Nos. 10-2015-0020285, filed on Feb. 10, 2015, and 10-2015-0076487, filed on May 29, 2015, in the Korean Intellectual Property Office, the disclosures of which are incorporated herein by reference in their entireties.

### BACKGROUND

1. Field

Apparatuses and methods consistent with exemplary embodiments relate to a foldable electronic apparatus and an interfacing method thereof.

2. Description of the Related Art

With the advancement of display technology, a flexible display, a transparent display panel, etc. have been developed. A flexible display refers to a display device that is bendable.

A flexible display may flexibly fold and unfold because the flexible display uses a plastic film, instead of a glass substrate that surrounds liquid crystals in an existing liquid-crystal display (LCD) or an organic light-emitting diode (OLED) display. Such a flexible display may be manufactured to have any of various shapes.

For example, a flexible display may be applied to an information technology (IT) product such as a mobile phone that may fold or roll to be carried or an ultra-small PC, and to an electronic book that may be a substitute for a publication such as a magazine, a textbook, a book, or a comic book. Also, because a flexible display uses a flexible plastic substrate, the flexible display may also be applied to wearable clothing and medical diagnostic devices.

As a flexible display has been commercialized, new interfacing methods for a foldable or rollable electronic apparatus have been studied by using the flexibility or foldability of the flexible display.

### SUMMARY

Exemplary embodiments address at least the above problems and/or disadvantages and other disadvantages not described above. Also, the exemplary embodiments are not required to overcome the disadvantages described above, and may not overcome any of the problems described above.

Exemplary embodiments provide a foldable electronic apparatus that includes a flexible display and is asymmetrically bendable, and an interfacing method of the foldable electronic apparatus. Exemplary embodiments also provide a computer-readable recording medium having embodied thereon a program for executing the interfacing method.

According to an aspect of an exemplary embodiment, there is provided a foldable electronic apparatus including a display configured to be foldable, a detector configured to detect whether the display is folded, and a controller configured to control the display to display an interface on an accessible region of the display, in response to the detector detecting that the display is folded.

The detector may be further configured to detect that the display is folded along a folding line so that surfaces of the display that face each other have different sizes.

The controller may be further configured to, in response to the detector detecting that the display is folded, activate the accessible region, and inactivate a region other than the accessible region of the display.

The detector may be further configured to detect a size of the accessible region, and the controller may be further configured to determine a size and a number of at least one interface element to be displayed in the interface, based on the detected size of the accessible region.

The interface may include an interface element that indicates a missed call, and information about a caller of the missed call.

The interface may include number interface elements for inputting a telephone number, or letter interface elements for inputting a name, and the controller may be further configured to control the display to change a number to be set in the number interface elements, or a letter to be set in the letter interface elements, based on a pressure intensity of a touch input.

The interface may include an interface element that indicates address book information, and the controller may be further configured to control the display to change a speed at which the address book information is changed, based on a pressure intensity of a touch input.

The interface may include an interface element that indicates an incoming call, and information about a caller of the incoming call, and the controller may be further configured to accept and block the incoming call, based on a pressure intensity of a touch input.

The interface may include information about an incoming message, and the controller may be further configured to control the display to display, on the accessible region, content of the incoming message and information about a sender of the incoming message, as a pressure intensity of a touch input on the information about the incoming message increases.

The interface may include at least one among a first icon that indicates time information, a second icon that indicates weather information, a third icon that indicates an alert mode, and a fourth icon that indicates a battery level of the foldable electronic apparatus, and in response to an input selecting one among the first icon, the second icon, the third icon, and the fourth icon, the controller may be further configured to control the display to display, on the accessible region, detailed information corresponding to the selected one among the first icon, the second icon, the third icon, and the fourth icon.

The interface may include an interface element and a screen switch icon, and the controller may be further configured to control the display to move and change the interface element, in response to an input selecting the screen switch icon.

The display may be further configured to receive a touch input including at least one among a tap gesture, a touch and hold gesture, a double tap gesture, a drag gesture, a panning gesture, a flick gesture, and a drag and drop gesture.

The controller may be further configured to recognize the touch input, based on a pressure intensity of the touch input.

According to an aspect of another exemplary embodiment, there is provided an interfacing method of a foldable electronic apparatus, the interfacing method including detecting whether a display of the foldable electronic apparatus is folded, and displaying an interface on an accessible region of the display, in response to the detecting that the display is folded.

The detecting may include detecting that the display is folded along a folding line so that surfaces of the display that face each other have different sizes.

The interfacing method may further include, in response to the detecting that the display is folded, activating the accessible region, and inactivating a region other than the accessible region of the display.

The interfacing method may further include detecting a size of the accessible region, and determining a size and a number of at least one interface element to be displayed in the interface, based on the detected size of the accessible region.

The interface may include number interface elements for inputting a telephone number, or letter interface elements for inputting a name, and the displaying may include changing a number to be set in the number interface elements, or a letter to be set in the letter interface elements, based on a pressure intensity of a touch input.

The interface may include an interface element that indicates address book information, and the displaying may include changing a speed at which the address book information is changed, based on a pressure intensity of a touch input.

The interface may include an interface element that indicates an incoming call, and information about a caller of the incoming call, and the interfacing method may further include accepting and blocking the incoming call, based on a pressure intensity of a touch input.

The interface may include information about an incoming message, and the displaying may include displaying, on the accessible region, content of the incoming message and information about a sender of the incoming message, as a pressure intensity of a touch input on the information about the incoming message increases.

The interface may include at least one among a first icon that indicates time information, a second icon that indicates weather information, a third icon that indicates an alert mode, and a fourth icon that indicates a battery level of the foldable electronic apparatus, and in response to an input selecting one among the first icon, the second icon, the third icon, and the fourth icon, the displaying may include displaying, on the accessible region, detailed information corresponding to the selected one among the first icon, the second icon, the third icon, and the fourth icon.

The interface may include an interface element and a screen switch icon, and the displaying may include moving and changing the interface element, in response to an input selecting the screen switch icon.

The interfacing method may further include receiving a touch input including at least one among a tap gesture, a touch and hold gesture, a double tap gesture, a drag gesture, a panning gesture, a flick gesture, and a drag and drop gesture.

The interfacing method may further include recognizing the touch input, based on a pressure intensity of the touch input.

A computer-readable storage medium may store a program including instructions configured to control a computer to execute the interfacing method.

According to an aspect of another exemplary embodiment, there is provided a foldable electronic apparatus including a display configured to be foldable, and a controller configured to control the display that is folded to display a first operating system on an accessible region of the display, detect whether the display is unfolded, and control the display to display a second operating system on the accessible region, in response to the controller detecting that the display is unfolded.

The controller may be further configured to determine whether an angle at which the display is unfolded is greater than or equal to a value, and control the display to display the second operating system on the accessible region, in response to the controller determining that the angle is greater than or equal to the value.

According to an aspect of another exemplary embodiment, there is provided a foldable electronic apparatus including a flexible display, a sensor configured to sense an asymmetrical folding of the flexible display, a controller configured to determine a dimension of the asymmetrical folding, determine a portion of the asymmetrically folded flexible display that is accessible to a user for accepting an input, based on the dimension, and display an interface on the portion.

### BRIEF DESCRIPTION OF THE DRAWINGS

The above and/or other aspects will be more apparent by describing certain exemplary embodiments with reference to the accompanying drawings in which:

FIG. 1 is a view illustrating an electronic apparatus according to an exemplary embodiment;

FIG. 2 is a block diagram illustrating an electronic apparatus according to an exemplary embodiment;

FIG. 3 is a flowchart illustrating an interfacing method of an electronic apparatus, according to an exemplary embodiment;

FIGS. 4A through 4C are views illustrating a method and apparatus for receiving a user's touch input through an exposed region according to exemplary embodiments;

FIG. 5 is a table showing a touch input that is distinguished by a controller of FIG. 2, according to an exemplary embodiment;

FIG. 6 is a flowchart illustrating a method performed by an electronic apparatus to display at least one object on an exposed region, according to an exemplary embodiment;

FIGS. 7A and 7B are views illustrating examples where an electronic apparatus displays a lock screen on an exposed region accordingly to exemplary embodiments;

FIG. 8 is a diagram illustrating an example where an electronic apparatus displays a state screen and an application icon for performing a call function on an exposed region accordingly to an exemplary embodiment;

FIG. 9 is a diagram illustrating an example where an electronic apparatus displays a state screen and an application icon for performing a call function on an exposed region accordingly to an exemplary embodiment;

FIG. 10 is a flowchart illustrating a method performed by an electronic apparatus to display an object that indicates a missed call and a message alert, according to an exemplary embodiment;

FIGS. 11A and 11B are views illustrating an example where an electronic apparatus displays an object that indicates a missed call on an exposed region according to an exemplary embodiment;

FIGS. 12A and 12B are views illustrating an example where an electronic apparatus displays an object that indicates a message alert on an exposed region according to an exemplary embodiment;

FIG. 13 is a flowchart illustrating an interfacing method performed by an electronic apparatus to make a call in a folding state, according to an exemplary embodiment;

FIGS. 14A through 14D are views illustrating examples where an electronic apparatus executes a call application through an exposed region according to exemplary embodiments;

FIGS. 15A through 15C are views illustrating examples where an electronic apparatus executes an address book application through an exposed region according to exemplary embodiments;

FIG. 16 is a flowchart illustrating an interfacing method performed by an electronic apparatus to receive a call in a folding state, according to an exemplary embodiment;

FIGS. 17A and 17B are views illustrating examples where an electronic apparatus provides a user interface for an incoming call in a folding state according to exemplary embodiments;

FIGS. 18 and 19 are views illustrating an electronic apparatus according to an exemplary embodiment;

FIG. 20 is a flowchart illustrating an interfacing method of an electronic apparatus that may bend along a plurality of folding lines, according to an exemplary embodiment;

FIG. 21 is a diagram illustrating an example where an electronic apparatus that may bend along a plurality of folding lines displays at least one object according to an exemplary embodiment;

FIG. 22 is a diagram illustrating an example where an electronic apparatus displays at least one object, according to an exemplary embodiment;

FIG. 23 is a diagram illustrating an example where an electronic apparatus displays at least one object, according to another exemplary embodiment;

FIG. 24 is a diagram illustrating an example of the electronic apparatus of FIG. 19;

FIG. 25 is a diagram illustrating an example of the electronic apparatus of FIG. 19;

FIG. 26 is a block diagram illustrating an electronic apparatus according to an exemplary embodiment;

FIG. 27 is a diagram illustrating an electronic apparatus including a flexible display, according to an exemplary embodiment;

FIG. 28A is a view illustrating a method of detecting an unfolding operation of an electronic apparatus, according to an exemplary embodiment;

FIG. 28B is a view illustrating a method of detecting an unfolding operation of an electronic apparatus, according to another exemplary embodiment;

FIG. 29A is a view illustrating a method performed by an electronic apparatus to detect an unfolding operation, according to another exemplary embodiment;

FIG. 29B is a view illustrating a method performed by an electronic apparatus to detect an unfolding operation, according to another exemplary embodiment;

FIGS. 30A and 30B are diagrams illustrating a method performed by a controller to detect an unfolding operation, according to an exemplary embodiment;

FIG. 31 is a flowchart illustrating a method performed by an electronic apparatus to provide a driving screen of at least one operating system (OS), according to an exemplary embodiment;

FIG. 32 is a flowchart illustrating a method performed by an electronic apparatus to change a driving screen of a first OS into a driving screen of a second OS, and display the driving screen of the second OS through a system re-booting process, according to an exemplary embodiment;

FIG. 33 is a diagram illustrating an example where an electronic apparatus changes a driving screen of a first OS into a driving screen of a second OS, and displays the driving screen of the second OS through a system re-booting process, according to an exemplary embodiment;

FIG. 34 is a diagram an example where an electronic apparatus changes a driving screen of a first OS into a driving screen of a second OS, and displays the driving screen of the second OS through a system re-booting process, according to another exemplary embodiment;

FIG. 35 is a flowchart illustrating a method performed by an electronic apparatus to change a driving screen of a first OS into a driving screen of a cloud OS, and display the driving screen of the cloud OS, according to an exemplary embodiment;

FIG. 36 is a diagram illustrating an example where as an electronic apparatus unfolds, the electronic apparatus displays a driving screen of a cloud OS, according to an exemplary embodiment;

FIG. 37 is a diagram illustrating an example where as an electronic apparatus unfolds, the electronic apparatus displays a driving screen of a cloud OS, according to another exemplary embodiment;

FIG. 38 is a flowchart illustrating a method performed by an electronic apparatus to drive at least one virtual OS as the electronic apparatus unfolds, according to an exemplary embodiment;

FIG. 39 is a diagram illustrating an example where as an electronic apparatus unfolds, the electronic apparatus drives at least one virtual OS, according to an exemplary embodiment;

FIG. 40 is a diagram illustrating an example where an electronic apparatus changes a size of a driving screen of a virtual OS, according to an exemplary embodiment;

FIG. 41 is a view illustrating a method performed by an electronic apparatus employing a rollable display to change an OS that is driven in the electronic apparatus, according to an exemplary embodiment;

FIG. 42 is a view illustrating a method performed by an electronic apparatus employing a flexible display having a fan shape to change an OS that is driven in the electronic apparatus, according to an exemplary embodiment;

FIG. 43 is a flowchart illustrating a method performed by an electronic apparatus to dynamically change an application list as the electronic apparatus unfolds in a state where the application list is displayed on a screen of the electronic apparatus, according to an exemplary embodiment;

FIG. 44 is a view illustrating an example where as an electronic apparatus unfolds, an application list that is displayed on a screen of the electronic apparatus is dynamically changed, according to an exemplary embodiment;

FIG. 45 is a flowchart illustrating a method performed by an electronic apparatus to display alert information, according to an exemplary embodiment;

FIGS. 46 through 48 are views illustrating examples where an electronic apparatus displays alert information based on information about a user's hand according to exemplary embodiments;

FIG. 49 is a flowchart illustrating a method performed by an electronic apparatus to display an execution screen of an application corresponding to alert information, in response to a user input, according to an exemplary embodiment;

FIG. 50 is a view illustrating an example where a controller controls an execution screen of an application corresponding to alert information to be displayed, according to an exemplary embodiment;

FIG. 51 is a view illustrating an example where a controller provides a graphical user interface (GUI), according to an exemplary embodiment;

FIG. 52 is a flowchart illustrating a method performed by an electronic apparatus to provide an execution screen of an application according to a user input, according to an exemplary embodiment;

FIG. 53 is a view illustrating an example where an input unit receives a user input, according to an exemplary embodiment;

FIG. 54 is a view illustrating an example where a controller controls a speed at which a screen is switched according to a user input that passes through a folding line, according to an exemplary embodiment;

FIGS. 55A through 55C are views illustrating examples where an electronic apparatus switches a screen according to a user input that is received while an e-book application is being executed, according to an exemplary embodiment;

FIG. 56 is a flowchart illustrating a method performed by an electronic apparatus that unfolds at an angle less than a critical angle to provide an execution screen of an application, according to an exemplary embodiment; and

FIG. 57 is a view illustrating an example where an electronic apparatus provides an execution screen of an application, according to an exemplary embodiment.

### DETAILED DESCRIPTION OF THE EXEMPLARY EMBODIMENTS

Exemplary embodiments are described in greater detail herein with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail since they would obscure the description with unnecessary detail.

It will be understood that the terms “comprises” and/or “comprising” used herein specify the presence of stated features or components, but do not preclude the presence or addition of one or more other features or components. In addition, the terms such as “unit,” “-er (-or),” and “module” described in the specification refer to an element for performing at least one function or operation, and may be implemented in hardware, software, or the combination of hardware and software.

Also, the term “user input” used herein may include, but is not limited to, at least one among a touch input, a bending input, a voice input, a button input, and a multimodal input.

Also, the term “touch input” used herein may be a touch gesture of a user performed on a touchscreen to control an electronic apparatus. Examples of the touch input used herein may include, but are not limited to, a tap gesture, a touch and hold gesture, a double tap gesture, a drag gesture, a panning gesture, a flick gesture, and a drag and drop gesture.

Also, according to an exemplary embodiment, an electronic apparatus may detect a touch position (e.g., coordinates), a touch speed, a touch intensity, and a touch duration time by using at least one among a capacitive sensor and a resistive sensor.

Also, the term “application” used herein may refer to a set of computer programs that are designed to provide a service.

As used herein, the term “and/or” includes any and all combinations of one or more of the associated listed items. Expressions such as “at least one among,” when preceding a list of elements, modify the entire list of elements and do not modify the individual elements of the list.

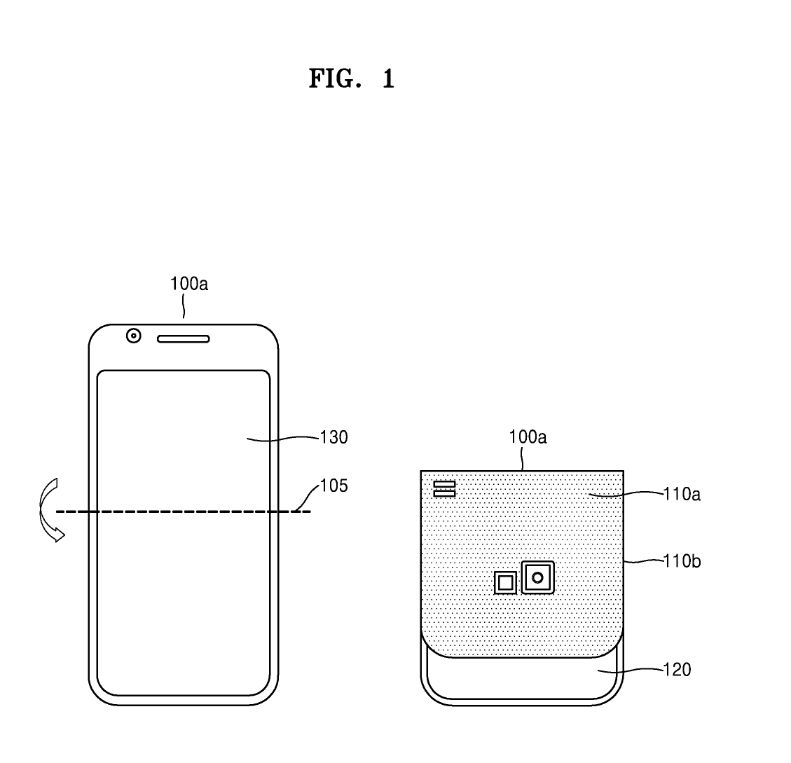

FIG. 1 is a view illustrating an electronic apparatus 100a according to an exemplary embodiment.

The electronic apparatus 100a employs a flexible display that asymmetrically bends as shown in FIG. 1. For example, the electronic apparatus 100a may employ any of various flexible displays such as a foldable display 130 that may fold and unfold at an angle or a curvature or a bendable display that may bend and unfold at a curvature. Although the following will be explained with the electronic apparatus 100a of FIG. 1 being a foldable electronic apparatus including the foldable display 130, the present exemplary embodiment is not limited thereto.

The term “folding state” used herein may refer to a state where when the electronic apparatus 100a folds along a folding line 105, two portions of the electronic apparatus 100a may be completely parallel to each other or substantially parallel to each other. Also, when the electronic apparatus 100a is in a folding state, it may mean that when the electronic apparatus folds along the folding line 105, facing surfaces 110a and 110b of the two portions of the electronic apparatus 100a do not have to contact each other but are very close to each other.

Sizes or areas of the two portions of the electronic apparatus 100a that are divided by the folding line 105 may be different from each other. Accordingly, in a folding state, the facing surfaces 110a and 110b of the foldable display 130 that are divided by the folding line 105 may have different sizes. Accordingly, even when the electronic apparatus 100a is in the folding state, the electronic apparatus 100a may expose a region 120 of the foldable display 130 to the outside. In other words, the region 120 is visible.

Also, the electronic apparatus 100a may provide a lock screen, a state screen a call receiving/making screen, and a message receiving screen by using the region 120 of the foldable display 130 that is not covered when the electronic apparatus 100a is in the folding state. For convenience of explanation, hereinafter, the region 120 of the foldable display 130 that is exposed to the outside when the electronic apparatus 100a is in the folding state will be referred to as, but is not limited to, an exposed region.

Although the electronic apparatus 100a is a smartphone in FIG. 1, the present exemplary embodiment is not limited thereto. For example, the electronic apparatus 100a of FIG. 1 may be any of other various devices such as a tablet PC, a notebook computer, a wearable device, and an electronic book. Also, the electronic apparatus 100a may include a hinge and a bending structure formed of a flexible material that is provided on the folding line 105.

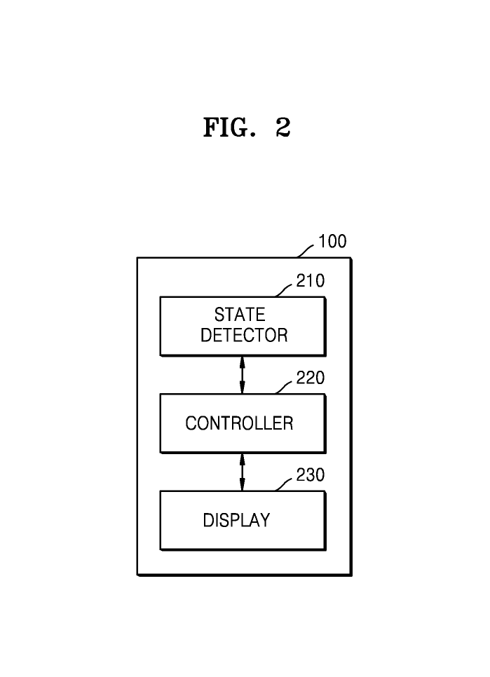

FIG. 2 is a block diagram illustrating an electronic apparatus 100 according to an exemplary embodiment.

Referring to FIG. 2, the electronic apparatus 100 includes a state detector 210, a controller 220, and a foldable display 230.

The state detector 210 may detect whether the display 230 folds. For example, the state detector 210 may detect a folding state of a main housing of the electronic apparatus 100 that folds along with the display 230 by using a hall sensor or a magnetic sensor that is provided on the folding structure.

The state detector 210 may measure a bending or folding angle of the main housing. When the electronic apparatus 100 includes a hinge structure, the state detector 210 may measure a folding angle at the hinge structure. Alternatively, the state detector 210 may detect a folding state by using a state detection sensor that is disposed at a point where two portions of the main housing are closer to each other as the main housing bends or folds. The state detection sensor may include at least one among a proximity sensor, an illumination sensor, a hall sensor, a touch sensor, a bending sensor, and an infrared sensor, or a combination thereof. Also, the state detector 210 may detect a position of a folding line along which the main housing bends or folds. The state detector 210 may determine a folding state according to the position of the folding line.

The state detector 210 may determine the folding state and may transmit a result of the determination to the controller 220. In this case, the controller 220 may know whether the electronic apparatus 100 is in the folding state or an unfolding state according to an output of the state detector 210 without additionally determining whether the electronic apparatus 100 is in the folding state or the unfolding state. Alternatively, the state detector 210 may transmit information along a bending or folding angle or sensing information of the state detection sensor to the controller 220 and the controller 220 may determine whether the electronic apparatus 100 is in the folding state or the unfolding state.

Also, the state detector 210 may detect a size or an area of a region of the display 230 that is exposed to the outside when the display 230 is in the folding state. The state detector 210 may transmit a result of the detection to the controller 220.

The controller 220 may control an overall operation of the electronic apparatus 100. For example, the controller 220 may execute and control an operating system (OS) of the electronic apparatus 100, may process various data, and may control elements of the electronic apparatus 100.

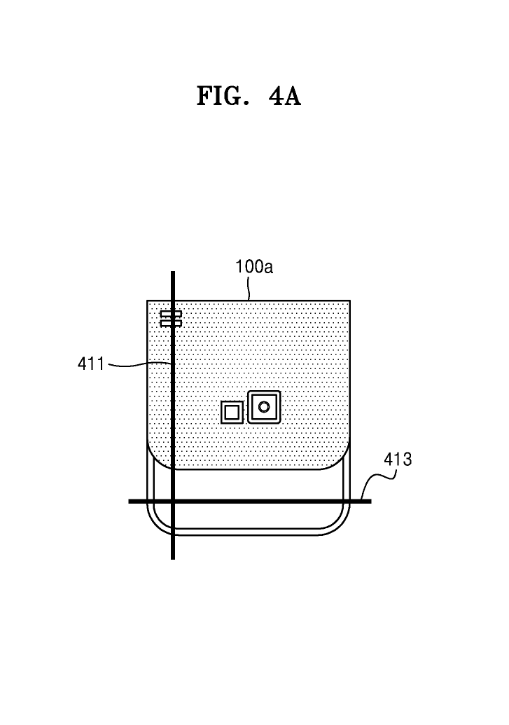

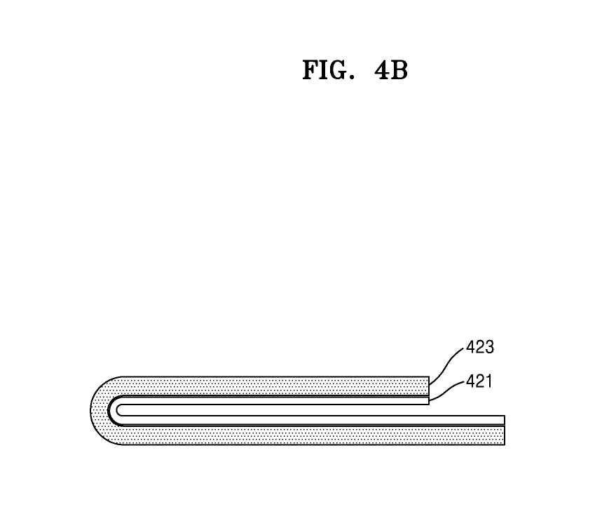

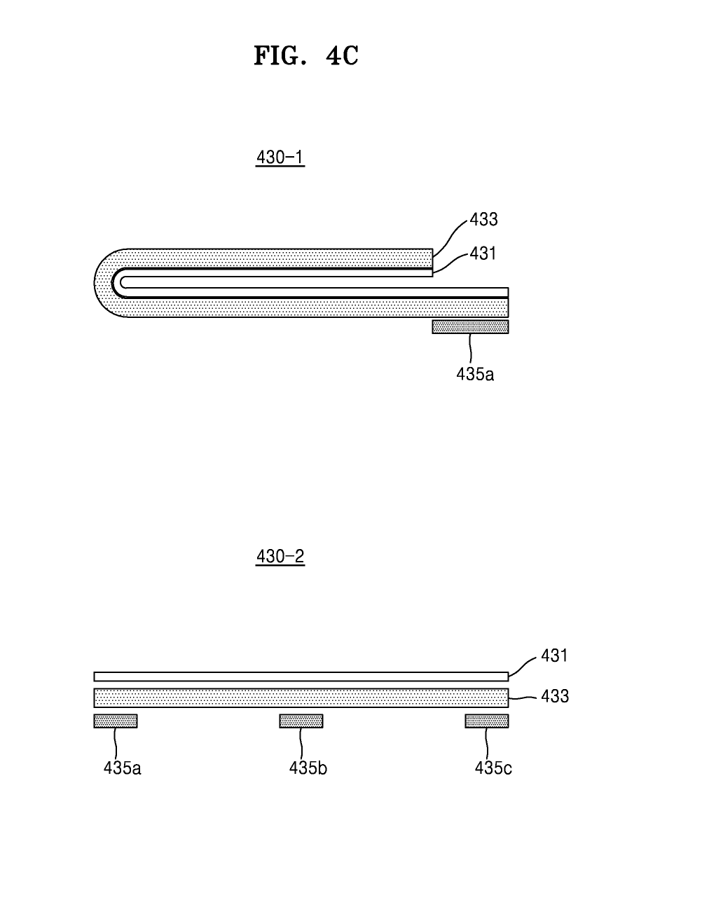

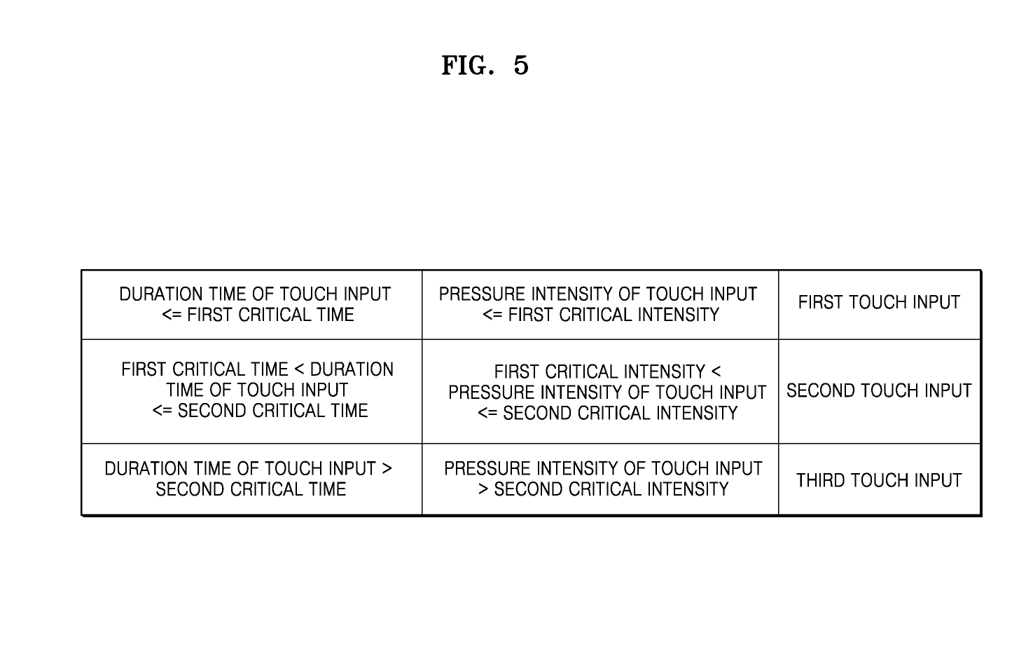

The controller 220 activates the region (e.g., the exposed region 120 of FIG. 1) of the display 230 that is exposed to the outside in the folding state based on a result of the determination transmitted from the state detector 210. The controller 220 may activate a touch function on the exposed region 120, and may inactivate a touch function on a non-exposed region of the display 230. Also, the controller 220 may distinguish a touch input based on at least one among a duration time of the touch input and a pressure intensity of the touch input. A method and apparatus used by the electronic apparatus 100 to receive a touch input through the exposed region 120 will be explained below in detail with reference to FIGS. 4A through 5.

Also, the controller 220 controls the display 230 to display at least one object or interface element on the exposed region 120. The term “object” may refer to an object that may be selected by a user or an object that indicates alert information. The object may include an image, a text, and/or a video, for example, an icon, a button, an index item, link information, and/or an execution screen of an application.

For example, when the electronic apparatus 100 is in the folding state, the controller 220 may control the display 230 to display a user interface for performing a call function, an object that indicates message alert information, a lock screen, or a state screen on a screen. In detail, when the electronic apparatus 100 is in the folding state, the controller 220 may control the display 230 to display on the screen an object that indicates a missed call or an incoming call, an object that indicates information about a sender, or an object as a call application or an address book application is executed. Also, the controller 220 may vary a size and a number of at least one object that is displayed on the exposed region 120 according to a size or an area of a region of the display 230 that is exposed to the outside.

The display 230 may asymmetrically or symmetrically fold, and displays at least one object on the region (for example, the exposed region 120 of FIG. 1) that is exposed to the outside in the folding state. For example, the display 230 may display on the exposed region 120 an execution screen of a call application or a address book application that is being executed in the controller 220, an object that indicates a missed call or an incoming call, message alert information, or a state icon that indicates a state of the electronic apparatus 100.

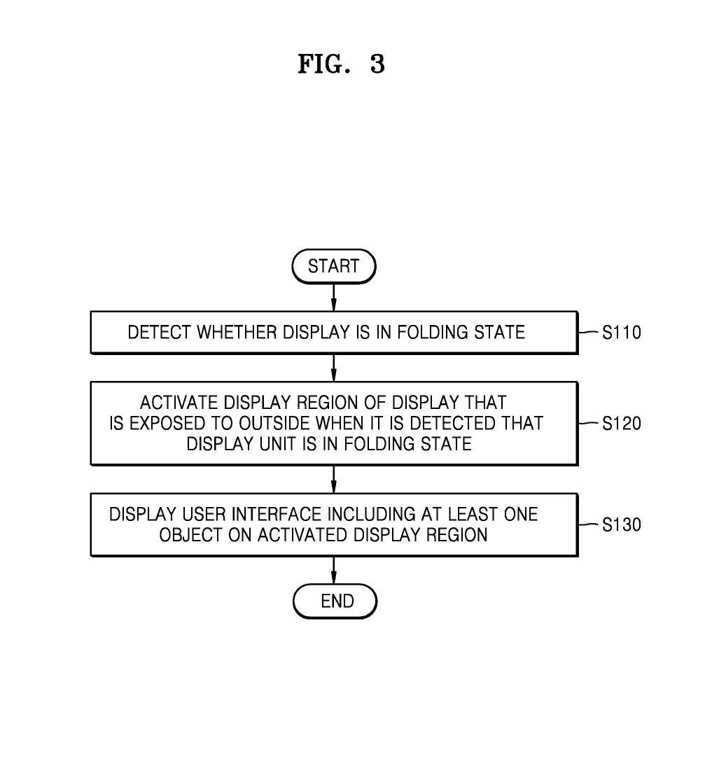

FIG. 3 is a flowchart illustrating an interfacing method of the electronic apparatus 100, according to an exemplary embodiment.

The electronic apparatus 100 that performs the interfacing method may have a foldable structure including a foldable display. For example, the electronic apparatus 100a of FIG. 1 may perform the interfacing method.

When the electronic apparatus 100 is in a folding state, the electronic apparatus 100 may be in a standby mode or a power saving mode in which the electronic apparatus 100 is turned on but a screen is turned off. The electronic apparatus 100 may receive a user input in the standby mode or the power saving mode. In response to the user input, in operation S110, the electronic apparatus 100 detects whether a display of the electronic apparatus 100 (i.e., the display 230) is in the folding state.

In operation S120, the electronic apparatus 100 activates a display region of the display (i.e., the exposed region 120) that is exposed to the outside when it is detected that the display is in the folding state. The electronic apparatus 100 may change a screen corresponding to the exposed region 120 to an ON state (for example, a state where the screen is activated), and may activate a touch function on the exposed region 120. In this case, a screen corresponding to a display region other than the exposed region 120 may be turned off, and a touch function on the display region other than the exposed region may be inactivated.

When the electronic apparatus 100 is in the folding state, in operation S130, the electronic apparatus 100 may display at least one object on the activated display region. The term “object” may refer to an object that may be selected by the user or an object that displays predetermined information to the user. The object may include an image, a text, and/or a video, for example, an icon, an index item, link information, and/or an execution screen of an application.

For example, the electronic apparatus 100 may display a user interface for performing a call function, an object that indicates message alert information, a lock screen, and a state screen on the exposed region 120. In detail, the electronic apparatus 100 may display on the exposed region 120 an object that indicates a missed call or an incoming call, an object that indicates information about a sender, and an object according to execution of a call application or an address book application.

Also, the electronic apparatus 100 may receive a user input for an object that is displayed on the exposed region 120. For example, the electronic apparatus 100 may receive a touch input including at least one among a tap gesture, a touch and hold gesture, a double tap gesture, a drag gesture, a panning gesture, a flick gesture, and a drag and drop gesture performed through the exposed region 120. Also, the electronic apparatus 100 may distinguish the touch input based on at least one among a duration time and a pressure intensity of the touch input. A method and apparatus used by the electronic apparatus 100 to receive a touch input through the exposed region 120 will be explained in detail with reference to FIGS. 4A through 5.

FIGS. 4A through 4C are views illustrating a method and apparatus for receiving a user's touch input through the exposed region 120 according to exemplary embodiments.

FIG. 4B is a cross-sectional view illustrating a first position 411 of FIG. 4A when the electronic apparatus 100a is in a folding state, according to an exemplary embodiment. FIG. 4C shows cross-sectional views 430-1 and 430-2 illustrating the first position 411 and a second position 413 of FIG. 4A when the electronic apparatus 100a is in the folding state, according to another exemplary embodiment.

Referring to FIG. 4B, the electronic apparatus 100a includes a touchscreen in which a display panel 423 that outputs information and a capacitive touch panel 421 for providing a capacitive touch input are coupled to each other to be stacked. A capacitive method is a method of calculating a touch position (e.g., coordinates) by using a dielectric body coated on a surface of a touchscreen, and detecting fine electricity that is generated in a user's body when the user's body part touches a surface of the touchscreen.

The foldable display 130 including the display panel 423 and the capacitive touch panel 421 may detect not only a position and an area of a touch input but also a duration time of the touch input, and may also detect not only a real touch but also a proximity touch.

Referring to FIG. 4C, the electronic apparatus 100a includes a touchscreen in which resistive sensors 435a, 435b, and 435c for providing a resistive touch input on the exposed region 120 and the display panel 433 and the capacitive touch panel 431 are coupled to one another to be stacked. A resistive method is a method of calculating a touch position (e.g., coordinates) and a pressure intensity by using two electrode plates that are provided in a touchscreen, and detecting current that flows when a user touches a screen and the two electrode plates contact each other at a touch point. For example, the electronic apparatus 100a may dispose three strain sensors at a position corresponding to the exposed region 120.

The foldable display 130 including the display panel 433, the touch panel 431, and the resistive sensors 435a, 435b, and 435c may detect not only a position and an area of a touch input but also a pressure intensity of the touch input.

The electronic apparatus 100a may provide at least one among a capacitive touch input and a resistive touch input through the exposed region 120. Also, the electronic apparatus 100a may drive at least one among the capacitive touch panel 431 and the resistive sensors 435a, 435b, and 435c based on a preset method of driving a user input.

For example, when the capacitive touch panel 431 is touched by using a conductor such as the user's finger, the electronic apparatus 100a may detect a touch input by using all of the capacitive touch panel 431 and the resistive sensors 435a, 435b, and 435c. Also, when the capacitive touch panel 431 is touched by using a non-conductor, the electronic apparatus 100a may detect a touch input by using the resistive sensors 435a, 435b, and 435c.

Also, the electronic apparatus 100a may distinguish the user's touch input as any of three touch inputs as shown in FIG. 5 based on at least one among a duration time of the touch input and a pressure intensity of the touch input. The term “duration time” used herein may refer to a duration time of a touch input that is detected on the same touch position (e.g., coordinates) and the term “pressure intensity” used herein may refer to a pressure intensity of a touch input that is detected on the same touch position (e.g., coordinates).

FIG. 5 is a table showing a touch input that is distinguished by the controller 220 of FIG. 2, according to an exemplary embodiment.

Referring to FIG. 5, when the electronic apparatus 100a of FIG. 4B or the electronic apparatus 100a of FIG. 4C drives only the capacitive touch panel 431, the controller 220 may distinguish the user's touch input based on a duration time of the touch input. Also, when the electronic apparatus 100a of FIG. 4C drives only the resistive sensors 435a, 435b, and 435c, the controller 220 may distinguish the user's touch input based on a pressure intensity of the touch input. Also, when the electronic apparatus 100a of FIG. 4C drives all of the capacitive touch panel 431 and the resistive sensors 435a, 435b, and 435c, the controller 220 may distinguish the user's touch input based on a duration time and a pressure intensity of the touch input.

For example, when only the resistive sensors 430a, 430b, and 430c are driven, and when an intensity of a touch input that is detected is equal to or less than a first critical intensity, the touch input may be distinguished as a first touch input. Also, when an intensity of a touch input that is detected is greater than a second critical intensity, the touch input may be distinguished as a third touch input.

An operation of the controller 220 may vary according to a touch input that is distinguished. For example, the controller 220 may control a speed at which a screen switches to be changed by recognizing a touch input for a screen switch icon for switching the screen. Also, the controller 220 may execute or end an application by recognizing a touch input.

The controller 220 may distinguish the user's touch input by comparing a highest pressure intensity until a point of time when the touch input ends with each critical intensity. Also, even before the touch input ends, the electronic apparatus 100a may distinguish the touch input at a point of time when a pressure intensity exceeds each critical intensity.

As such, because the electronic apparatus 100a finely sub-divides the user's input on the exposed region 120 having a small screen that is exposed to the outside, various interfaces may be provided to the user. Although the electronic apparatus 100a distinguishes the user's touch input as any of three touch inputs, the present exemplary embodiment is not limited thereto. The electronic apparatus 100a may distinguish the user's touch input as any of two touch inputs, or four or more touch inputs. Also, although each touch input is distinguished based on at least one among a duration time and a pressure intensity of the touch input, the present exemplary embodiment is not limited thereto. For example, when a touch input that drags a screen is received, the electronic apparatus 100a may distinguish the touch input according to a drag speed.

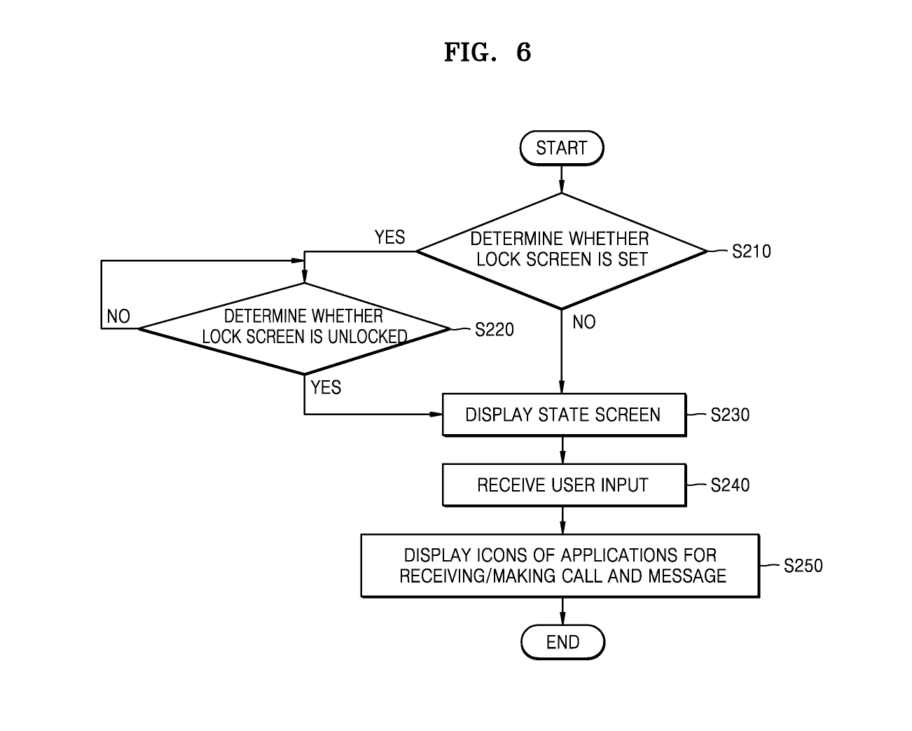

FIG. 6 is a flowchart illustrating a method performed by the electronic apparatus 100 to display at least one object on the exposed region 120, according to an exemplary embodiment.

Referring to FIG. 6, in operation S210, when the exposed region 120 is activated when the electronic apparatus 100 is in a folding state, the electronic apparatus 100 determines whether a lock screen is set. When it is determined in operation S210 that the lock screen is set, the method proceeds to operation S220. In operation S220, the electronic apparatus 100 may receive a user input for unlocking the lock screen, and determines whether the lock screen is unlocked.

When it is determined in operation S210 that the lock screen is not set, or it is determined in operation S220 that the lock screen is unlocked, the method proceeds to operation S230. In operation S230, the electronic apparatus 100 displays a state screen of the electronic apparatus 100. The state screen may include state icons that indicate a state of the electronic apparatus 100. For example, the state screen may include a state icon that indicates time information, a state icon that indicates weather information, a state icon that indicates an alert mode, a state icon that indicates a battery level of the electronic apparatus 100, and a state icon that indicates a communication connection with a base station. Also, the state screen may include a screen switch icon for switching the state screen to another screen.

In operation S240, the electronic apparatus 100 receives a user input for the screen switch icon. The electronic apparatus 100 may switch the state screen to a screen including icons of applications, according to the user input. For example, in operation S250, the electronic apparatus 100a of FIG. 1 switches the state screen to display a screen including icons of applications for performing a call function, i.e., receiving/making a call and a message.

When the electronic apparatus 100 receives a touch input for the state screen, the electronic apparatus 100 may change a speed at which the screen switches according to a pressure intensity of the touch input. Also, when the electronic apparatus 100 receives a touch input that drags the state screen, the electronic apparatus 100 may change a speed at which the screen switches according to a drag speed.

Although the lock screen or the state screen is displayed as the exposed region 120 of the electronic apparatus 100 is activated, the present exemplary embodiment is not limited thereto. For example, as the exposed region 120 is activated, the electronic apparatus 100 may directly display icons of applications for performing a call function on the exposed region 120.

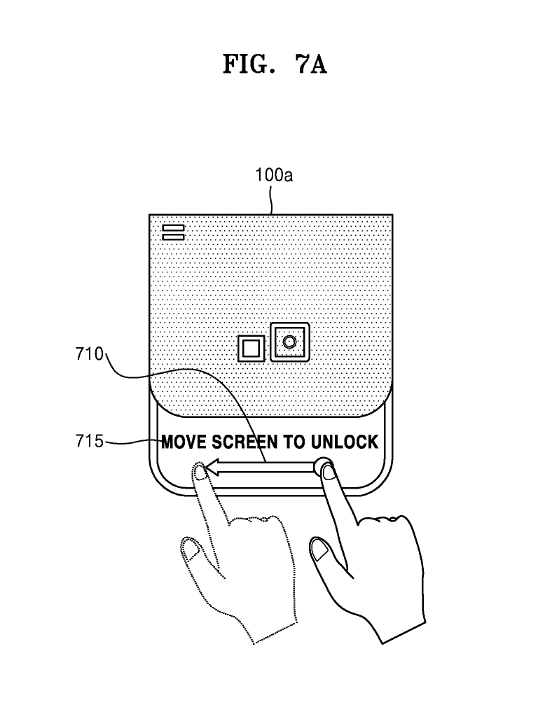

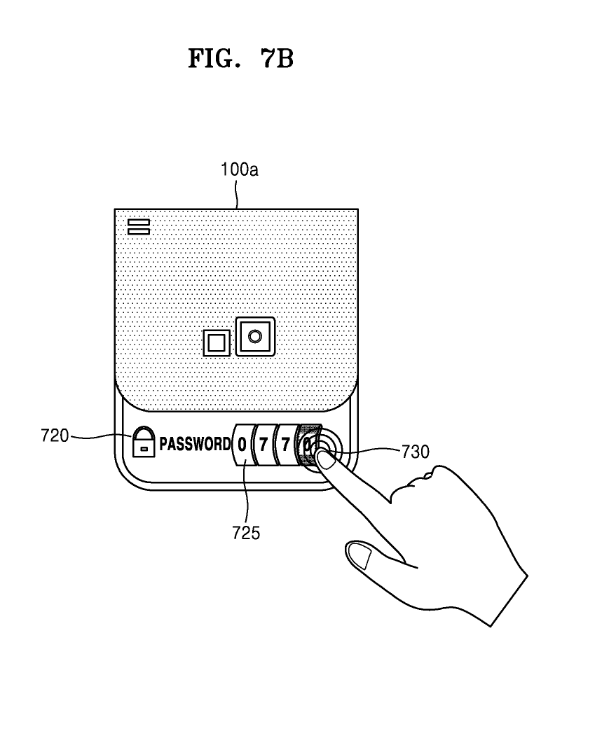

FIGS. 7A and 7B are views illustrating examples where the electronic apparatus 100a displays a lock screen on the exposed region 120 accordingly to exemplary embodiments.

According to an exemplary embodiment, the electronic apparatus 100a may display a lock screen 715 on the exposed region 120 as the exposed region 120 is activated in a folding state, as shown in FIG. 7A.

As a first touch input 710 that drags the lock screen 715 is received, the electronic apparatus 100a may switch the lock screen 715 to another screen. Alternatively, as a second touch input or a third touch input for the lock screen 715 is received, the electronic apparatus 100a may switch the lock screen 715 to another screen.

According to another exemplary embodiment, the electronic apparatus 100a may display a lock screen 720 including number setting buttons 725 for inputting a password on the exposed region 120 as the exposed region 120 is activated in the folding state, as shown in FIG. 7B. When the user's touch input for the number setting buttons 725 is a second touch input 730, the electronic apparatus 100a may change a number that is displayed on each of the number setting buttons 725. Also, when a third touch input is received, the electronic apparatus 100a may increase a speed at which a number is changed.

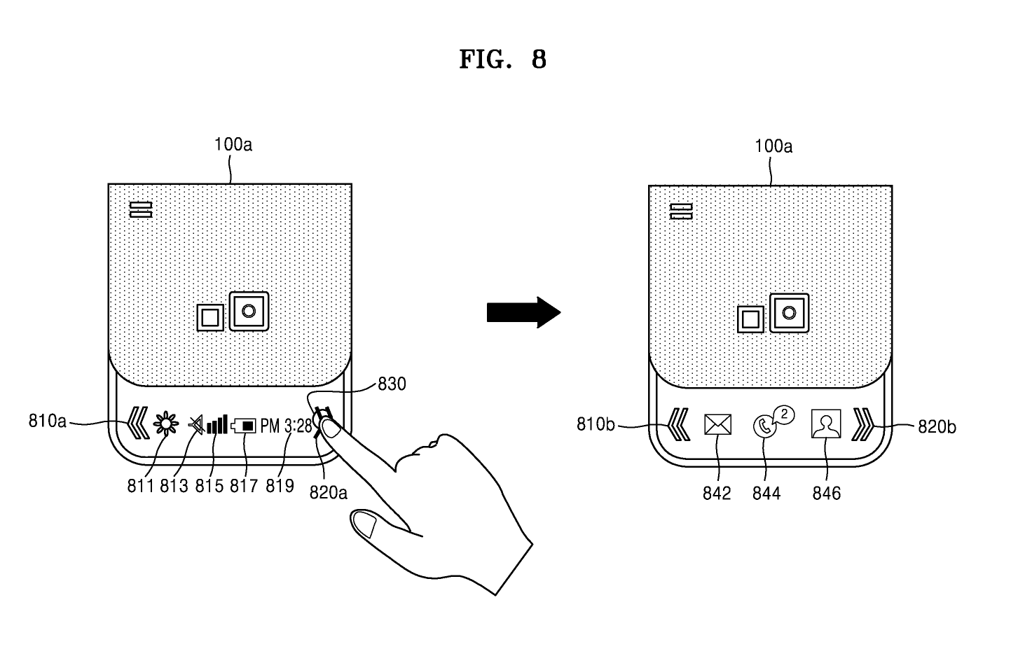

FIG. 8 is a diagram illustrating an example where the electronic apparatus 100a displays a state screen and an application icon for performing a call function on the exposed region 120 accordingly to an exemplary embodiment.

According to an exemplary embodiment, as shown on the left of FIG. 8, the electronic apparatus 100a may display a state screen as the exposed region 120 is activated when the electronic apparatus 100a is in a folding state. Alternatively, the electronic apparatus 100a may display a state screen according to the user's touch input that is received from a lock screen. The state screen may include state icons that indicate a state of the electronic apparatus 100a. For example, the state screen may include a state icon 819 that indicates time information, a state icon 811 that indicates weather information, a state icon 813 that indicates an alert mode, a state icon 815 that indicates a battery level of the electronic apparatus 100a, and a state icon 817 that indicates a communication connection with a base station.

Also, the electronic apparatus 100a may include screen switch icons 810a and 820a. The electronic apparatus 100a may switch the state screen to another screen according to a user input 830 for any of the screen switch icons 810a and 820a. For example, the electronic apparatus 100a may receive a first touch input for the screen switch icon 820a that is a right icon. In this case, the electronic apparatus 100a may switch the state screen to a screen including an icon 842 of a message application for performing a call function, an icon 844 of a call application, and an icon 846 for an address book application. Also, when a first touch input for the screen switch icon 810a that is a left icon is received, the electronic apparatus 100a may switch the state screen to a screen including icons of applications having a high frequency of use.

When a number of icons of applications that are to be displayed on a screen is equal to or greater than a predetermined number, the electronic apparatus 100a may display the screen switch icons 810b and 820b on a screen including the icons 842, 844, and 846.

As such, the electronic apparatus 100a according to an exemplary embodiment may display many icons on the exposed region 120 that has a screen with a limited size.

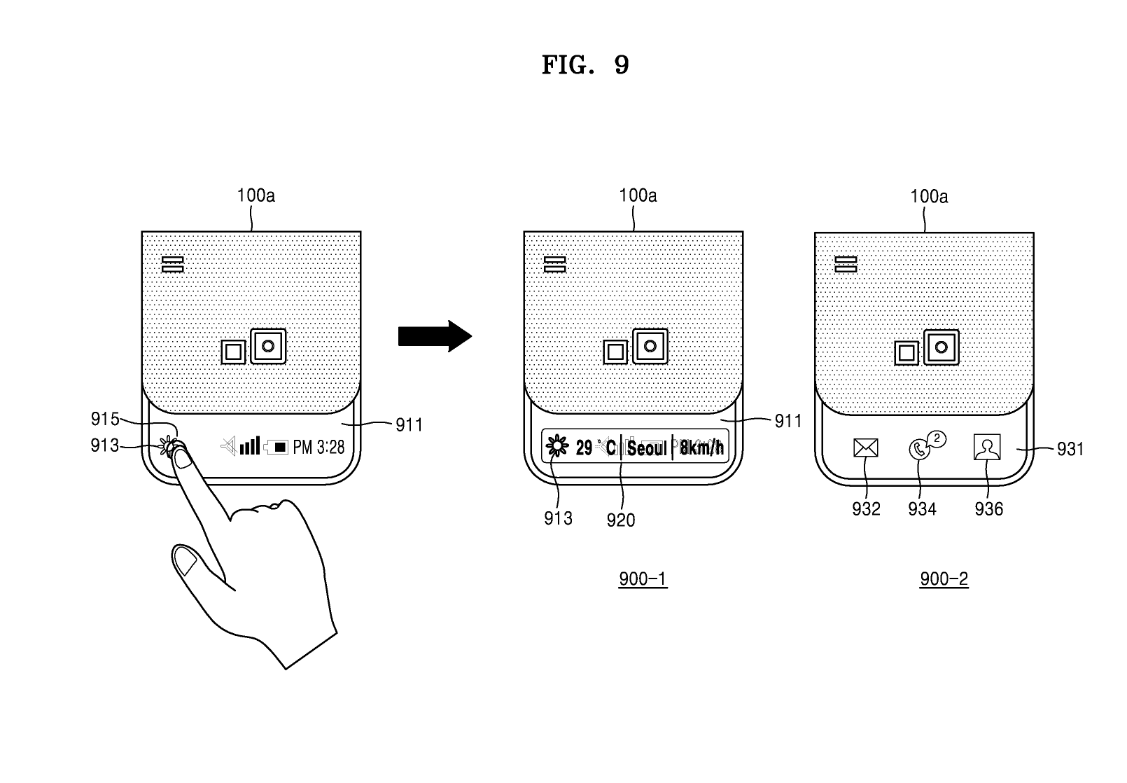

FIG. 9 is a diagram illustrating an example where the electronic apparatus 100a displays a state screen and an application icon for performing a call function on the exposed region 120 accordingly to an exemplary embodiment.

As shown on the left of FIG. 9, the electronic apparatus 100a may display a state screen 911 as the exposed region 120 is activated when the electronic apparatus 100a is in a folding state. Alternatively, the electronic apparatus 100a may display the state screen 911 according to the user's touch input that is received from a lock screen. Also, the electronic apparatus 100a may receive a user input 915 that is at least one among a first touch input, a second touch input, and a third touch input through the state screen 911.

For example, when a first touch input is received, the electronic apparatus 100a may display detailed information of a state icon corresponding to a position at which the first touch input is received. In detail, as shown in a view 900-1, when a first touch input for a weather icon 913 is received, the electronic apparatus 100a may display detailed information 920 including a current temperature, a position, and a wind speed so that the detailed information 920 overlaps the state screen 911.

Also, as shown in a view 900-2, when a second touch input is received, the electronic apparatus 100a may switch the state screen 911 to a screen 931 including an icon 932 for a message application, an icon 934 for a call application, and an icon 936 for an address book application. Also, when a third touch input is received, the electronic apparatus 100a may change a speed at which a screen switches.

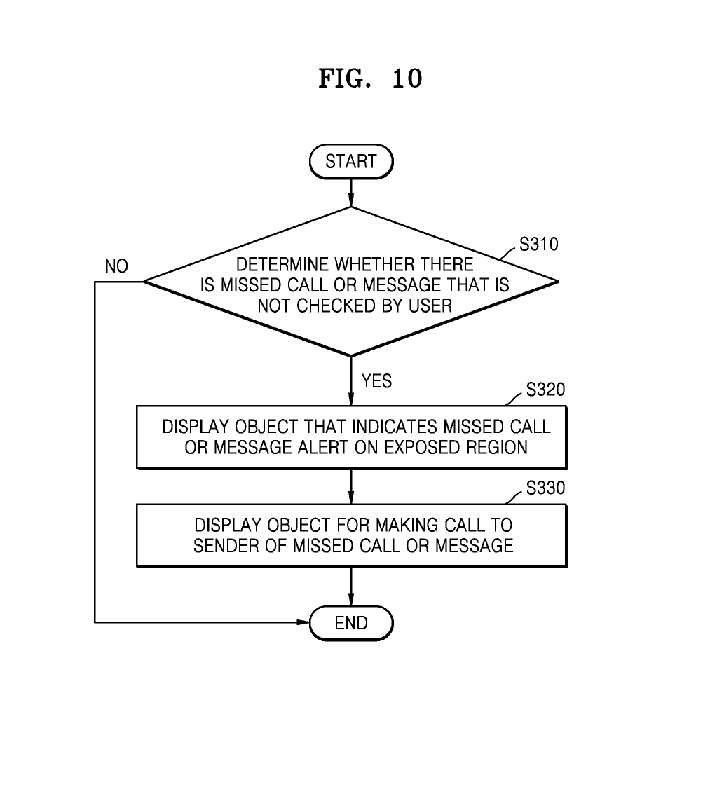

FIG. 10 is a flowchart illustrating a method performed by the electronic apparatus 100 to display an object that indicates a missed call and a message alert, according to an exemplary embodiment.

Referring to FIG. 10, in operation S310, the electronic apparatus 100 determines whether there is a missed call or a message that is not checked by a user when the exposed region 120 is activated when the electronic apparatus 100 is in a folding state.

When it is determined in operation S310 that there is a missed call or a message, the method proceeds to operation S320. In operation S320, the electronic apparatus 100 displays an object that indicates a missed call or a message alert on the exposed region 120. For example, the electronic apparatus 100 may display information about the missed call or the message and information about a sender on the exposed region 120. The information about the sender may include a telephone number, a name, a nickname, and an image of the sender who has sent the missed call or the message.

In operation S330, the electronic apparatus 100 displays an object for making a call to the sender of the missed call or the message. For example, the electronic apparatus 100 may display a call origination button for allowing a call of the sender and a message transmission button for transmitting a message to the sender.

If it is determined in operation S310 that there is no missed call or message, the electronic apparatus 100 may display icons of applications for performing a call function, a state screen, and/or a lock screen on the exposed region 120.

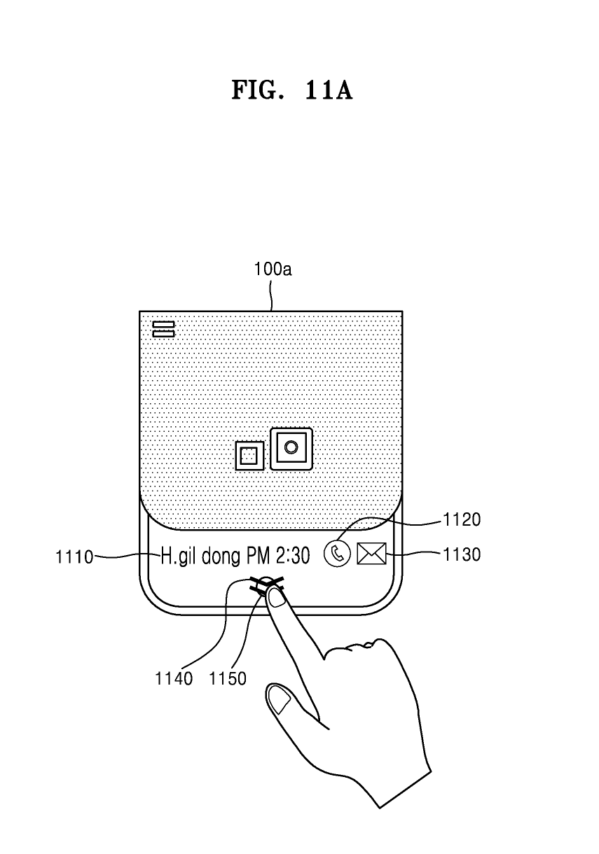

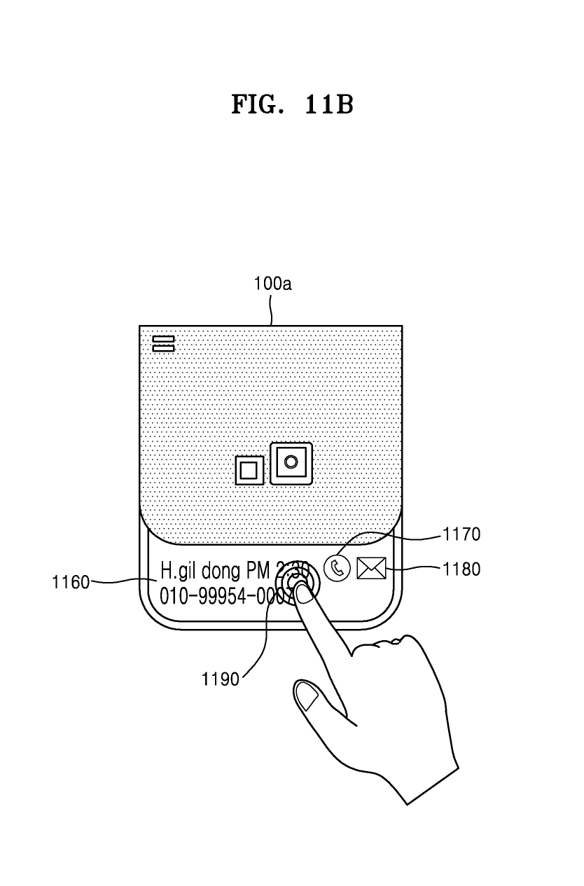

FIGS. 11A and 11B are views illustrating an example where the electronic apparatus 100a displays an object that indicates a missed call on the exposed region 120 according to an exemplary embodiment.

As the exposed region 120 is activated when the electronic apparatus 100a is in a folding state, the electronic apparatus 100a may display missed call information 1110, a call origination button 1120, and a message transmission button 1130, as shown in FIG. 11A. The missed call information 1110 may include a name of a sender of a missed call and a time when the missed call is received.

When a user input for the call origination button 1120 is received, the electronic apparatus 100a may make a call to the sender of the missed call. Also, when a user input for the message transmission button 1130 is received, the electronic apparatus 100a may automatically transmit a message to the sender of the missed call. For example, the electronic apparatus 100a may automatically transmit a message indicating that the sender of the missed call may reach the user now.

When there are a plurality of missed calls, the electronic apparatus 100a may display missed call information beginning from a latest missed call. In this case, the electronic apparatus 100a may display on the exposed region 120 a screen switch button 1140 for displaying next missed call information. As a first touch input 1150 for the screen switch button 1140 is received, the electronic apparatus 100a may display information about a next missed call. If a second touch input for the screen switch button 1140 is received, the electronic apparatus 100a may change a speed at which a screen switches, and when a third touch input is received, the electronic apparatus 100a may display information about an earliest missed call.

Also, as the exposed region 120 is activated when the electronic apparatus 100a is in the folding state, the electronic apparatus 100a may display missed call information 1160, a call origination button 1170, and a message transmission button 1180, as shown in FIG. 11B. The missed call information 1160 may include a name and a telephone number of a sender of a missed call and a time when the missed call is received.

The electronic apparatus 100a may receive a user input 1190 through the exposed region 120. For example, when a first touch input for the call origination button 1170 or the message transmission button 1180 is received, the electronic apparatus 100a may make a call to the sender of the missed call or may automatically transmit a message to the sender.

Also, when a second touch input is received through the exposed region 120, the electronic apparatus 100a may display information about a next missed call. Also, when a third touch input is received through the exposed region 120, the electronic apparatus 100a may display information about an earliest missed call.

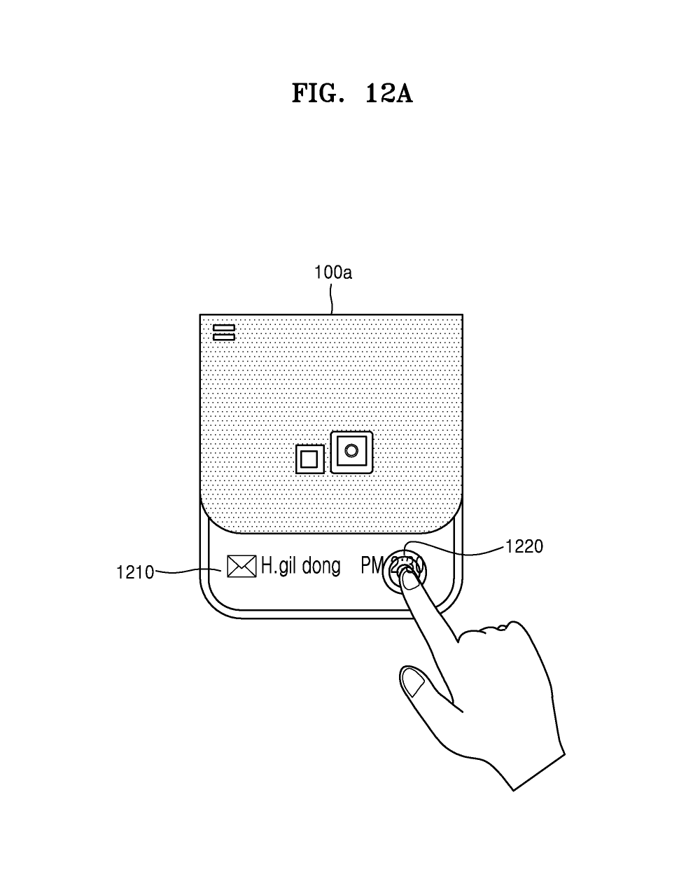

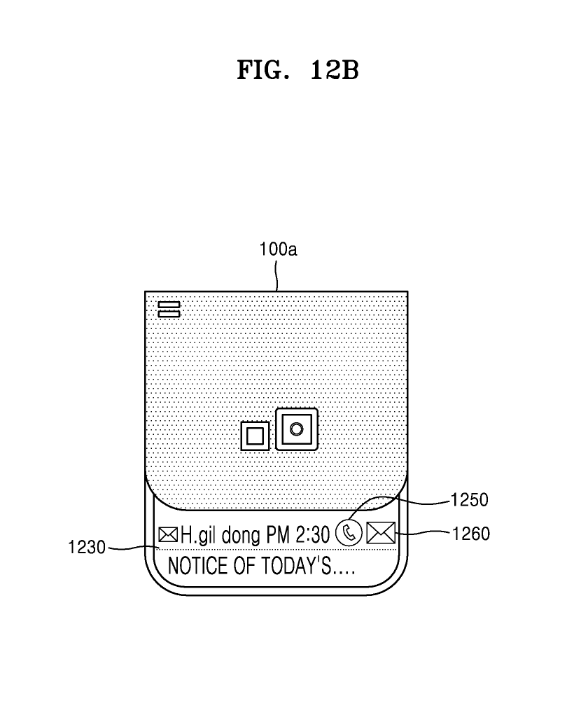

FIGS. 12A and 12B are views illustrating an example where the electronic apparatus 100a displays an object that indicates a message alert on the exposed region 120 according to an exemplary embodiment.

Referring to FIG. 12A, as the exposed region 120 is activated when the electronic apparatus 100a is in a folding state, the electronic apparatus 100a may display on the exposed region 120 alert information 1210 about a message that is not checked by the user. Alternatively, as a message is newly received when the electronic apparatus 100a is in the folding state, the electronic apparatus 100a may display alert information 1210 about the message on the exposed region 120. The alert information 1210 about the message may include information about a sender and a time when the message is received. Also, the electronic apparatus 100a may receive a user input 1220 that is at least one among a first touch input, a second touch input, and a third touch input on the exposed region 120 on which the alert information 1210 about the message is displayed. For example, when a first touch input is received through the exposed region 120, the electronic apparatus 100a may display detailed information 1230 about the message as shown in FIG. 12B.

When a plurality of messages are received, as a second touch input is received through the exposed region 120 on which the alert information 1210 about the messages is displayed, the electronic apparatus 100a may display alerter information about a next message. Also, when a third touch input is received through the exposed region 120, the electronic apparatus 100a may display alert information about an earliest message.

Referring to FIG. 12B, as the user's first touch input is received through a screen on which the alert information 1210 about the message is received, the electronic apparatus 100a may display the detailed information 1230 about the message on the exposed region 120. Alternatively, as a message is received when the electronic apparatus 100a is in the folding state, the electronic apparatus 100a may display the detailed information 1230 about the message on the exposed region 120. The detailed information 1230 about the message may include information about a sender, content of the message, a time when the message is received, a call origination button 1250, and a message transmission button 1260. As a first touch input for the call origination button 1250 or the message transmission button 1260 is received, the electronic apparatus 100a may make a call to the sender of the message or may automatically transmit a message to the sender.

When a plurality of messages are received, as a second touch input is received through the exposed region 120 on which the detailed information 1230 about the messages is displayed, the electronic apparatus 100a may display detailed information about a next message. Also, as a third touch input is received through the exposed region 120, the electronic apparatus 100a may display detailed information about an earliest message.

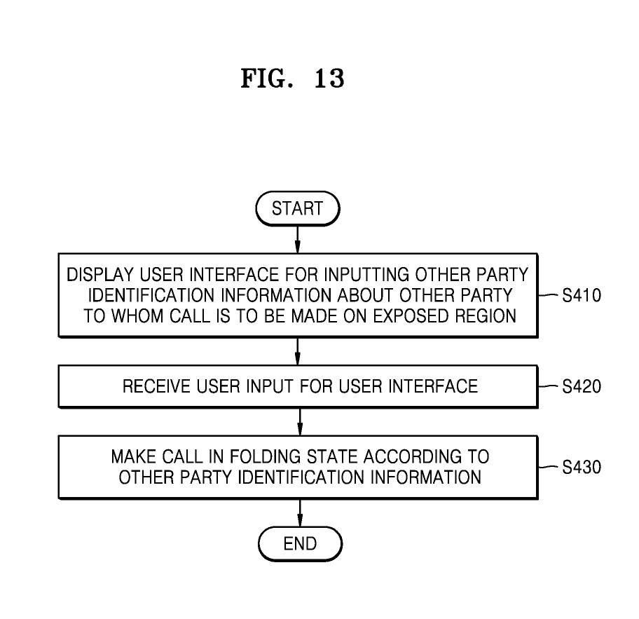

FIG. 13 is a flowchart illustrating an interfacing method performed by the electronic apparatus 100 to make a call in a folding state, according to an exemplary embodiment.

Referring to FIG. 13, the electronic apparatus 100 may execute an application for performing a call function in the folding state. For example, the electronic apparatus 100 may execute a call application or an address book application.

As the call application is executed, in operation S410, the electronic apparatus 100 displays a user interface for inputting other party identification information about other party to whom a call is to be made on the exposed region 120. The other party identification information may include a telephone number, a name, a nickname, or an email address of the other party. Accordingly, the user interface may include a number setting object for inputting a telephone number of the other party and a letter setting object for inputting a name of the other party. Also, the electronic apparatus 100 may automatically activate a voice recognition function for inputting the other party identification information.

In operation S420, the electronic apparatus 100 receives a user input for the user interface. In operation S430, the electronic apparatus 100 makes a call to the other party in the folding state according to the other party identification information. The electronic apparatus 100 may output voice data that is received from the other party through a speaker that is disposed on a rear surface of the electronic apparatus 100.

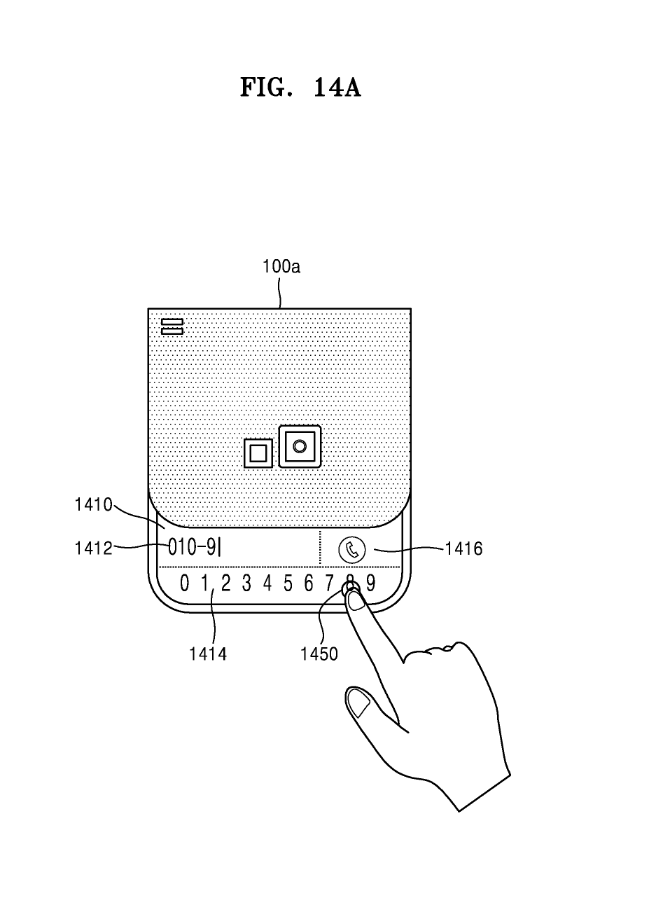

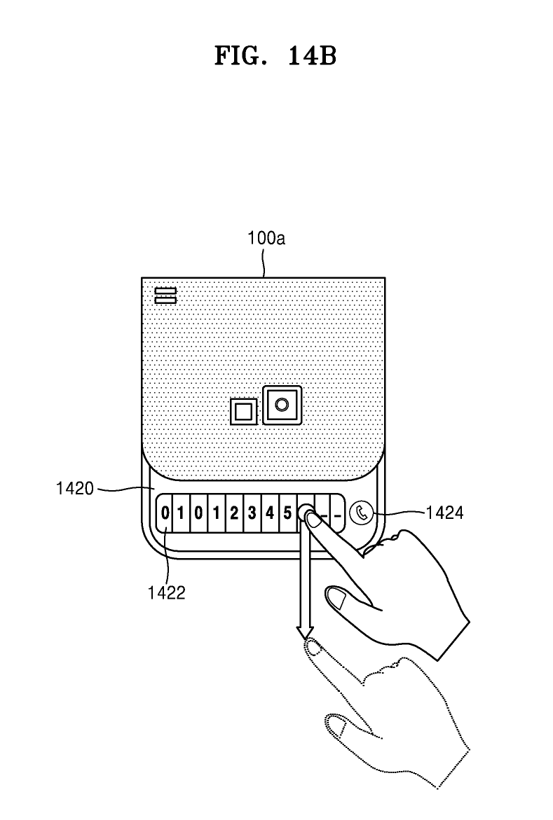

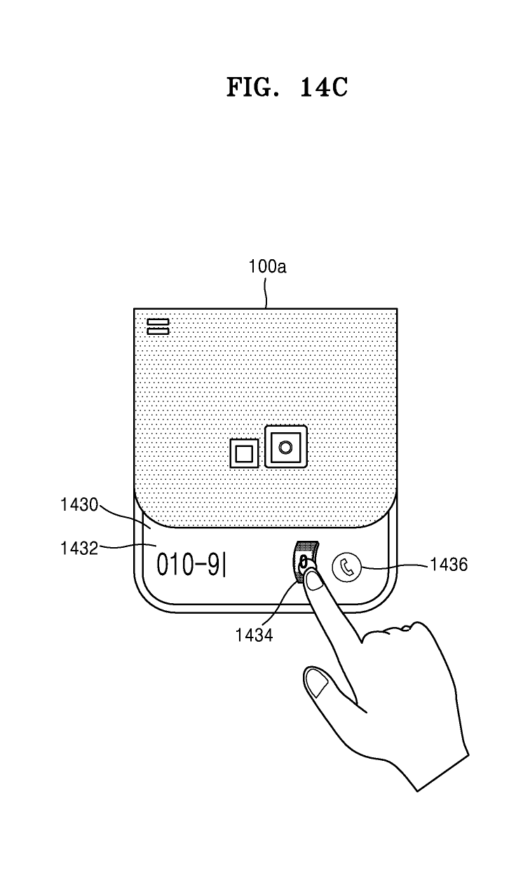

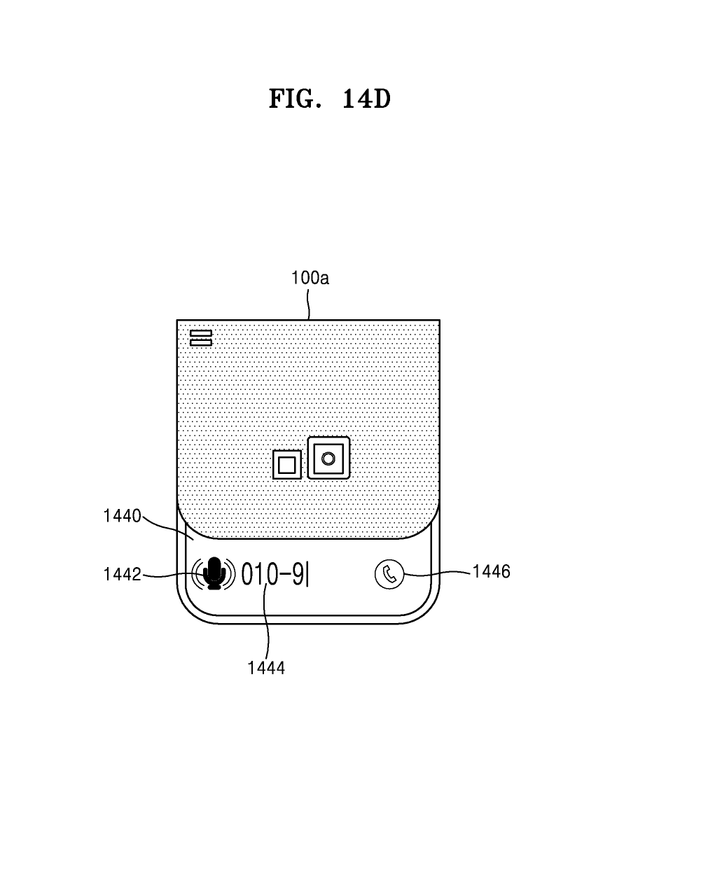

FIGS. 14A through 14D are views illustrating examples where the electronic apparatus 100a executes a call application through the exposed region 120 according to exemplary embodiments.

According to an exemplary embodiment, the electronic apparatus 100a may display an execution screen 1410 of a call application on the exposed region 120, as shown in FIG. 14A. The execution screen 1410 of the call application may include a telephone number display region 1412, a number button 1414, and a call origination button 1416. In this case, the electronic apparatus 100a may select a telephone number of the other party to whom a call is to be made based on a first touch input 1450 for the number button 1414. The selected telephone number may be displayed on the telephone number display region 1412. Also, when a first touch input for the call origination button 1416 is received, the electronic apparatus 100a may make a call to the other party based on the telephone number that is displayed on the telephone number display region 1412.

According to another exemplary embodiment, the electronic apparatus 100a may display an execution screen 1420 of a call application on the exposed region 120, as shown in FIG. 14B. The execution screen 1420 of the call application may include number setting buttons 1422 for setting a telephone number of the other party to whom a call is to be made and a call origination button 1424. In this case, the electronic apparatus 100a may set a telephone number of the other party according to a first touch input and a second touch input for the number setting buttons 1422. For example, as a first touch input for each of the number setting buttons 1422 is received, the electronic apparatus 100a may change a number that is set on each number setting button 1422. Also, as a second touch input for each number setting button 1422 is received, the electronic apparatus 100a may increase a speed at which a number is changed on each number setting button 1422. Alternatively, as a first touch that vertically drags each number setting button 1422 is received, the electronic apparatus 100a may change a number that is set on each number setting button 1422. When a user input for the call origination button 1424 is received, the electronic apparatus 100a may make a call to the other party based on numbers that are set on the number setting buttons 1422.

When a third touch input is received through a portion of the exposed region 120 other than the number setting buttons 1422 and the call origination button 1424, the electronic apparatus 100a may cancel execution of the call application. In this case, the electronic apparatus 100a may display again a screen that was displayed before the execution of the call application.

According to another exemplary embodiment, the electronic apparatus 100a may display an execution screen 1430 of a call application on the exposed region 120, as shown in FIG. 14C. The execution screen 1430 of the call application may include a telephone number display region 1432, one number setting button 1434, and a call origination button 1436. In this case, the electronic apparatus 100a may change a number that is set on the one number setting button 1434 and may display the changed number on the telephone number display region 1432 based on a first touch input and a second touch input for the one number setting button 1434. When a first touch input for the call origination button 1436 is received, the electronic apparatus 100a may make a call based on numbers that are displayed on the telephone number display region 1432.

According to another exemplary embodiment, when a call application is executed in a folding state, the electronic apparatus 100a may automatically activate a voice recognition function, as shown in FIG. 14D. In this case, an execution screen 1440 of a call application may include a voice recognition activation icon 1442, a telephone number display region 1444, and a call origination button 1446. The electronic apparatus 100a may display a telephone number of the other party to whom a call is to be made on the telephone number display region 1444 based on the user's voice data that is received.

As such, the electronic apparatus 100a according to an exemplary embodiment may provide various user interfaces on the exposed region 120 having a limited size.

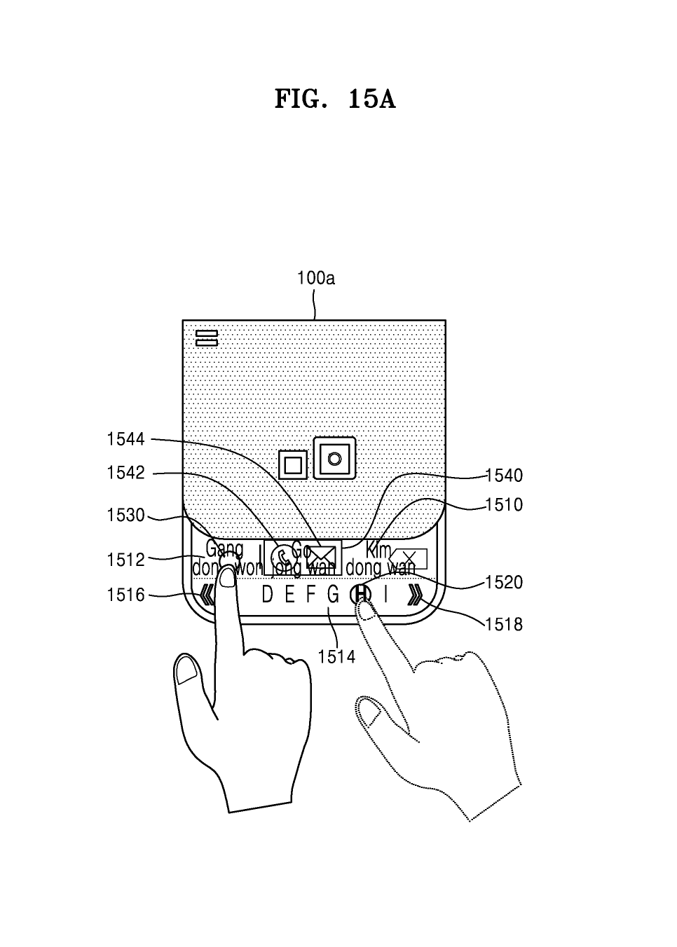

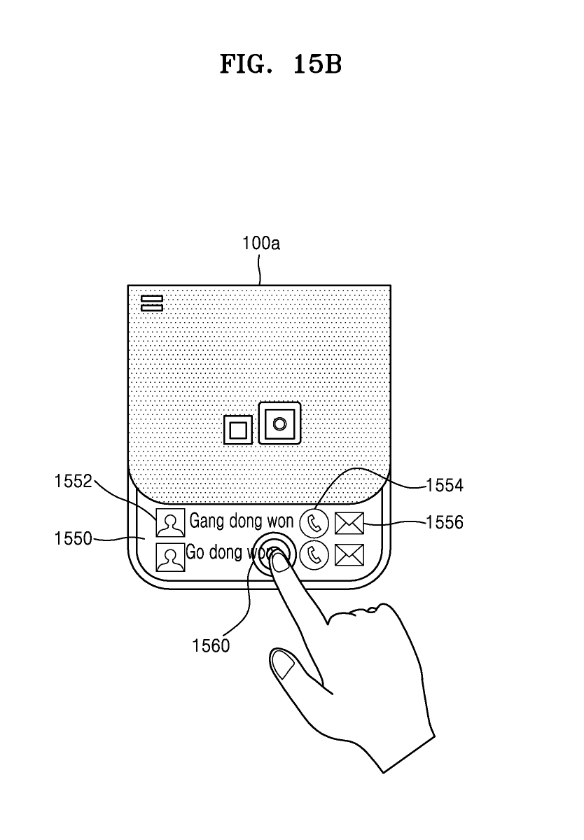

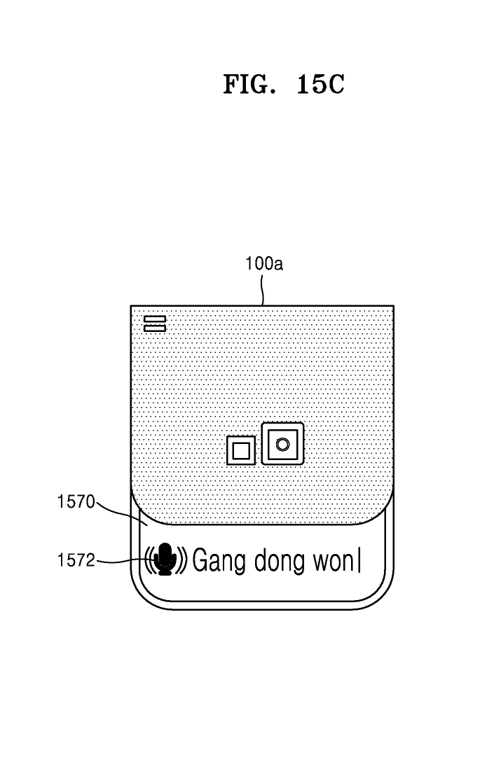

FIGS. 15A through 15C are views illustrating examples where the electronic apparatus 100a executes an address book application through the exposed region 120 according to exemplary embodiments.

According to an exemplary embodiment, the electronic apparatus 100a may display an execution screen 1510 of an address book application, as shown in FIG. 15A. The execution screen 1510 of the address book application may include a letter setting region 1514 for inputting a name of the other party and another party setting region 1512 that displays a list of names of the other parties.

The letter setting region 1514 of the electronic apparatus 100a may include letter buttons (for example, Korean consonant buttons or English alphabet buttons) for inputting a name of the other party. The electronic apparatus 100a may receive a user input 1520 that selects at least one message button through the letter setting region 1514. Also, the electronic apparatus 100a may display names of the other parties corresponding to the at least one message button on the other party setting region 1512. For example, when the Korean consonant buttons (or the English alphabet buttons) are selected through the letter setting region 1514, the electronic apparatus 100a may display on the other party setting region 1512 a list of names of the other parties who have Korean consonants corresponding the consonant buttons as initial sounds of their names (or a list of names of the other parties who include English alphabets corresponding to the alphabet buttons).

Next, the electronic apparatus 100a may receive a first touch input 1530 that selects one in the list of the names of the other parties that is displayed on the other party setting region 1512. The electronic apparatus 100a may display a popup window 1540 on the exposed region 120 so that the popup window 1540 is adjacent to a display region through which the first touch input 1530 is received. The popup window 1540 may include a call origination button 1542 and a message transmission button 1544. As a first touch input for the call origination button 1542 or the message transmission button 1544 is received, the electronic apparatus 100a may make a call to the selected other party or may transmit a message to the selected other party.

The letter setting region 1514 may include screen switch buttons 1516 and 1518. In this case, the electronic apparatus 100a may change letter buttons that are displayed on the letter setting region 1514 based on a first touch input for the screen switch buttons 1516 and 1518. Also, although a name of the other party is set through the execution screen 1510 of the address book application and one name is selected in the list of the names of the other parties, the present exemplary embodiment is not limited thereto. For example, a nickname or an email address of the other party is set through the execution screen 1510 of the address book application, and one nickname or email address may be selected in a list of nicknames or email addresses of the other parties.

According to another exemplary embodiment, the electronic apparatus 100a may display an execution screen 1550 of an address book application, as shown in FIG. 15B. The execution screen 1550 of the address book application may include address book lists. Also, each of the address book lists may include address book information 1552, a call origination button 1554, and a message transmission button 1556. The user may send a call or a message to a desired other party by selecting the call origination button 1554 or the message transmission button 1556 included in each address book list.

In this case, a number of address book lists that are displayed on one screen may be limited according to a size of the exposed region 120. Accordingly, as a second touch input 1560 for the execution screen 1550 of the address book application is received, the electronic apparatus 100a may change an address book list that is displayed on the exposed region 120. Also, as a third touch input is received, the electronic apparatus 100a may change a speed at which an address book list is changed. Alternatively, as a first touch input that vertically or horizontally drags the execution screen 1550 of the address book application is received, the electronic apparatus 100a may change an address book list that is displayed on the exposed region 120. Also, the electronic apparatus 100a may change a speed at which an address book list is changed according to a drag speed.

According to another exemplary embodiment, the electronic apparatus 100a may activate a voice recognition function as an address book application is activated, as shown in FIG. 15C. In this case, an execution screen 1570 of the address book application may include a voice recognition activation icon 1572. The electronic apparatus 100a may display a name of the other party on the exposed region 120 based on the user's voice data that is received. Also, when there is address book information that is matched to the name of the other party, the electronic apparatus 100a may automatically make a call to the other party.

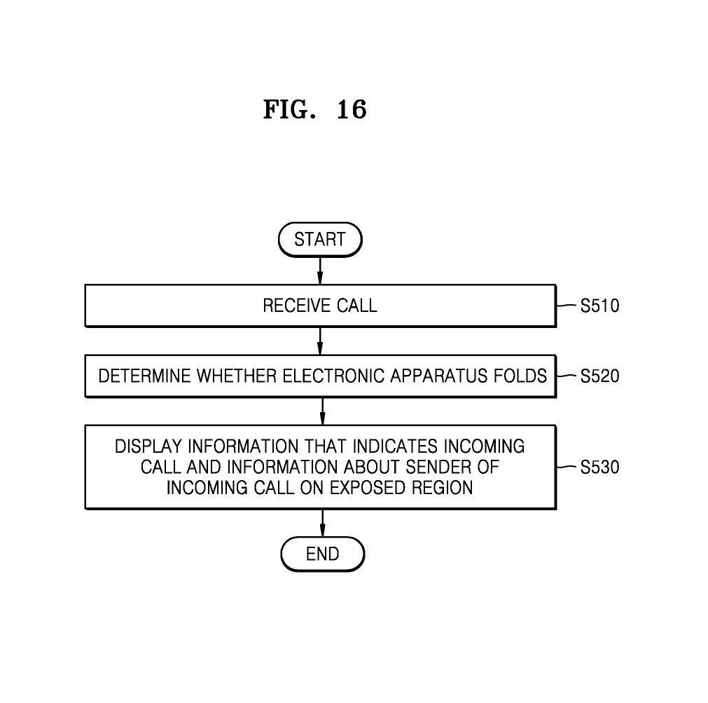

FIG. 16 is a flowchart illustrating an interfacing method performed by the electronic apparatus 100 to receive a call in a folding state, according to an exemplary embodiment.

According to an exemplary embodiment, in operation S510, a call is received from the other party. In operation S520, it is determined whether the electronic apparatus 100 folds. When it is determined in operation S520 that the electronic apparatus 100 folds, the method proceeds to operation S530. In operation S530, the electronic apparatus 100 displays information that indicates an incoming call and information about a sender of the incoming call on the exposed region 120. For example, the electronic apparatus 100 may activate a screen of the exposed region 120, and may display a name, a telephone number, etc. of the sender on the exposed region 120.

Also, the electronic apparatus 100 may allow a call in the folding state in response to a user input that is received through the exposed region 120. For example, as a first touch input that drags the screen is received through the exposed region 120, the electronic apparatus 100 may allow a call. Alternatively, as a second touch input is received through the exposed region 120, the electronic apparatus 100 may allow a call.

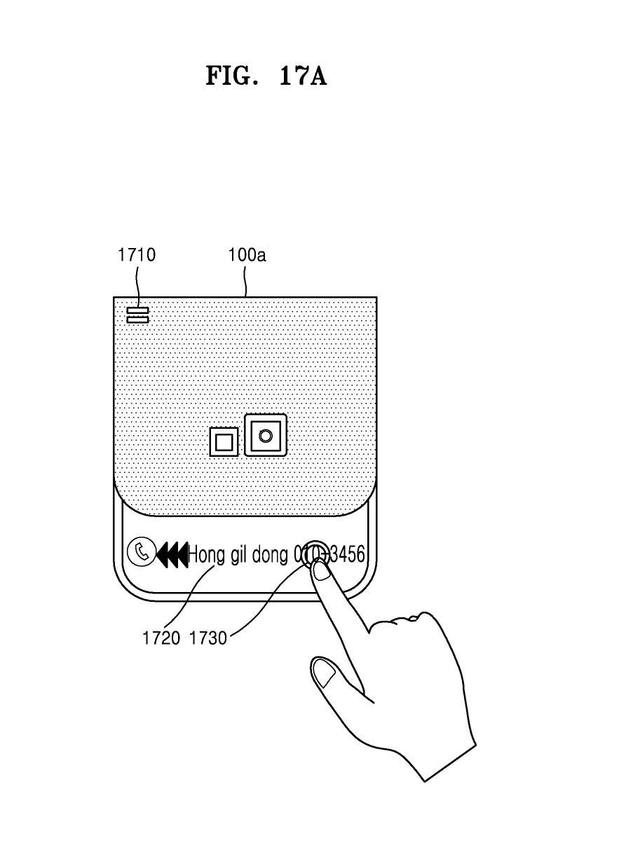

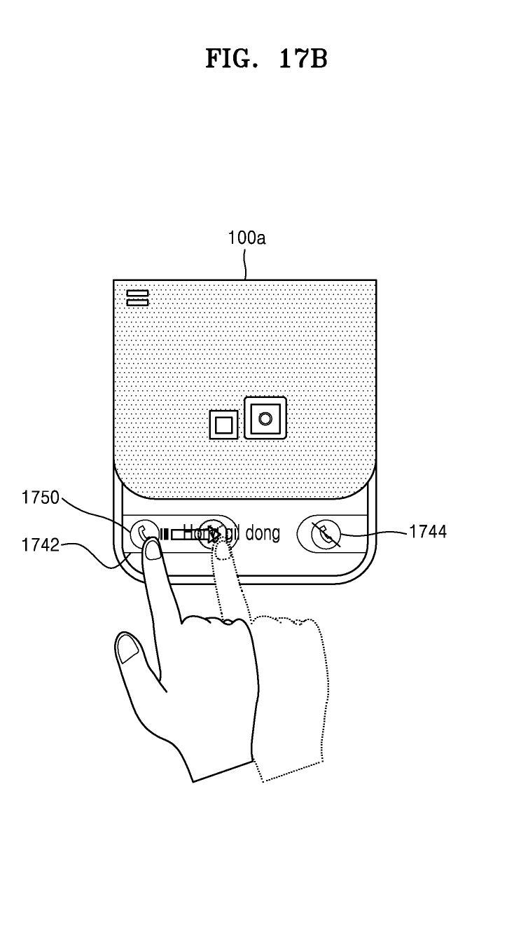

FIGS. 17A and 17B are views illustrating examples where the electronic apparatus 100a provides a user interface for an incoming call in a folding state according to exemplary embodiments.

According to an exemplary embodiment, when a call is received and the electronic apparatus 100a is in the folding state, the electronic apparatus 100a may display identification information 1720 of a sender on the exposed region 120, as shown in FIG. 17A. The identification information 1720 of the sender may include a name and a telephone number of the sender. As a second touch input 1730 is received through the exposed region 120, the electronic apparatus 100a may allow a call. Also, as a third touch input for the exposed region 120 is received, the electronic apparatus 100a may block a call.

According to another exemplary embodiment, when a call is received and the electronic apparatus 100a is in the folding state, the electronic apparatus 100a may display identification information of the other party who makes the call, a call origination button 1742, and a call blocking button 1744 on the exposed region 120, as shown in FIG. 17B. In this case, as a first touch input 1750 that drags the call origination button 1742 is received, the electronic apparatus 100a may allow the call, and when a first touch input that drags the call blocking button 1744 is received, the electronic apparatus 100a may block the call.

The electronic apparatus 100a may output voice data that is received from the other party through a speaker 1710 that is disposed on a rear surface of the electronic apparatus 100a. Accordingly, the user may have conversations with the other party by telephone when the electronic apparatus 100a is in the folding state.

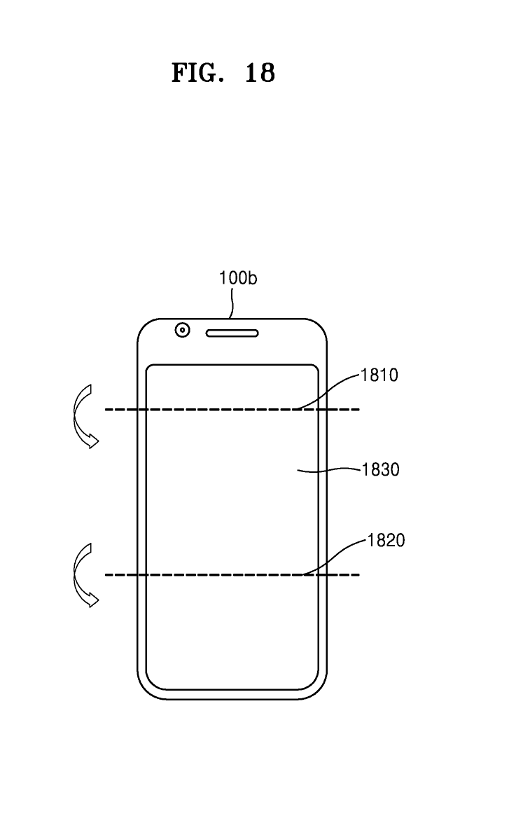

FIGS. 18 and 19 are views illustrating an electronic apparatus 100b according to an exemplary embodiment.

As shown in FIG. 18, the electronic apparatus 100b is a foldable electronic apparatus including a foldable display 1830 that may fold along a plurality of folding lines, for example, first and second folding lines 1810 and 1820. Also, the electronic apparatus 100b of FIG. 18 may fold along at least one folding line among the first folding line 1810 and the second folding line 1820, as shown in FIG. 19.

Referring to FIG. 19, the electronic apparatus 100b may fold along the first folding line 1810 and the second folding line 1820. In this case, as shown in a view 1900-1, the electronic apparatus 100b includes a first exposed region 1920 of the foldable display 1830 that is not covered by a first housing 1910a and a second housing 1910b. Also, as shown in a view 1900-2, when the electronic apparatus 100b folds along the second folding line 1820, the electronic apparatus 100b includes a second exposed region 1930 of the foldable display 1830 that is not covered by the second housing 1910b. Also, as shown in a view 1900-3, when the electronic apparatus 100b folds along the first folding line 1810, the electronic apparatus 100b includes a third exposed region 1940 of the foldable display 1830 that is not covered by the first housing 1910a. Also, the electronic apparatus 100b of FIG. 18 may vary objects that are displayed on the first exposed region 1920, the second exposed region 1930, and the third exposed region 1940 having different sizes and a number of the objects.

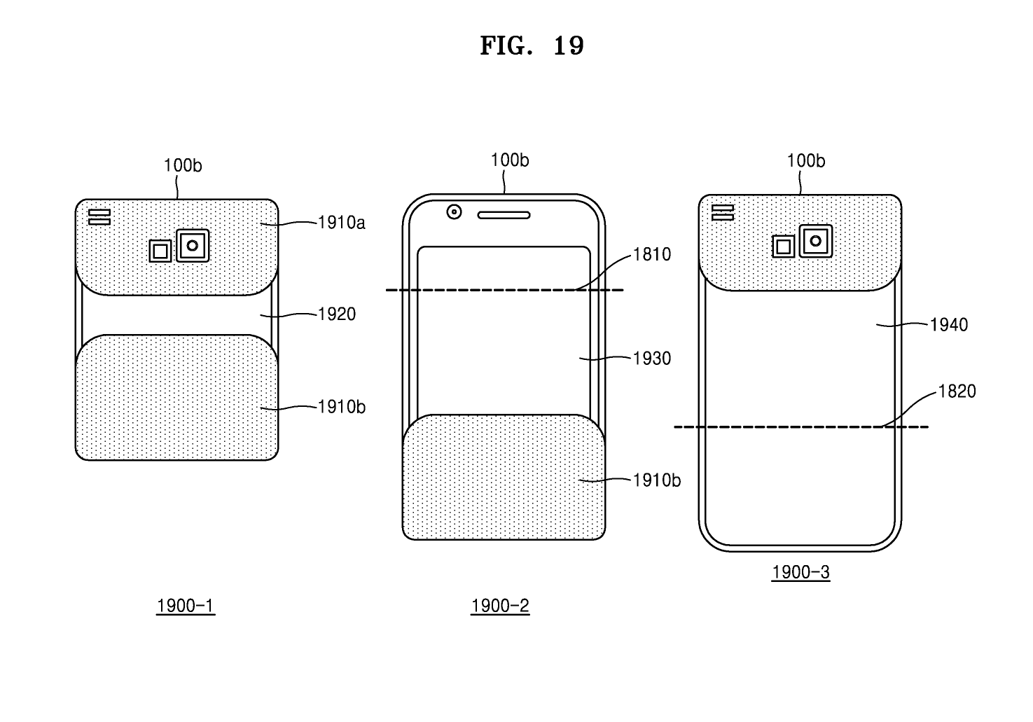

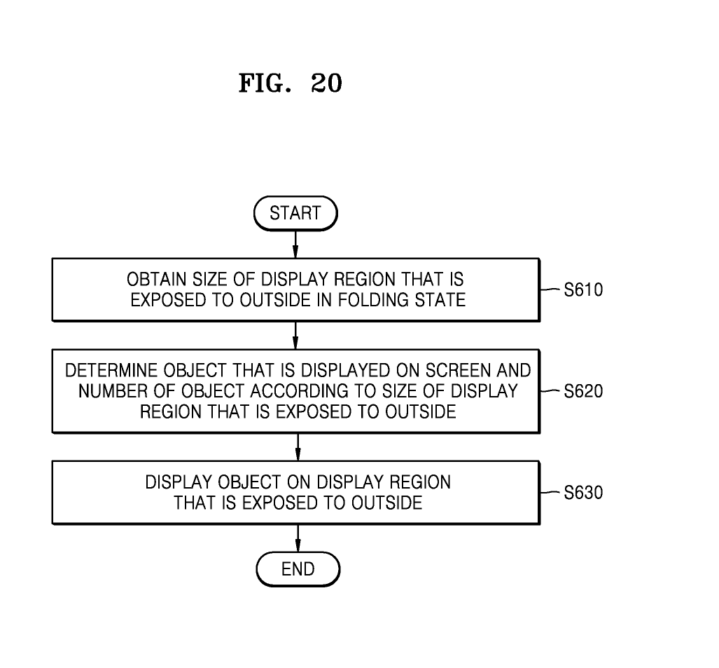

FIG. 20 is a flowchart illustrating an interfacing method of the electronic apparatus 100 that may fold along a plurality of folding lines, according to an exemplary embodiment.

According to an exemplary embodiment, when the electronic apparatus 100 is in a folding state, the electronic apparatus 100 may be in a standby mode or a power saving mode in which the electronic apparatus 100 is turned on but a screen is turned off. The electronic apparatus 100 may receive a user input that changes the screen to an ON state (for example, a state where the screen is activated) in the standby mode or the power saving mode. As the screen is activated, the electronic apparatus 100 may determine whether the electronic apparatus 100 is in the folding state. Also, in operation S610, the electronic apparatus 100 obtains a size or an area of a display region that is exposed to an outside in the folding state. For example, referring to FIG. 19, the electronic apparatus 100 may determine whether the display region is a first exposed region, a second exposed region, or a third exposed region.

In operation S620, the electronic apparatus 100 determines at least one object that is displayed on the screen and a number of the at least one object according to the detected size or area of the display region that is exposed to the outside. Also, in operation S630, the electronic apparatus 100 displays the determined object on the display region that is exposed to the outside. The term “object” may refer to an object that may be selected by the user or an object that indicates alert information. For example, the object may include an icon, a button, an index item, link information, and/or an execution screen of an application.

For example, referring to FIG. 19, the electronic apparatus 100b may vary objects that are displayed on the first exposed region, the second exposed region, and the third exposed region and a number of the objects. In detail, when the first exposed region is detected, the electronic apparatus 100b may display a state screen or an execution screen of an application that is more simplified than that when the electronic apparatus 100 unfolds. However, when the second exposed region or the third exposed region is detected, the electronic apparatus 100b may display the same state screen or execution screen of the application as that when the electronic apparatus 100b unfolds. When the execution screen of the application is displayed on the second exposed region or the third exposed region, because the second exposed region or the third exposed region has an aspect ratio that is different from that when the electronic apparatus 100 unfolds, the electronic apparatus 100b may adjust a ratio at which the execution screen of the application is displayed.

FIG. 21 is a diagram illustrating an example where the electronic apparatus 100b that may fold along a plurality of folding lines displays at least one object according to an exemplary embodiment.

Referring to FIG. 21, the electronic apparatus 100b may provide a first exposed region 2110, a second exposed region 2120, and a third exposed region 2130 to the user according to a method in which the electronic apparatus 100b folds. The first exposed region 2110 may be a display region that is exposed to the outside when the electronic apparatus 100 entirely folds, and the second exposed region 2120 may be a display region that is exposed to the outside when a lower end of the electronic apparatus 100b folds. Also, the third exposed region 2130 may be a display region that is exposed to the outside when an upper end of the electronic apparatus 100b folds.

As shown in a view 2100-1, when the first exposed region 2110 is activated in a folding state, the electronic apparatus 100b may display an icon 2113 of a call application for performing a call function, an icon 2115 of an address book application, and an icon 2111 of a message application on the first exposed region 2110.

Also, the electronic apparatus 100b may detect that the second exposed region 2120 is activated in the folding state. In this case, as shown in a view 2100-2, the electronic apparatus 100b may display a state screen 2121 of the electronic apparatus 100b and missed call information 2123 on the second exposed region 2120 along with the icons 2111, 2113, and 2115 that are displayed on the first exposed region 2110.

Also, the electronic apparatus 100b may detect that the third exposed region 2130 is activated. In this case, as shown in a view 2100-3, the electronic apparatus 100b may display detailed information 2131 about a state of the electronic apparatus 100b along with objects that are displayed on the second exposed region 2120. Alternatively, as the second exposed region 2120 or the third exposed region 2130 is activated, the electronic apparatus 100b may display objects, which are the same as those when the electronic apparatus 100b unfolds, at an aspect ratio, which is different from that when the electronic apparatus 100b unfolds.

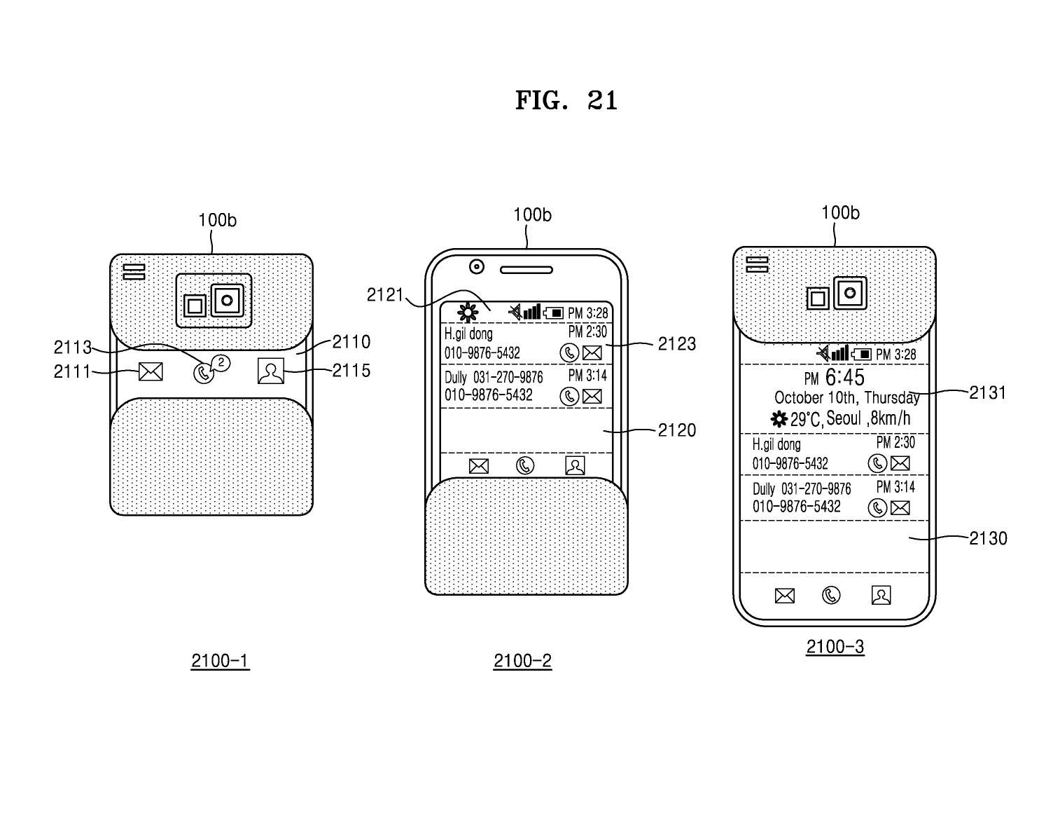

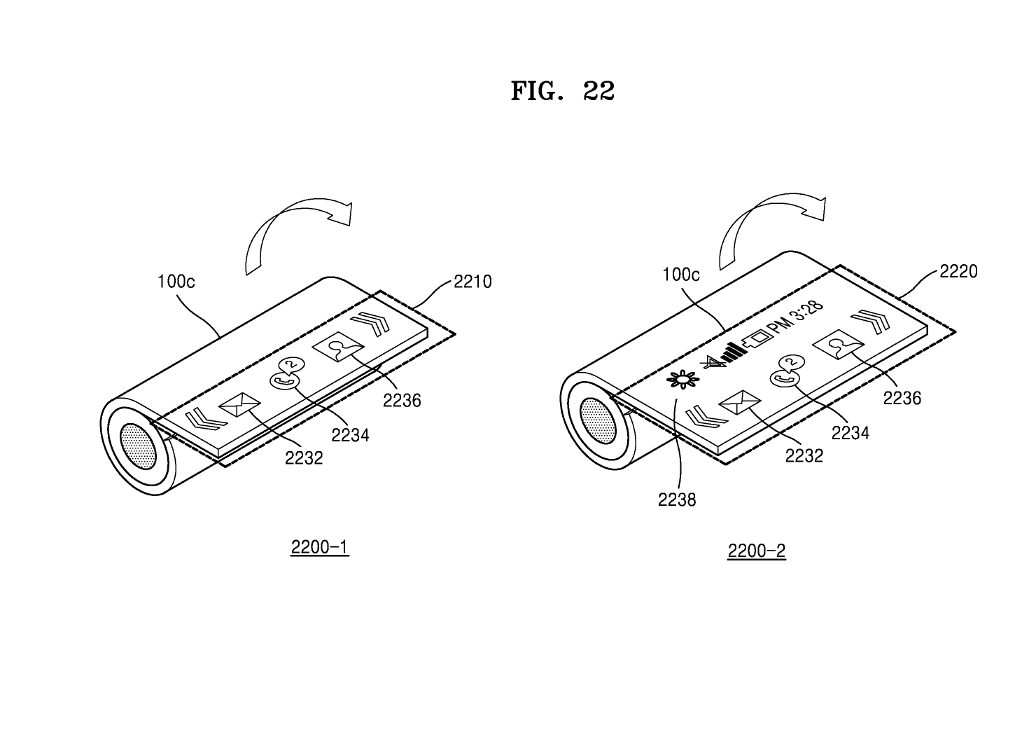

FIG. 22 is a diagram illustrating an example where an electronic apparatus 100c displays at least one object, according to an exemplary embodiment.

As shown in FIG. 22, the electronic apparatus 100c is a rollable electronic apparatus including a rollable display. The user activates a screen of a region of the rollable display by unrolling a part of the rollable display that rolls into a scroll.

Also, the electronic apparatus 100c obtains sizes of display regions 2210 and 2220 that are activated based on an unfolding curvature at which the electronic apparatus 100c unfolds. For example, the electronic apparatus 100c may measure the unfolding curvature at which the electronic apparatus 100c unfolds based on a state detection sensor. For example, the state detection sensor may include at least one among a proximity sensor, an illumination sensor, a magnetic sensor, a bending sensor, and an infrared sensor, or a combination thereof. The electronic apparatus 100c may obtain a size of the rollable display that unfolds at a curvature that is greater than a critical curvature.

The electronic apparatus 100c may determine objects that are to be displayed on the display regions 2210 and 2220 that are activated or a number of the objects. For example, as shown in a view 2200-1, when the obtained size is less than a critical size, the electronic apparatus 100c displays an icon 2232 of a message application, an icon 2234 of a call application, and an icon 2236 of an address book application. Also, as shown in a view 2200-2, the electronic apparatus 100c displays a state screen 2238, in addition to the icons 2232, 2234, and 2236 of the applications for performing a call function as the obtained size increases to be greater than the critical size.

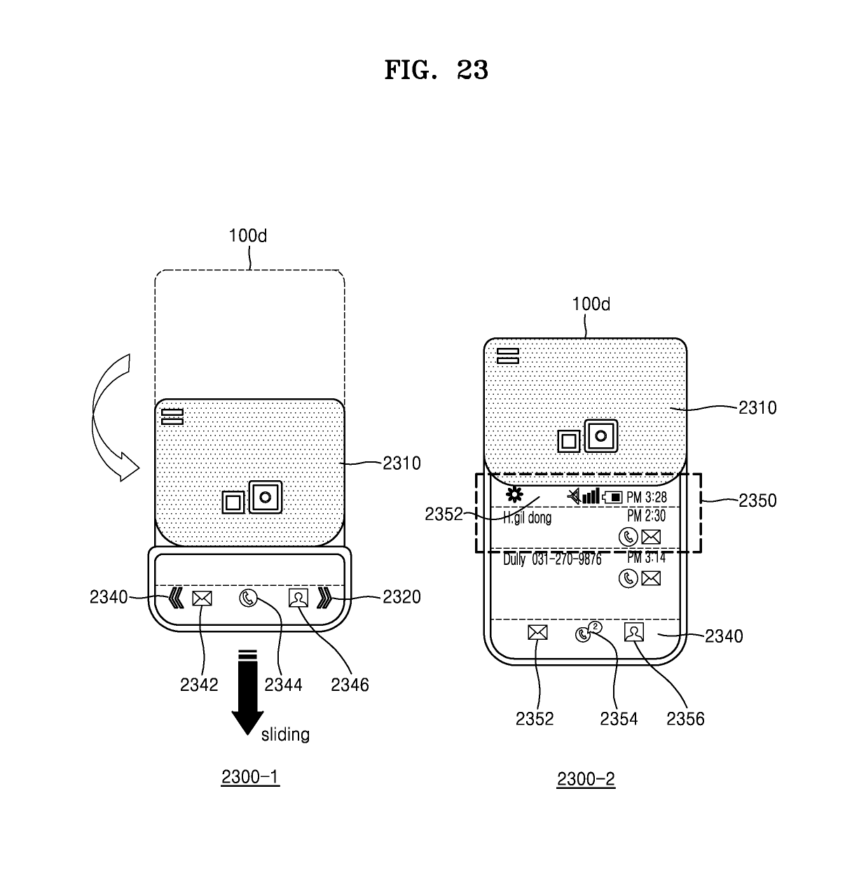

FIG. 23 is a diagram illustrating an example where an electronic apparatus 100d displays at least one object, according to another exemplary embodiment.

The electronic apparatus 100d includes a main housing 2310, and a sliding housing 2320 including an auxiliary display, as shown in FIG. 23. The auxiliary display is disposed on a front surface of the sliding housing 2320 to face the outside. Also, the sliding housing 2320 may slide in a state where the sliding housing 2320 faces the main housing 2310.

The electronic apparatus 100d activates a screen 2340 of the auxiliary display that is exposed to the outside in a state where an upper portion of the main housing 2310 folds and the sliding housing 2320 overlaps the main housing 2310. Also, the electronic apparatus 100d activates a screen 2350 of a main display of the main housing 2310 and the screen 2340 of the auxiliary display when the sliding housing 2320 slides to a lower end of the main housing 2310. The electronic apparatus 100d may determine objects that are to be displayed on a screen and a number of the objects according to sizes of the screens that are activated.

As shown in a view 2300-1, when only the screen 2340 of the auxiliary display is activated, the electronic apparatus 100d displays an icon 2342 of a message application, an icon 2344 of a call application, and an icon 2346 of an address book application on the auxiliary display. As shown in a view 2300-2, when both the screen 2350 of the main display and the screen 2340 of the auxiliary display are activated, the electronic apparatus 100d displays a state screen 2352, in addition to the icons 2342, 2344, and 2346 of the applications for performing a call function.

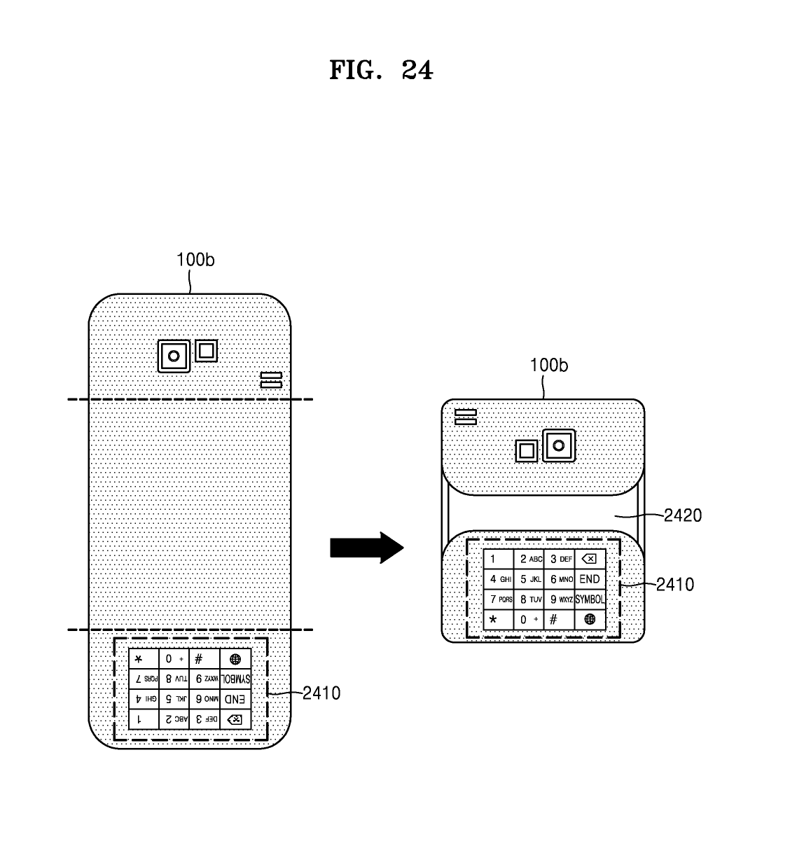

FIG. 24 is a diagram illustrating an example of the electronic apparatus 100b of FIG. 19, according another exemplary embodiment.

The foldable electronic apparatus 100b of FIG. 19 may include letter and number input buttons 2410 for inputting letters and numbers that are disposed on a rear surface of the electronic apparatus 100b.

As shown on the right of FIG. 24, when a lower end of the electronic apparatus 100b folds, the letter and number input buttons 2410 may be disposed to face the user along with a first exposed region 2420. The user may input letters and numbers by using the letter and number input buttons 2410 when the electronic apparatus 100d is in a folding state. Accordingly, the user may conveniently write a text message even when the electronic apparatus 100d is in the folding state, and may conveniently input a telephone number of the other party to whom a call is to be made.

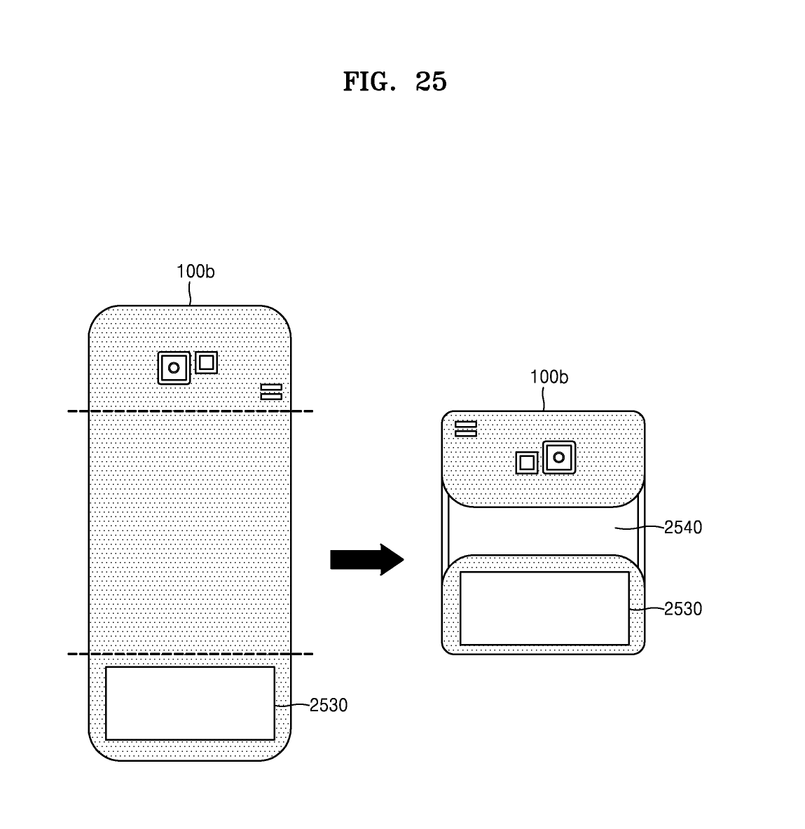

FIG. 25 is a diagram illustrating an example of the electronic apparatus 100b of FIG. 19, according to another exemplary embodiment.

The foldable electronic apparatus 100b of FIG. 19 may include a plurality of displays that are spaced apart from one another. As shown in FIG. 25, the electronic apparatus 100b may include a main display that is provided on a front surface of the electronic apparatus 100b and an auxiliary display 2530 that is provided on a rear surface of the electronic apparatus 100b.

As shown on the right of FIG. 25, when a lower end of the electronic apparatus 100b folds, the auxiliary display 2530 may be disposed to face the user along with a region 2540 of the main display that is exposed to the outside when the electronic apparatus 100b is in a folding state. The electronic apparatus 100b may display at least one object by using the region 2540 of the main display and the auxiliary display 2530.

FIG. 26 is a block diagram illustrating an electronic apparatus 1000 according to an exemplary embodiment.

As shown in FIG. 26, a configuration of the electronic apparatus 1000 may be applied to any of various apparatuses such as a mobile phone, a tablet PC, a personal digital assistant (PDA), an MP3 player, a kiosk, a digital photo frame, a navigation system, a digital TV, or a wearable device.

Referring to FIG. 26, the electronic apparatus 1000 may include at least one among a controller 1010, a display 1020, a memory 1030, a sensor 1035, a communication interface 1040, a video processor 1060, an audio processor 1065, a user interface 1050, a microphone 1070, an image pickup 1075, a speaker 1080, and a motion detector 1085.

When a user input is received when the electronic apparatus 1000 is in a standby mode or a power saving mode, the controller 1010 may receive information indicating whether the electronic apparatus 1000 is in a folding state or an unfolding state from the sensor 1035. When the electronic apparatus 1000 is in the folding state, the controller 1010 activates a region of the display 1020 that is exposed to the outside when the electronic apparatus 1000 is in the folding state. The controller 1010 controls the user interface 1050 and the display 1020 to activate a touch function on the region of the display 1020 that is exposed to the outside.

Also, the controller 1010 may control the display 1020 to display part of data, which is stored in the memory 1030, on the region of the display 1020 that is exposed to the outside. In other words, the controller 1010 may display the part of the data, which is stored in the memory 1030, on the display 1020.

Alternatively, when a user input is received through the region of the display 1020, the controller 1010 may perform a control operation corresponding to the user input. According to an exemplary embodiment, the controller 1010 may distinguish the user's touch input, which is received through the region of the display 1020 that is exposed to the outside, according to a pressure intensity. The controller 1010 may control a number that is set on a number setting button or a letter that is set on a letter setting button to be changed according to the pressure intensity of the user's touch input. Also, the controller 1010 may control a speed at which address book information is changed according to the pressure intensity of the user's touch input. Also, the controller 1010 may allow or block an incoming call according to the pressure intensity of the user's touch input that is received through the region of the display 1020 on which the incoming call is displayed. Also, as the pressure intensity of the user's touch input that is received through the region of the display 1020 on which alert information about a message is displayed increases, the controller 1010 may control detailed information about the message to be displayed. Also, the controller 1010 may control detailed information corresponding to a state icon to be displayed according to the user's touch input for the state icon. Also, as a user input for a screen switch icon is received, the controller 1010 may control objects that are displayed on the region of the display 1020 that is exposed to the outside to be moved or changed.

The controller 1010 may include at least one among a random-access memory (RAM) 1011, a read-only memory (ROM) 1012, a central processing unit (CPU) 1013, a graphics processing unit (GPU) 1014, and a bus 1015. The RAM 1011, the ROM 1012, the CPU 1013, and the GPU 1014 may be connected to one another via the bus 1015.

The CPU 1013 accesses the memory 1030 and performs booting by using an OS that is stored in the memory 1030. The CPU 1013 performs various operations by using various programs, content, and data that are stored in the memory 1030.

A command set for booting a system is stored in the ROM 1012. For example, when a turn-on command is input and power is supplied to the electronic apparatus 1000, the CPU 1013 may copy the OS that is stored in the memory 1030 into the RAM 1011 according to a command that is stored in the ROM 1012, may execute the OS, and may boot the system. When the booting ends, the CPU 1013 copies the various programs that are stored in the memory 1030 into the RAM 1011, executes the various programs that are copied in to the RAM 1011, and performs various operations. When the electronic apparatus 1000 is completely booted, the GPU 1014 displays a user interface screen on a region of the display 1020. Also, a screen that is generated by the GPU 1014 may be transmitted to the display 1020 and may be displayed on each region of the display 1020.

The display 1020 may symmetrically or asymmetrically fold, and displays at least one object on a region that is exposed to the outside in a folding state.

For example, the display 1020 may display a user interface including at least one object for performing a call function on the region that is exposed to the outside. The user interface may include an object that indicates a missed call and information about a sender of the missed call. Also, the user interface may include number setting objects for inputting a telephone number or letter setting objects for inputting a name. Also, the user interface may include an object that indicates address book information. Also, the user interface may include an object that indicates an incoming call and information about a sender of the incoming call. Also, the user interface may include an object about message alert information. Also, the user interface may include a state icon that indicates time information, a state icon that indicates weather information, a state icon that indicate an alert mode, and a state icon that indicates a battery level.

The display 1020 includes a display panel 1021 and a controller (not shown) that controls the display panel 1021. The display panel 1021 may be any of various displays such as a liquid crystal display (LCD), an organic light-emitting diode (OLED), an active-matrix organic light-emitting diode (AM-OLED), or a plasma display panel (PDP). The display panel 1021 may be flexible, transparent, or wearable. The display 1020 may be coupled to a touch panel 1052 of the user interface 1050 and may be provided as a touchscreen (not shown). For example, the touchscreen may include a module in which the display panel 1021 and the touch panel 1052 are integrally coupled to be stacked. Also, the touchscreen may further include a resistive sensor that is provided in a part of the module in which the display panel 1021 and the touch panel 1052 are integrally coupled to be stacked.

The memory 1030 may include at least one among an internal memory (not shown) and an external memory (not shown).

The internal memory may include at least one among, for example, a volatile memory (e.g., a dynamic RAM (DRAM), a static RAM (SRAM), or a synchronous dynamic RAM (SDRAM)), a nonvolatile memory (e.g., a one-time programmable ROM (OTPROM), a programmable ROM (PROM), an erasable and programmable ROM (EPROM), an electrically erasable and programmable ROM (EEPROM), a mask ROM, or a flash ROM), a hard disc drive (HDD), and a solid-state drive (SSD).

According to an exemplary embodiment, the controller 1010 may load a command or data that is received from a nonvolatile memory or at least one among other elements into a volatile memory and may process the loaded command or data. Also, the controller 1010 may store data that is received from or generated by other elements in the nonvolatile memory.

The external memory may include at least one among, for example, a compact flash (CF), a secure digital (SD), a micro secure digital (micro-SD), a mini secure digital (mini-SD), an extreme digital (xD), and a memory stick.

The memory 1030 may store various programs and data that are used to operate the electronic apparatus 1000. For example, at least part of content that is to be displayed on a lock screen may be temporarily or semi-permanently stored in the memory 1030.

The sensor 1035 may detect a folding state and an unfolding state of the electronic apparatus 1000. For example, the sensor 1035 may detect a folding state or an unfolding state by using a hall sensor or a magnetic sensor that is provided in a folding structure. Also, the sensor 1035 may detect whether the electronic apparatus 1000 is in a folding state.

The sensor 1035 may measure a bending or folding angle (or an unfolding angle) of the electronic apparatus 1000. Also, the sensor 1035 may detect a position of a folding line along which the electronic apparatus 1000 bends or folds. Also, the sensor 1035 may detect a folding state by using a state detection sensor that is disposed at a position where both portions of the electronic apparatus 1000 are close to each other when the electronic apparatus 1000 bends or folds. The state detection sensor may include at least one among a proximity sensor, an illumination sensor, a magnetic sensor, a hall sensor, a touch sensor, a bending sensor, and an infrared sensor, or a combination thereof.

The communication interface 1040 may communicate with any of various external devices according to any of various communication methods. The communication interface 1040 may include at least one among a WiFi chip 1041, a Bluetooth chip 1042, a wireless communication chip 1043, and a near field communication (NFC) chip 1044. The controller 1010 may send and receive a call and a message to and from any of various external devices by using the communication interface 1040.

The WiFi chip 1041 and the Bluetooth chip 1042 may allow communications respectively by using a WiFi method and a Bluetooth method. When the WiFi chip 1041 or the Bluetooth chip 1042 is used, various connection information such as service set identification (SSID) and a session key may be first transmitted/received, communication networks may be connected by using the various connection information, and then various information may be transmitted/received. The wireless communication chip 1043 is a chip that performs communications according to any of various communication specifications such as Institute of Electrical and Electronics Engineers (IEEE), ZigBee, 3^{rd} Generation (3G), 3^{rd} Generation Partnership Project (3GP), or Long Term Evolution (LTE). The NFC chip 1044 is a chip that operates by using an NFC method using a band of 13.56 MHz from among various RF-ID frequency bands such as 135 kHz, 13.56 MHz, 433 MHz, 860-960 MHz, and 2.45 GHz.

The video processor 1060 may process video data that is included in content that is received through the communication interface 1040 or content that is stored in the memory 1030. The video processor 1060 may perform various image processing such as decoding, scaling, noise filtering, frame rate conversion, or resolution conversion on the video data.

The audio processor 1065 may process audio data that is included in content that is received through the communication interface 1040 or content that is stored in the memory 1030. The audio processor 1065 may perform various processing such as decoding, amplification, or noise filtering on the audio data.

When a reproduction program for multimedia content is executed, the controller 1010 may drive the video processor 1060 and the audio processor 1065 to reproduce the multimedia content. The speaker 1080 may output audio data that is generated by the audio processor 1065.

The user interface 1050 may receive various commands from the user. The user interface 1050 may include at least one among a key 1051, the touch panel 1052, and a pen recognition panel 1053.

The touch panel 1052 may detect the user's touch input and may output a touch event value corresponding to a detected touch signal. According to an exemplary embodiment, the touch panel 1052 may receive the user's touch input including at least one among a tap gesture, a touch and hold gesture, a double tap gesture, a drag gesture, panning gesture, a flick gesture, and a drag and drop gesture. When the touch panel 1052 is coupled to the display panel 1021 to form a touchscreen (not shown), the touchscreen may include any of various touch sensors such as a capacitive sensor, a resistive sensor, or a piezoelectric sensor.

A capacitive method is a method of calculating a touch position (e.g., coordinates) by using a dielectric body coated on a surface of a touchscreen and detecting fine electricity that is generated in a user's body when the user's body part touches a surface of the touchscreen. A resistive method is a method of calculating a touch position (e.g., coordinates) by using two electrode plates that are provided in a touchscreen and detecting current that flows when a user touches a screen and the two electrode plates contact each other at a touch point. Although a touch event that occurs on the touchscreen may be mainly caused by a human finger, a touch event may also be caused by a conductive material that may change a capacitance.

The key 1051 may be any of various keys such as mechanical buttons or a wheel that is formed on any of various portions of a front surface, a side surface, or a rear surface of a main outer body of the electronic apparatus 1000.

The pen recognition panel 1053 may detect a proximity input or a touch input of a pen as the user uses a touch pen (e.g., a stylus pen) or a digitizer pen and may output a pen proximity event or a pen touch event. The pen recognition panel 1053 may be implemented as, for example, an electro-magnetic resonance (EMR) system, and may detect a touch or proximity input according to a change in the intensity of an electromagnetic field as a pen is touched or approached. In detail, the pen recognition panel 1053 may include an electromagnetic induction coil sensor (not shown) having a grid structure and an electromagnetic signal processor (not shown) that sequentially applies alternating current (AC) signals having predetermined frequencies to loop coils of the electromagnetic induction coil sensor. When a pen including a resonance circuit is disposed around a loop coil of the pen recognition panel 1053, a magnetic field that is transmitted from the loop coil generates current based on mutual electromagnetic induction in the resonance circuit of the pen. An induced magnetic field may be generated from a coil of the resonance circuit in the pen based on the current, and the pen recognition panel 1053 may detect the induced magnetic field from a loop coil that is in a signal receiving state and may detect an access position or a touch position of the pen. The pen recognition panel 1053 may have an area in a lower portion of the display panel 1021, for example, an area large enough to cover a display region of the display panel 1021.

The microphone 1070 may receive the user′ voice or other sounds and may convert the user′ voice or the other sounds into audio data. The controller 1010 may use the user's voice that is input through the microphone 1070 during a call operation, or may convert the user's voice into audio data and may store the audio data in the memory 1030.

The image pickup 1075 may capture a still image or a moving picture according to the user's control. A plurality of image pickups may be provided as, for example, front cameras or rear cameras.

When the image pickup 1075 and the microphone 1070 are provided, the controller 1010 may perform a control operation according to the user's motion that is recognized by the image pickup 1075 or the user's voice that is input through the microphone 1070. For example, the electronic apparatus 1000 may operate in a motion control mode or a voice control mode. When the electronic apparatus 1000 operates in the motion control mode, the controller 1010 may photograph the user by activating the image pickup 1075, may track a change in the user's motion, and may perform a control operation corresponding to the change. When the electronic apparatus 1000 operates in the voice control mode, the controller 1010 may operate in a voice recognition mode in which the controller 1010 analyzes the user's voice that is input through the microphone 1070 and performs a control operation according to the analyzed user's voice.

The motion detector 1085 may detect a motion of a main body of the electronic apparatus 1000. The electronic apparatus 100 may rotate or incline in various directions. In this case, the motion detector 1085 may detect motion characteristics such as a rotation direction, a rotation angle, or a gradient by using at least one among various sensors such as a terrestrial magnetism sensor, a gyro-sensor, and an acceleration sensor.

According to other exemplary embodiments, although not shown in FIG. 26, the electronic apparatus 1000 may further include various external input ports for connecting to various external terminals such as a universal serial bus (USB) port to which a USB connector may be connected, a headset, a mouse, and a local area network (LAN), a digital multimedia broadcasting (DMB) chip that receives and processes a DMB signal, and various sensors.

Names of elements of the electronic apparatus 1000 may be altered. Also, the electronic apparatus 100 according to the present exemplary embodiment may include at least one among the elements, may omit some elements, or may further include other additional elements.

Also, the controller 1010 of FIG. 26 may correspond to the controller 220 of FIG. 2, and the sensor 1035 of FIG. 26 may correspond to the state detector 210 of FIG. 2. Also, the display 1020 of FIG. 26 may correspond to the display 230 of FIG. 2.

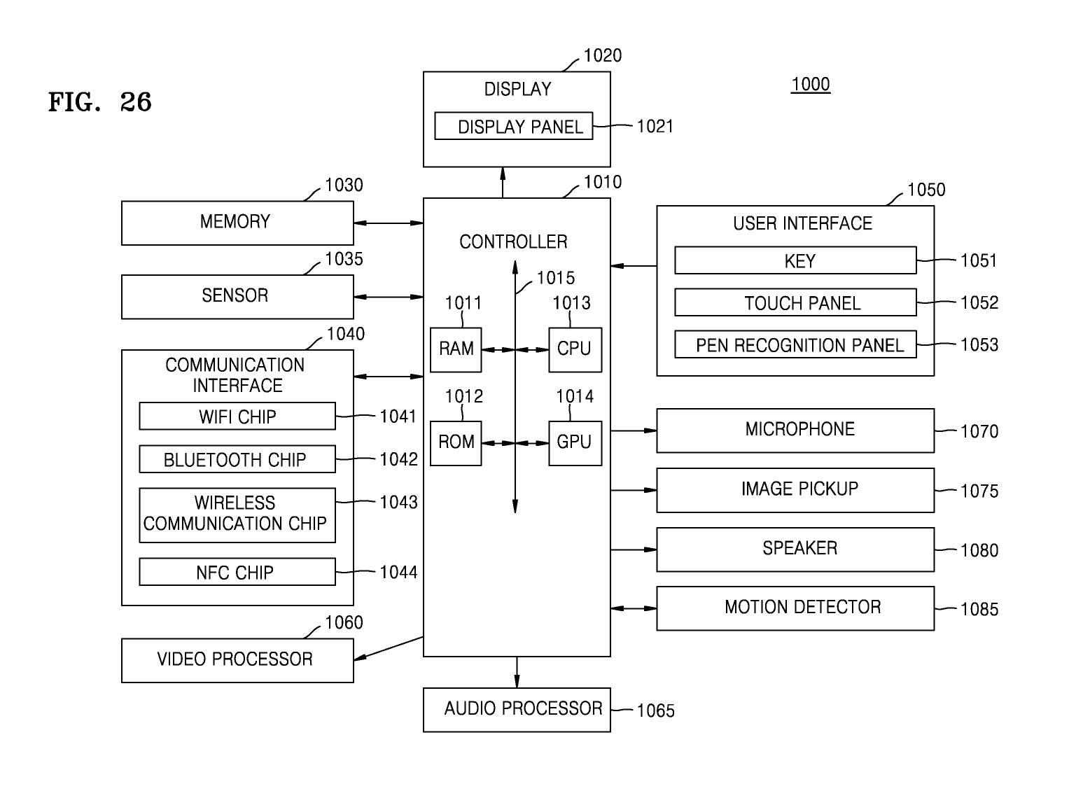

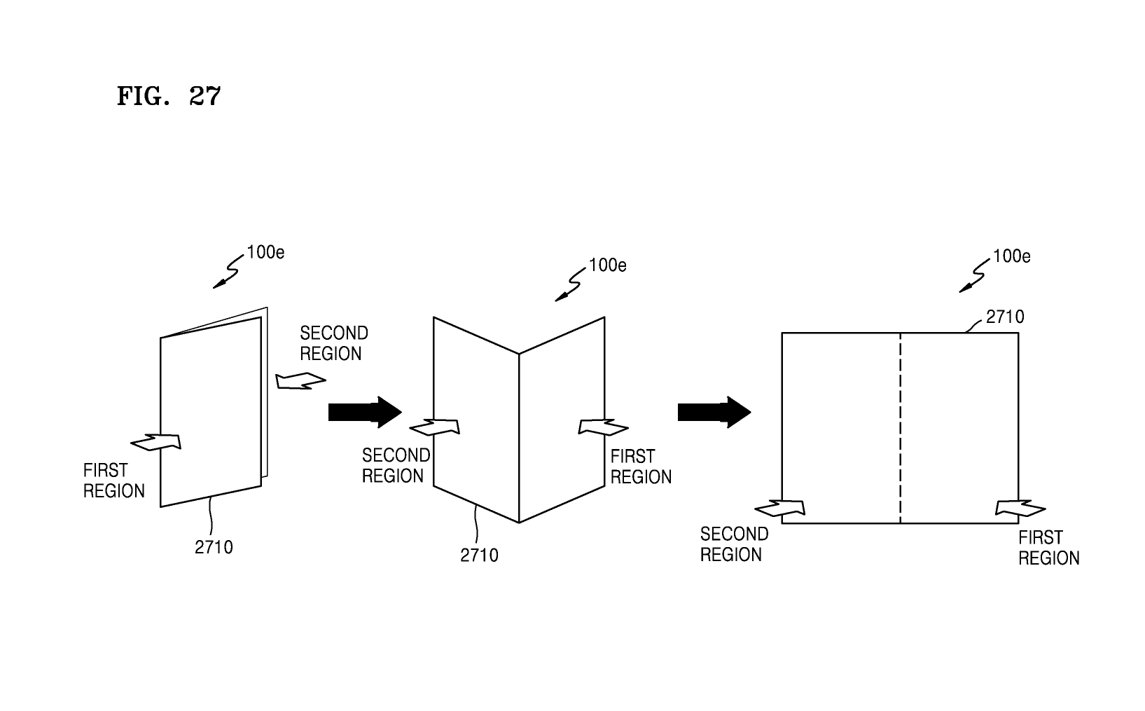

FIG. 27 is a diagram illustrating an electronic apparatus 100e including a flexible display, according to an exemplary embodiment.

Referring to FIG. 27, the electronic apparatus 100e may employ any of various flexible displays 2710 whose type may vary according to an external force, such as a foldable display that may fold at an angle or a curvature or may unfold, a bendable display that may bend at a curvature or may be spread flat, or a rollable display that may roll into a scroll.

Like an existing display such as an LCD or an LED display, the flexible display 2710 may display a screen on which information that is processed or to be processed by an OS that is driven in the electronic apparatus 100e is displayed. For example, the flexible display 2710 may display an execution screen of an application that is processed by the OS, a lock screen, a background screen, and an application list screen. The flexible display 2710 may correspond to the display 1020 of FIG. 26.

Also, the flexible display 2710 may have an input interfacing function of a touchscreen or a touchpad. Accordingly, the flexible display 2710 may detect the user's touch input and the electronic apparatus 100e may be controlled according to the detected touch input.

The following will be explained with the electronic apparatus 100e of FIG. 27 employing a foldable display as the flexible display 2710. However, the electronic apparatus 100e may employ a bendable display or a rollable display as will described with other drawings.

The user may use the electronic apparatus 100e in a completely folding state, that is, in a state where an unfolding angle is “0°” In this case, when the electronic apparatus 100e is in the completely folding state, a first region of the flexible display 2710 that is exposed to the user may be activated. In this case, a second region of the flexible display 2710 that is not exposed to the user may be inactivated.

Alternatively, the user may use the electronic apparatus 100e in an unfolding state, that is, in a state with an unfolding angle of “180°”. In this case, the second region of the flexible display 2710 that is exposed to the user may be changed to be activated.

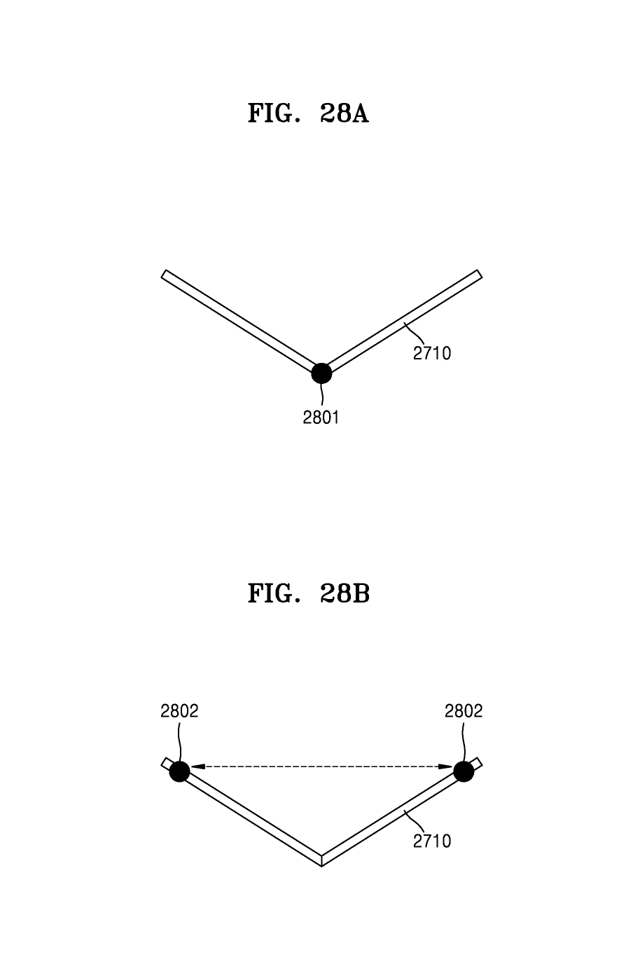

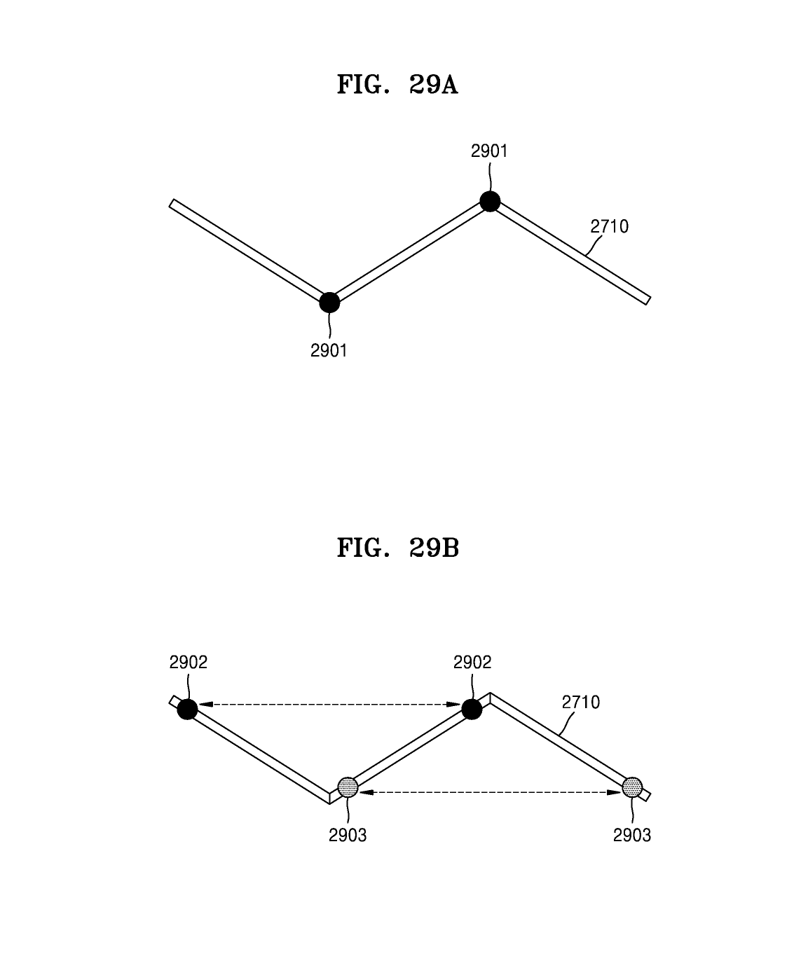

The flexible display 2710 may fold along one folding line as shown in FIG. 28A or 28B. However, the flexible display 2710 may have two or more folding lines as shown in FIG. 29A or 29B. Each folding line is a line along which the flexible display 2710 folds. For example, the folding line may be a line along which the flexible display 2710 folds due to a hinge unit that is provided on the electronic apparatus 100e. When the electronic apparatus 100e symmetrically folds, the folding line may be a middle line of the flexible display 2710. However, when the electronic apparatus 100e folds, the folding line may not be a middle line of the flexible display 2710.

The electronic apparatus 100e may change an OS that is driven in the electronic apparatus 100e according to an unfolding degree of the electronic apparatus 100e. Alternatively, the electronic apparatus 100e may drive a plurality of different OSs according to an unfolding degree of the electronic apparatus 100e. OS manufacturers may provide various OSs (for example, an OS for smartphones, an OS for tablets, and an OS for computers) according to a size of a screen of a target apparatus in which the OS is driven. Accordingly, the electronic apparatus 100e needs to provide different OSs based on the user's unfolding degree of the electronic apparatus 100e.

Also, an application may be executed only in a specific OS. Accordingly, the electronic apparatus 100e needs to drive a plurality of OSs as desired.

That is, as shown in FIG. 27, the electronic apparatus 100e may change an OS that is driven in the electronic apparatus 100e as the electronic apparatus 100e unfolds from an unfolding degree of “0°” to an unfolding degree to “135°”. Alternatively, as the electronic apparatus 100e unfolds, the electronic apparatus 100e may further drive an OS other than an OS that is being currently driven. Exemplary embodiments in which as the electronic apparatus 100e unfolds, an OS that is driven in the electronic apparatus 100e is changed or added will now be explained.

FIG. 28A is a view illustrating a method of detecting an unfolding operation of the electronic apparatus 100e, according to an exemplary embodiment.

Referring to FIG. 28A, the electronic apparatus 100e may fold along one folding line. For example, the sensor 1035 (see FIG. 26) of the electronic apparatus 100e may include a state detection sensor 2801. The state detection sensor 2801 may be disposed on the folding line of the electronic apparatus 100e, and may measure an unfolding degree of the electronic apparatus 100e. The folding line that is a line along which the flexible display 110 folds may be a middle line of the flexible display 2710 when the electronic apparatus 100e symmetrically folds. However, when the flexible display 2710 folds, the folding line may not be the middle line of the flexible display 2710.

FIG. 28B is a view illustrating a method of detecting an unfolding operation of the electronic apparatus 100e, according to another exemplary embodiment.

Referring to FIG. 28B, the flexible display 2710 may fold about one folding line, like in FIG. 28A. However, state detection sensors 2802 of FIG. 28B may be disposed on both ends of the flexible display 2710, not on the folding line of the flexible display 2710 in FIG. 28A, and may measure an unfolding angle of the flexible display 2710. In this case, the state detection sensors 2802 may measure an unfolding angle of the flexible display 2710 by using a distance between the state detection sensors 2802. Also, the state detection sensors 2802 may be infrared sensors for measuring a distance.

FIG. 29A is a view illustrating a method performed by the electronic apparatus 100e to detect an unfolding operation, according to another exemplary embodiment.

Referring to FIG. 29A, the flexible display 2710 may fold along a plurality of (e.g., two) folding lines. Two state detection sensors 2901 may be respectively disposed on the two folding lines of the flexible display 2710 and may measure an unfolding angle of the flexible display 2710.

FIG. 29B is a view illustrating a method performed by the electronic apparatus 100e to detect an unfolding operation, according to another exemplary embodiment.

Referring to FIG. 29B, the flexible display 2710 may fold along a plurality of (e.g., two) folding lines, like in FIG. 29A. However, two pairs of state detection sensors 2902 and 2903 FIG. 29B may be disposed on both ends of the flexible display 2710 and along the folding lines of the flexible display 271 and may measure an unfolding angle of the flexible display 2710, unlike in FIG. 29A. In this case, one pair of state detection sensors 2902 and the other pair of the state detection sensors 2903 may measure an unfolding angle of the flexible display 2710 by using a distance between the state detection sensors 2902 and a distance between the state detection sensors 2903. The state detection sensors 2902 and 2903 may be camera, infrared camera or infrared sensors for measuring a distance.

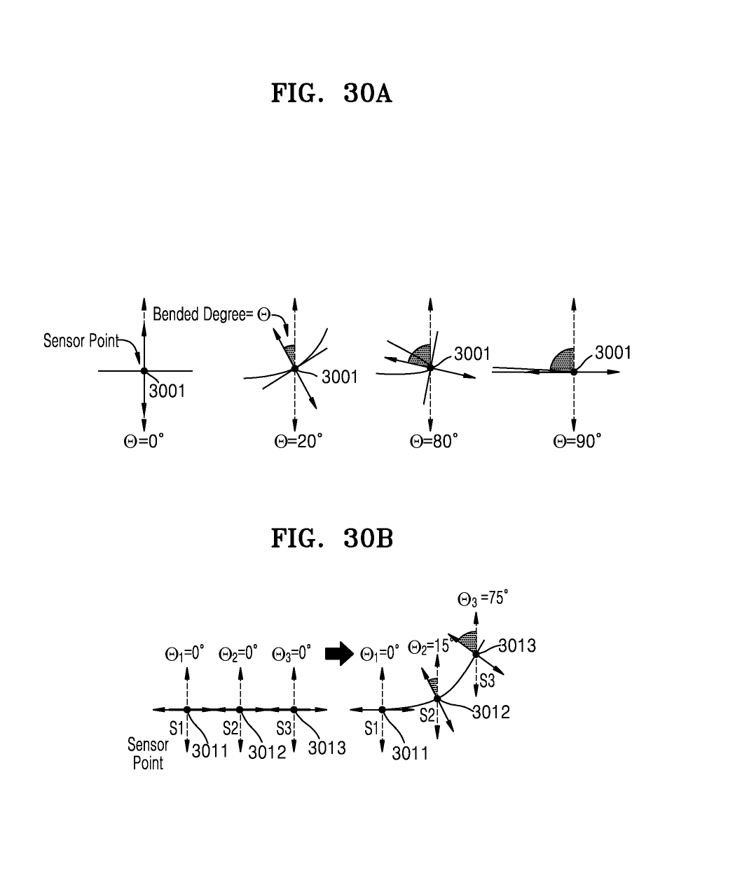

FIGS. 30A and 30B are views illustrating a method performed by the controller 1010 to detect an unfolding angle of the flexible display 2710, according to an exemplary embodiment. Referring to FIGS. 30A and 30B, the electronic apparatus 100e may collect a change in a value of a sensor point at which a state detection sensor 3001 is disposed.

Referring to FIG. 30A, the state detection sensor 3001 may detect a flexural curvature at the sensor point. For example, the state detection sensor 3001 may detect a flexural curvature ranging from +180° to −180°. Also, referring to FIG. 30B, a plurality of state detection sensors 3011, 3012, and 3013 that are arranged at predetermined intervals may detect a flexural curvature at their sensor points. Also, the detected flexural curvature may be provided to the controller 1010.

The controller 1010 may detect an unfolding operation of the electronic apparatus 100e based on the flexural curvature provided by the state detection sensor 3001.

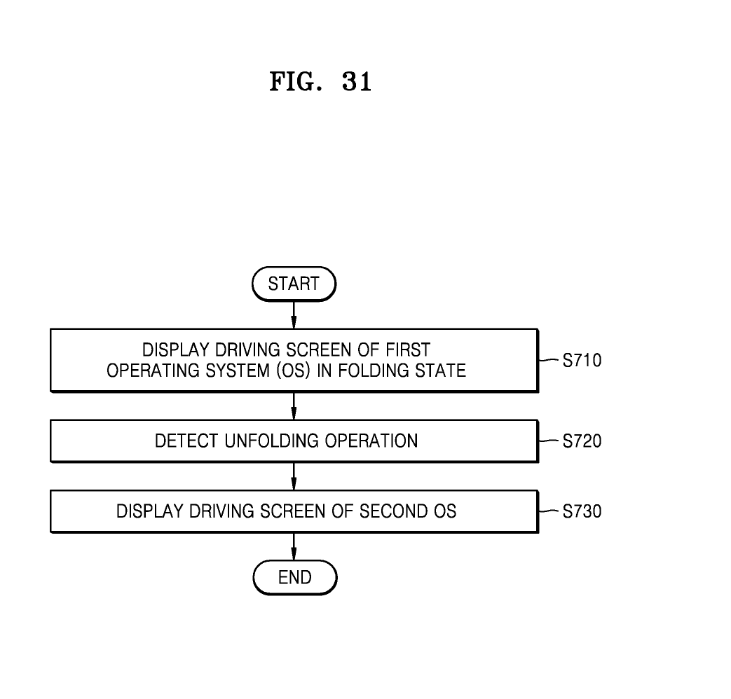

FIG. 31 is a flowchart illustrating a method performed by the electronic apparatus 100e to provide a driving screen of at least one OS, according to an exemplary embodiment.

Referring to FIG. 31, in operation S710, the controller 1010 controls a display to display a screen on which information that is processed or to be processed by a first OS that is driven in the electronic apparatus 100e (hereinafter, referred to as a ‘driving screen of the first OS’), when the electronic apparatus 100e is in a folding state. When the electronic apparatus 100e is in the folding state, the controller 1010 may control the display to display the driving screen of the first OS on a first region of the flexible display 2710. In this case, the first OS may be an OS that is developed to be suitable for apparatuses employing small displays such as an OS for smartphones, an OS for MP3s, an OS for navigation systems, and an OS for cameras.

In operation S720, the controller 1010 detects an unfolding operation of the electronic apparatus 100e. Also, in operation S730, the controller 1010 controls the display to display a driving screen of a second OS as the electronic apparatus 100e unfolds. As the electronic apparatus 100e unfolds, the controller 100e may activate a second region of the flexible display 2710 that is exposed to the user of the electronic apparatus 100e. In this case, the controller 1010 may control to display the driving screen of the second OS including an OS for tablets, an OS for PCs, or an OS for TVs as a size of a screen of the electronic apparatus 100e that is exposed to the user gradually increases.

According to an exemplary embodiment, the controller 1010 may change the first OS that is driven in the electronic apparatus 100e into the second OS as the electronic apparatus 100e unfolds. In this case, the controller 1010 may control to display the driving screen of the second OS on an unfolding screen. For example, the controller 1010 may re-boot a system of the electronic apparatus 100e by executing the second OS by copying execution data of the second OS that is stored in the memory 1030 into the RAM 1011. Alternatively, the second OS may be a cloud OS. In this case, the controller 1010 may access a cloud server through the communication interface 1040 and may receive display data corresponding to a driving screen of the cloud OS that is driven in the cloud server.

According to an exemplary embodiment, the electronic apparatus 100e may drive the second OS along with the first OS as the electronic apparatus 100e unfolds. For example, the controller 1010 may drive the second OS on a virtual machine by executing the virtual machine. In this case, the second OS may be a virtual OS. Also, the virtual machine is an emulation of a computing environment of the electronic apparatus 100e by using software, and the virtual OS may drive a virtual system platform that is provided by the virtual machine.

Although the electronic apparatus 100e that is in a folding state gradually unfolds from the folding state, the present exemplary embodiment is not limited thereto. For example, the electronic apparatus 100e that is in an unfolding state may gradually fold from the unfolding state. In this case, the controller 1010 may change the driving screen of the second OS into the driving screen of the first OS.

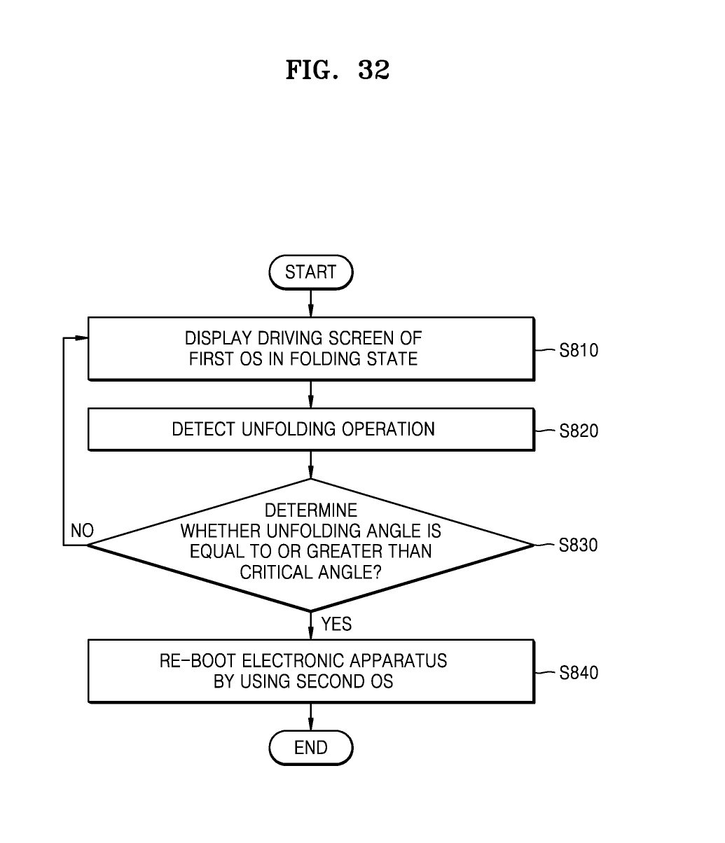

FIG. 32 is a flowchart illustrating a method performed by the electronic apparatus 100e to change a driving screen of a first OS into a driving screen of a second OS, and display the driving screen of the second OS through a system re-booting process, according to an exemplary embodiment.

Referring to FIG. 32, in operation S810, the controller 1010 controls a display to display the driving screen of the first OS when the electronic apparatus 100e is in the folding state. Also, in operation S820, the controller 1010 detects a user's operation of unfolding the electronic apparatus 100e. In this case, the controller 1010 may measure an unfolding angle at which the electronic apparatus 100e unfolds. For example, like in FIG. 28A or 29A, the electronic apparatus 100e may measure an unfolding angle by using the state detection sensor 2801 or 2901 that is disposed on a folding line of the electronic apparatus 100e. Alternatively, like in FIG. 28B or 29B, the sensor 1035 may measure an unfolding angle by using the state detection sensors 2802, 2902, or 2903 that are disposed on both ends of the flexible display 2710. The measured unfolding angle may be provided to the controller 1010.

In operation S830, it is determined whether the unfolding angle is equal to or greater than a critical angle. When it is determined in operation S830 that the unfolding angle is equal to or greater than the critical angle, the method proceeds to operation S840. In operation S840, the controller 1010 re-boots the electronic apparatus 100e by using the second OS. For example, when the unfolding angle is equal to or greater than “150°”, the controller 1010 may end the first OS and may drive the second OS. For example, the controller 1010 may re-boot the system by copying execution data of the second OS that is stored in the memory 1030 into the RAM 1011.

After the system is re-booted, the controller 1010 may control the display to display the driving screen of the second OS.

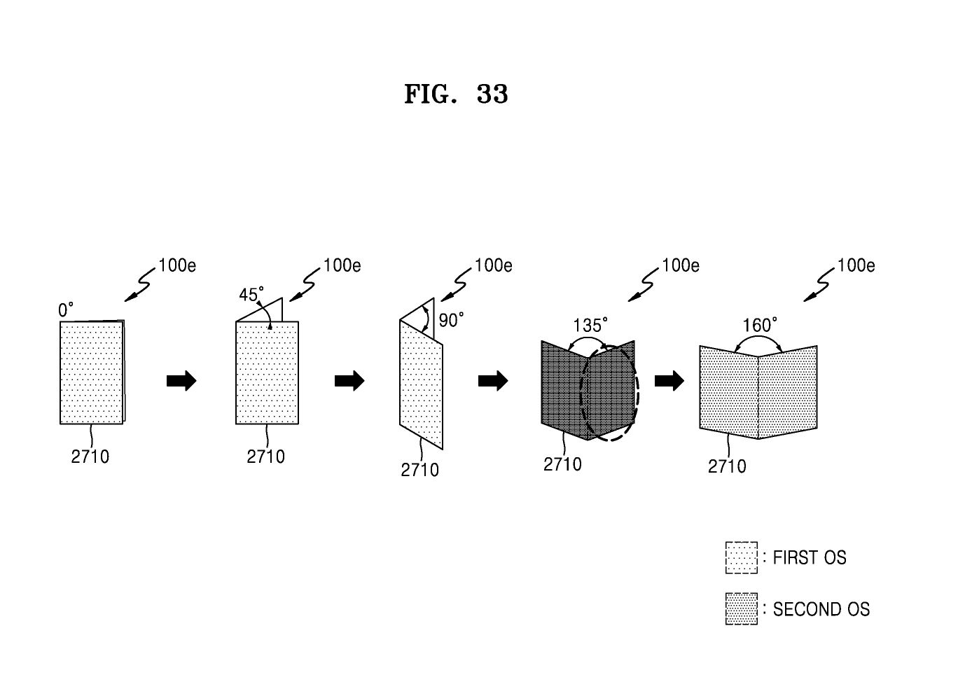

FIG. 33 is a diagram illustrating an example where the electronic apparatus 100e changes a driving screen of a first OS into a driving screen of a second OS, and displays the driving screen of the second OS through a system re-booting process, according to an exemplary embodiment.

Referring to FIG. 33, the electronic apparatus 100e may measure an unfolding angle of the electronic apparatus 100e by using values that are received from state detection sensors. The electronic apparatus 100e may end the first OS and may drive the second OS when the unfolding angle is equal to or greater than a critical angle (for example, “150°”). In this case the first OS that ends may be an OS for smartphones, and the second OS that is newly driven may be an OS for tablets.

While the electronic apparatus 100e displays an execution screen of an application, the electronic apparatus 100e may unfold. In this case, the electronic apparatus 100e may store information about the application that is executed on the first OS in the memory 1030, and may re-execute the same application on the second OS by using the information about the application that is stored in the memory 1030 as the second OS is driven. Accordingly, the electronic apparatus 100e may continuously provide the execution screen of the same application, which is executed on the different OSs, to the user. In this case, when applications are the same, it may mean that when two applications having the same purpose are developed by the same application developer to be suitable for different OSs (for example, a Linux application and a window application), the applications may be same.

Alternatively, while the electronic apparatus 100e displays a home screen of the first OS, the electronic apparatus 100e may unfold. In this case, the electronic apparatus 100e may display a home screen of the second OS as the second OS is driven. In this case, the home screen of the second OS may be a home screen for tablets that is suitable for the electronic apparatus 100e including the flexible display 2710 that unfolds.

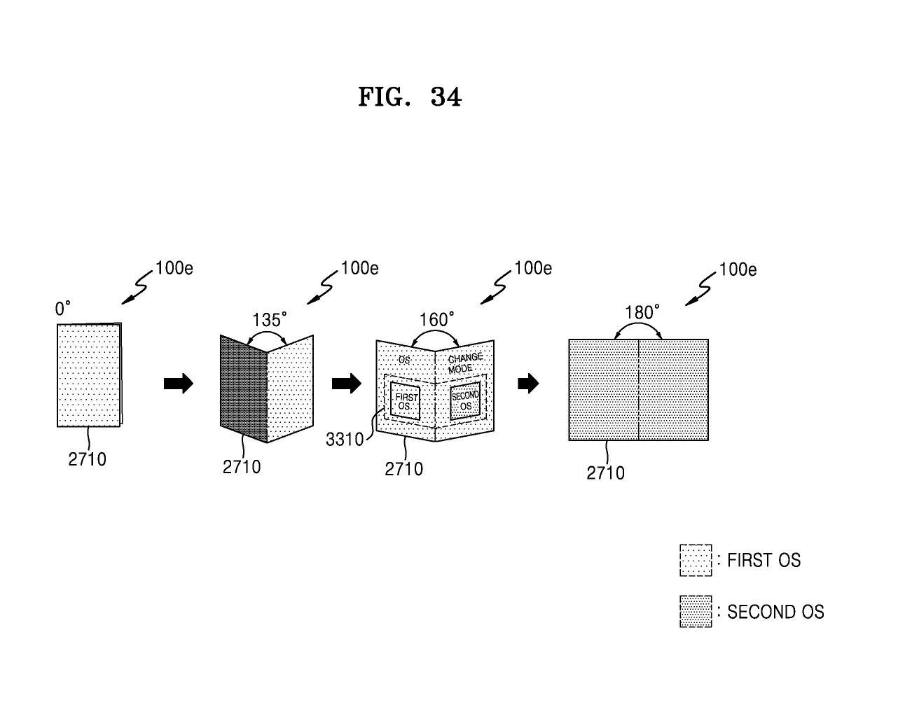

FIG. 34 is a diagram illustrating an example where the electronic apparatus 100e changes a driving screen of a first OS into a driving screen of a second OS, and displays the driving screen of the second OS through a system re-booting process, according to another exemplary embodiment.

Referring to FIG. 34, the electronic apparatus 100e may provide a user interface 3310 (hereinafter, referred to as an ‘OS selection UI’) for selecting the first OS or the second OS when an unfolding angle of the electronic apparatus 100e is equal to or greater than a critical angle of “150°”, unlike in FIG. 33. The electronic apparatus 100e may maintain the first OS, or may end the first OS and may drive the second OS, based on a user input for the OS selection UI 3310.

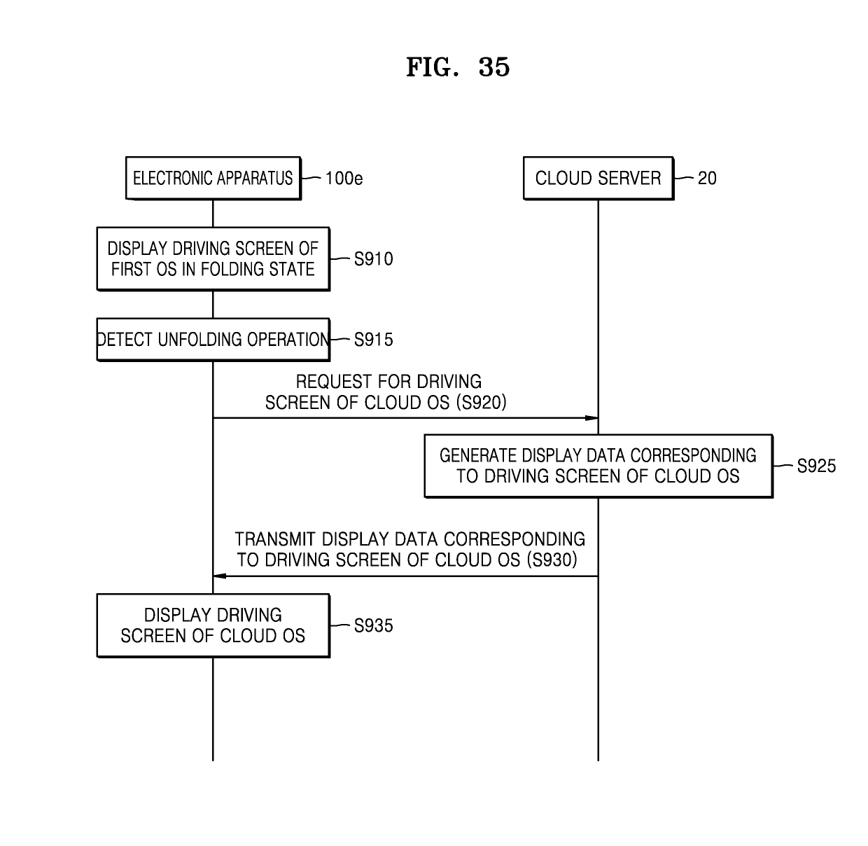

FIG. 35 is a flowchart illustrating a method performed by the electronic apparatus 100e to change a driving screen of a first OS into a driving screen of a cloud OS, and display the driving screen of the cloud OS, according to an exemplary embodiment.

Referring to FIG. 35, the electronic apparatus 100e may transmit/receive data to/from the cloud server 20 through the communication interface 1040. For example, the cloud server 20 may execute a cloud OS and applications in the cloud server 20, and may apply an execution result of the cloud OS and the applications to clients that connect to the cloud server 20. The clients may obtain information about an execution screen of an application that is executed on the cloud OS and a driving screen of the cloud OS that is executed by the cloud server 20 by connecting to the cloud server 20 through the communication interface 1040. The electronic apparatus 100e may be a client that connects to the cloud server 20.

In detail, in operation S910, the electronic apparatus 100e displays the driving screen of the first OS. Also, in operation S915, the electronic apparatus 100e detects an unfolding operation of the electronic apparatus 100e. In operation S920, as the electronic apparatus 100e unfolds, when an unfolding angle of the electronic apparatus 100e is equal to or greater than a critical angle, the electronic apparatus 100e requests the cloud server 20 for the driving screen of the cloud OS.

For example, the communication interface 1040 may access the cloud server 20 by using an address (e.g., a uniform resource locator (URL) address) of the cloud server 20 through a network. Alternatively, the electronic apparatus 100e may access the cloud server 20 by executing a predetermined application. The cloud server 20 may request the user of the electronic apparatus 100e to be authenticated. For example, the cloud server 20 may request the electronic apparatus 100e for an identification value (for example, a media access control (MAC) address of the electronic apparatus 100e) of the electronic apparatus 100e that is registered in the cloud server 20 or an identification value (e.g., an ID and a password) of the user of the electronic apparatus 100e.

In operation S925, the cloud server 20 generates display data corresponding to the driving screen of the cloud OS that is being driven on the cloud server 20. For example, the cloud server 20 may generate bitmap data, joint photographic experts group (JPEG) data, portable network graphics (PNG) data, or graphics interchange format (GIF) data corresponding to the driving screen of the cloud OS.

Also, in operation S930, the cloud server 20 transmits the generated display data to the electronic apparatus 100e. In this case, the cloud server 20 may repeatedly generate the display data at predetermined time intervals (for example, intervals of 30 seconds), and may transmit the repeatedly generated display data to the electronic apparatus 100e. Also, the cloud server 20 may compress the display data, and then may transmit the compressed display data.

In operation S935, the electronic apparatus 100e displays the driving screen of the cloud OS based on the display data that is received from the cloud server 20. The electronic apparatus 100e may transmit an event (for example, a touch event or an alert event) that occurs on the electronic apparatus 100e to the cloud server 20 in order for the cloud server 20 to process information corresponding to each event. Also, the electronic apparatus 100e may receive the display data that is generated at predetermined time intervals by the cloud server 20, thereby making the user to feel as if the cloud OS is driven in the electronic apparatus 100e.

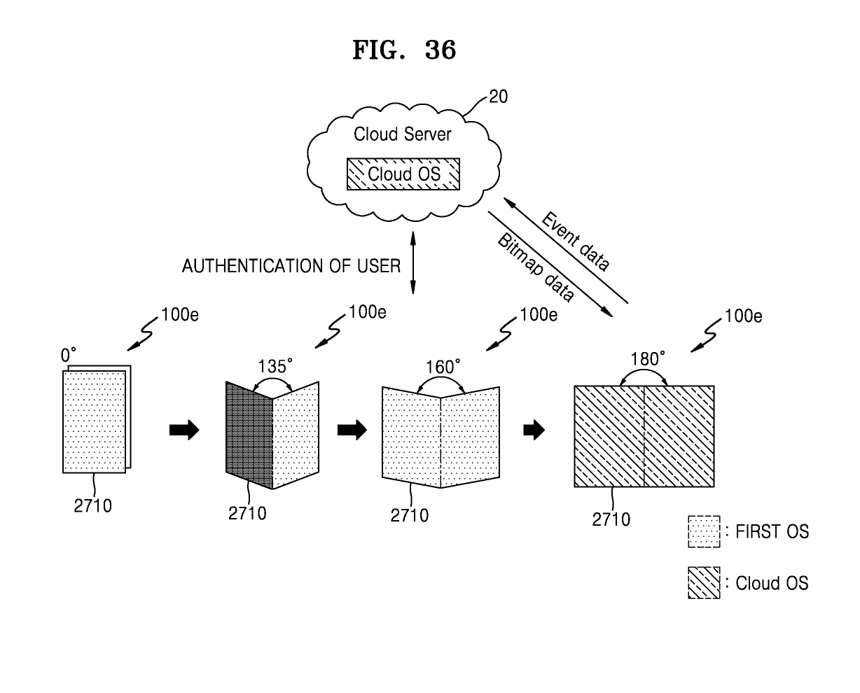

FIG. 36 is a diagram illustrating an example where as the electronic apparatus 100e unfolds, the electronic apparatus 100e displays a driving screen of a cloud OS, according to an exemplary embodiment.

As shown in FIG. 36, the electronic apparatus 100e may access the cloud server 20 when an unfolding angle of the electronic apparatus 100e exceeds a critical angle of “150°”. In this case, the electronic apparatus 100e may perform a user authentication process with the cloud server 20. For example, the cloud server 20 may request the electronic apparatus 100e for an identification value (e.g., an ID and a password) of the user of the electronic apparatus 100e. Alternatively, the cloud server 20 may determine whether the electronic apparatus 100e is already registered in the cloud server 20 by receiving a MAC address of the electronic apparatus 100e.

When the user authentication process is completed, the cloud server 20 may transmit bitmap data corresponding to the driving screen of the cloud OS that is being driven on the cloud server 20 to the electronic apparatus 100e. Also, the electronic apparatus 100e may transmit information about an event that occurs in the electronic apparatus 100e to the cloud server 20.

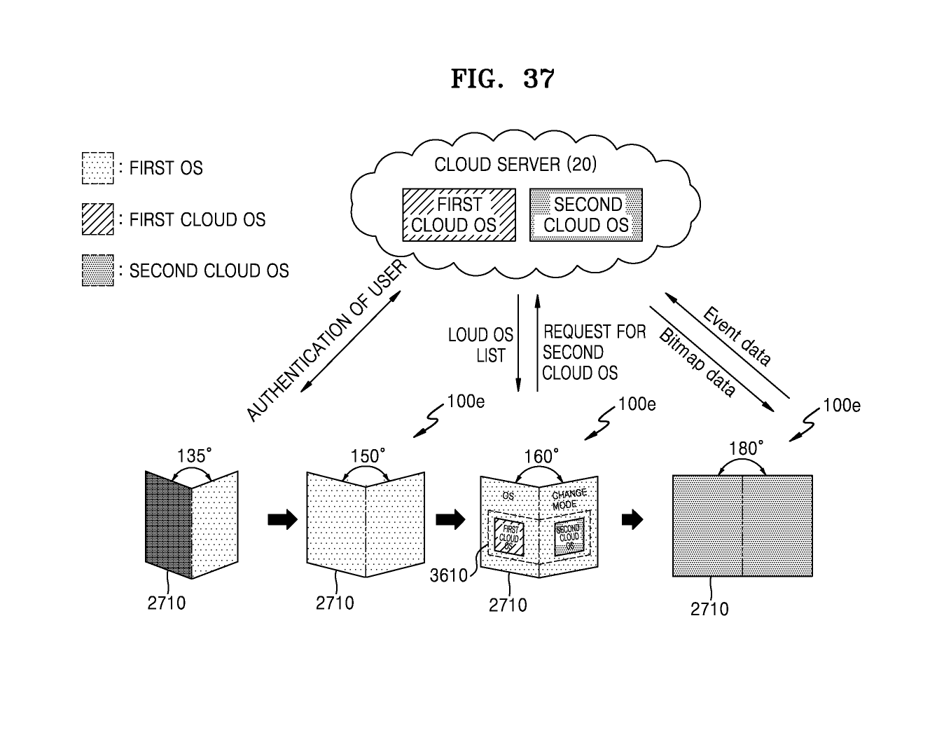

FIG. 37 is a diagram illustrating an example where as the electronic apparatus 100e unfolds, the electronic apparatus 100e displays a driving screen of a cloud OS, according to another exemplary embodiment.

As shown in FIG. 37, the cloud server 20 may drive a plurality of cloud OSs. In this case, when a user authentication process with the electronic apparatus 100e is completed, the cloud server 20 may transmit a cloud OS list including information about the plurality of cloud OSs that are being driven on the cloud server 20 to the electronic apparatus 100e.

When the cloud OS list is received, the electronic apparatus 100e may provide a cloud OS selection UI 3610 for selecting one cloud OS in the cloud OS list. Also, the electronic apparatus 100e may request the cloud server 20 for a second cloud OS according to a user input for the cloud OS selection UI 3610. Next, the electronic apparatus 100e may receive bitmap data corresponding to a driving screen of the second cloud OS from the cloud server 20, and may transmit event data about an event that occurs in the electronic apparatus 100e to the cloud server 20.

In FIGS. 36 and 37, the electronic apparatus 100e may display a driving screen of the first cloud OS or the second cloud OS by executing a web application or the like on the first OS that is driven in the electronic apparatus 100e.

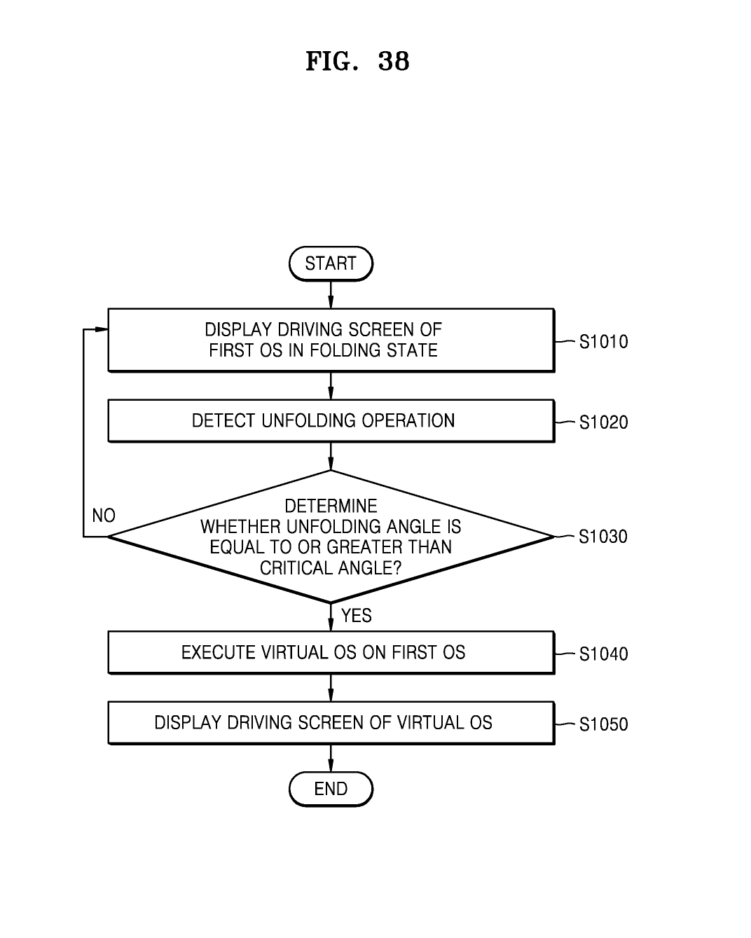

FIG. 38 is a flowchart illustrating a method performed by the electronic apparatus 100e to drive at least one virtual OS as the electronic apparatus 100e unfolds, according to an exemplary embodiment.

Referring to FIG. 38, in operation S1010, the controller 1010 controls a display to display a driving screen of a first OS when the electronic apparatus 100e is in a folding state. In operation S1020, the controller 1010 detects an unfolding operation of the electronic apparatus 100e.

In operation S1030, it is determined whether an unfolding angle of the electronic apparatus 100e is equal to or greater than a critical angle. When it is determined in operation S1030 that the unfolding angle is equal to or greater than the critical angle, the method proceeds to operation S1040. In operation S1040, the controller 1010 executes a virtual OS on the first OS. The virtual OS that is a method for simultaneously performing a plurality of OSs in one apparatus may be driven on a virtual machine that provides a virtual computing environment. Also, the virtual machine that is an application program that is executed on the first OS that is driven in the electronic apparatus 100e may be emulation of the whole or part of a computing environment including hardware such as a memory by using software.

When the virtual OS is executed, in operation S1050, the controller 1010 controls the display to display a driving screen of the virtual OS along with a driving screen of the first OS on the flexible display 2710. Alternatively, the controller 1010 may control the display to display only the driving screen of the virtual OS on the flexible display 2710. The first OS and the virtual OS may transmit/receive data therebetween through a virtual network. Accordingly, the controller 1010 may transmit information about an event (for example, a touch event) that occurs from the virtual OS. Also, the virtual OS may perform data processing by using the information about the event that is received from the first OS.

Although one virtual OS is executed as the electronic apparatus 100e unfolds along one folding line, the present exemplary embodiment is not limited thereto. For example, when the electronic apparatus 100e have a plurality of folding lines as shown in FIG. 29, as the electronic apparatus 100e unfolds along different folding line, the electronic apparatus 100e may execute a plurality of virtual OSs. For example, when the electronic apparatus 100e unfolds along a first folding line, the electronic apparatus 100e may drive a virtual OS for tablets, and when the electronic apparatus 100e further unfolds along a second folding line, the electronic apparatus 100e may further drive a virtual OS for PCs.

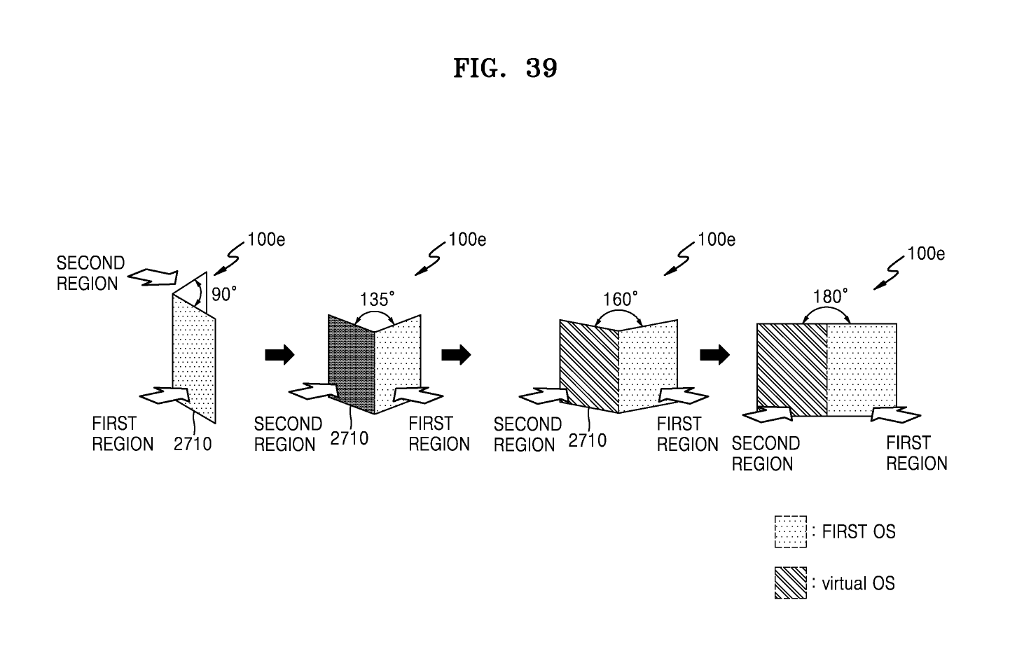

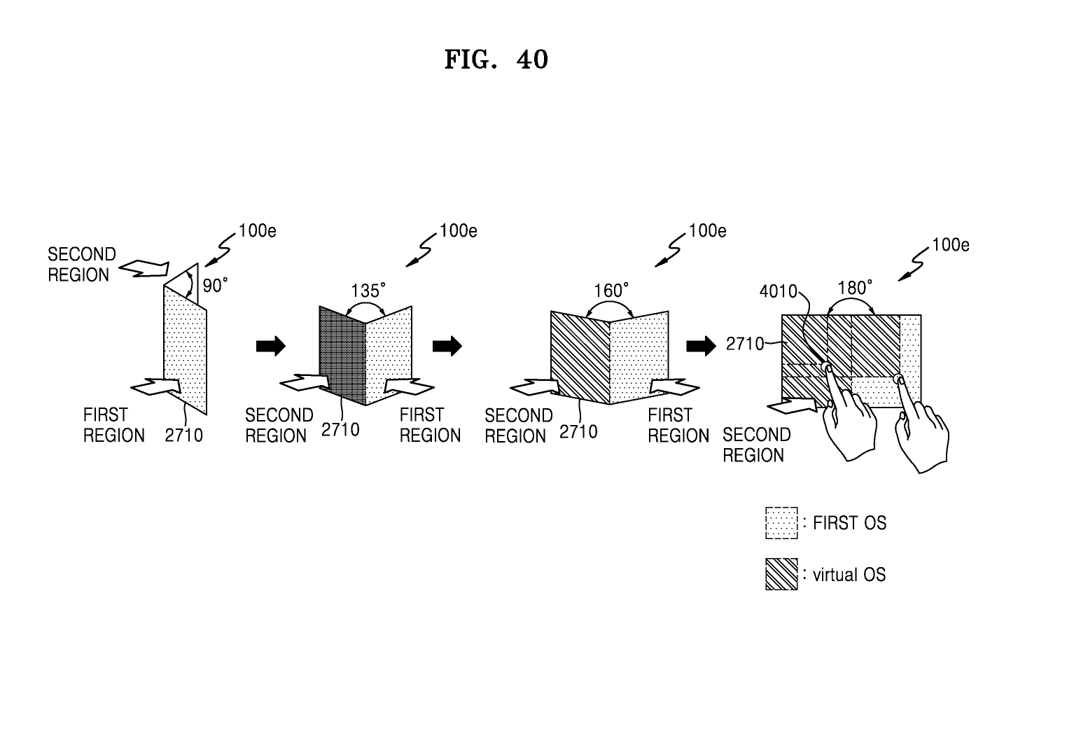

FIG. 39 is a diagram illustrating an example where as the electronic apparatus 100e unfolds, the electronic apparatus 100e drives at least one virtual OS, according to an exemplary embodiment.

Referring to FIG. 39, the electronic apparatus 100e may display a driving screen of a first OS on a first region of the flexible display 2710. In this case, a second region of the flexible display 2710 may be inactivated.

When an unfolding angle of the electronic apparatus 100e is equal to or greater than a critical angle (for example, “150°”), the second region of the flexible display 2710 may be activated to the user of the electronic apparatus 100e. Also, the electronic apparatus 100e may drive a virtual OS on the first OS. In this case, the electronic apparatus 100e may display a driving screen of the virtual OS on the second region of the flexible display 2710.

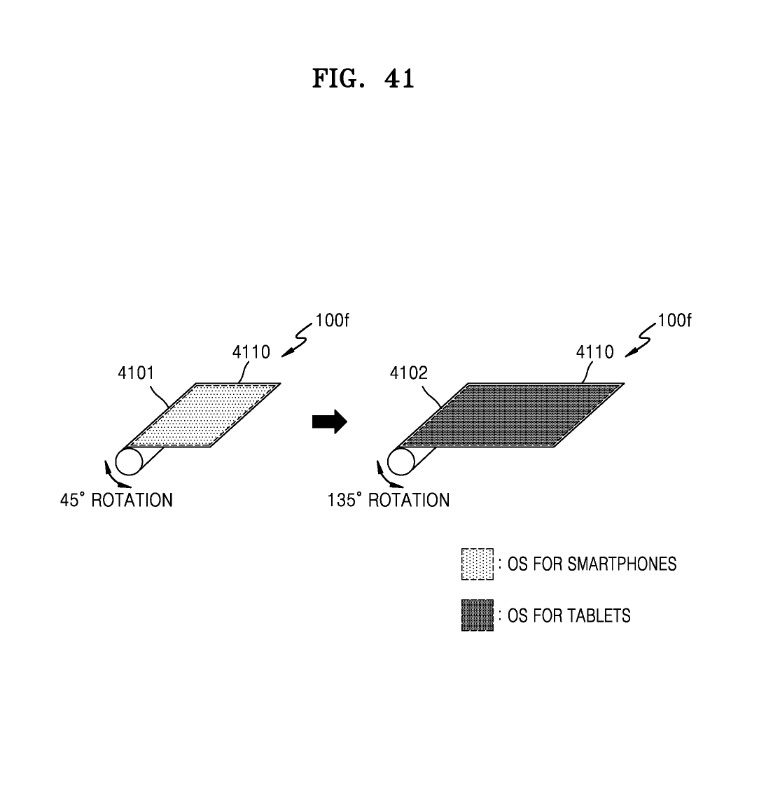

FIG. 40 is a diagram illustrating an example where the electronic apparatus 100e changes a size of a driving screen of a virtual OS, according to an exemplary embodiment.

In FIGS. 39 and 40, a virtual machine on which the virtual OS is driven may be one application program that is executed on the first OS. In other words, when a second region of the flexible display 2710 is activated, the electronic apparatus 100e may extend a region on which a driving screen of the first OS is displayed to the second region, and may display an execution window of a virtual machine on which the second OS is driven on the second region. In this case, because the virtual machine is an application program that is executed on the first OS, the user of the electronic apparatus 100e may move the execution window of the virtual machine or may adjust a size of the execution window of the virtual machine. For example, the electronic apparatus 100e may adjust a size of the execution window of the virtual machine on which a driving screen of the virtual OS is shown according to a user input 4010 that touches and drags an end point of the driving screen of the virtual OS. As such, as the execution window of the virtual machine in which the virtual OS is driven is moved or a size of the execution window of the virtual machine is adjusted, a position of the driving screen of the virtual OS may be changed or a size of the driving screen of the virtual OS may be adjusted.

FIG. 41 is a view illustrating a method performed by an electronic apparatus 100f employing a rollable display to change an OS that is driven in the electronic apparatus 100f, according to an exemplary embodiment.

Referring to FIG. 41, when the electronic apparatus 100f rolls relatively much (for example, when a rolling axis of the electronic apparatus 100f rotates by “45°”), because a display region 4101 that is exposed to the user is relatively small, a driving screen of an OS for smartphones may be displayed on a flexible display 4110. However, when the electronic apparatus 100f relatively unrolls (for example, when the rolling axis rotates by “135°”), because a display region 4102 that is exposed to the user is relatively large, a driving screen of an OS for tablets may be displayed. That is, like a foldable device or a bendable device, the flexible display 4110 may dynamically vary an OS, which is driven in the electronic apparatus 100f, according to a rolling degree of the electronic apparatus 100f.

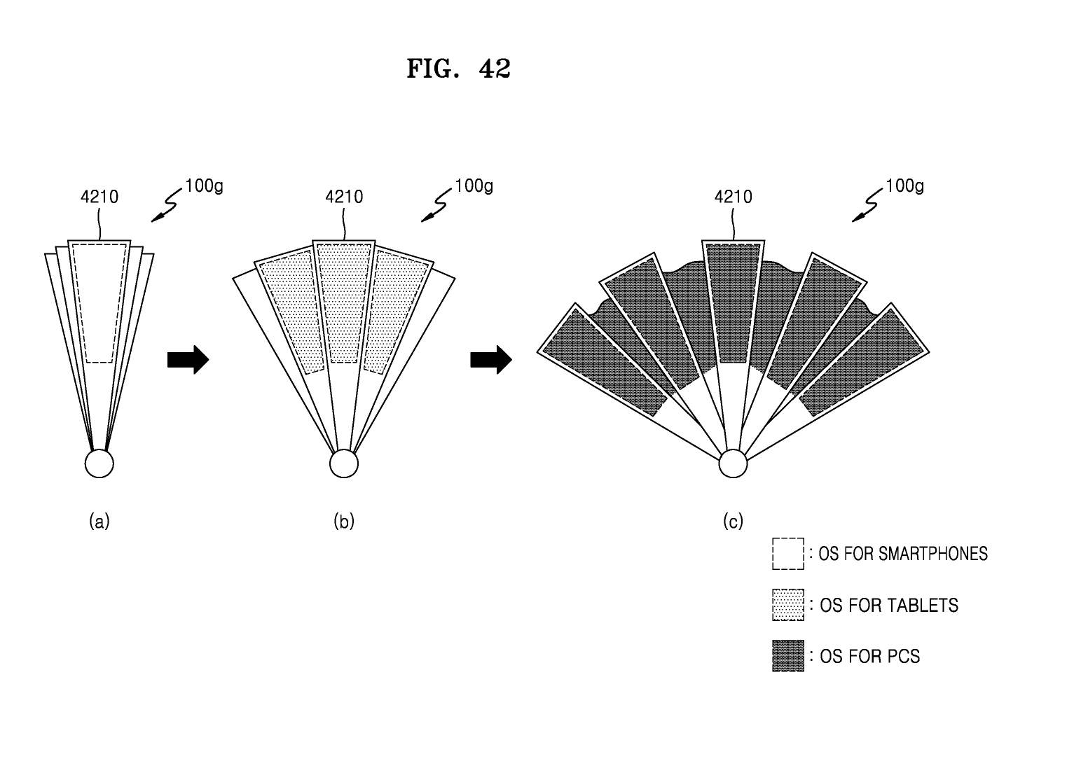

FIG. 42 is a view illustrating a method performed by an electronic apparatus 100g employing a flexible display having a fan shape to change an OS that is driven in the electronic apparatus 100g, according to an exemplary embodiment.

Referring to FIG. 42, in a state (a) where the electronic apparatus 100g folds relatively much, because a display region 4210 that may be viewed by the user is only one, the electronic apparatus 100g may display a driving screen of an OS for smartphones. However, in a state (b) where the electronic apparatus 100g unfolds more than that in the state (a), the electronic apparatus 100g may display a driving screen of an OS for tablets. Also, in a state (c) where the electronic apparatus 100g unfolds to the maximum, the electronic apparatus 100g may display a driving screen of an OS for PCs.

That is, like in FIGS. 27 and 41, the electronic apparatus 100g of FIG. 42 may dynamically vary a driving screen of an OS, which is provided on the flexible display, according to an unfolding degree of the electronic apparatus 100g.

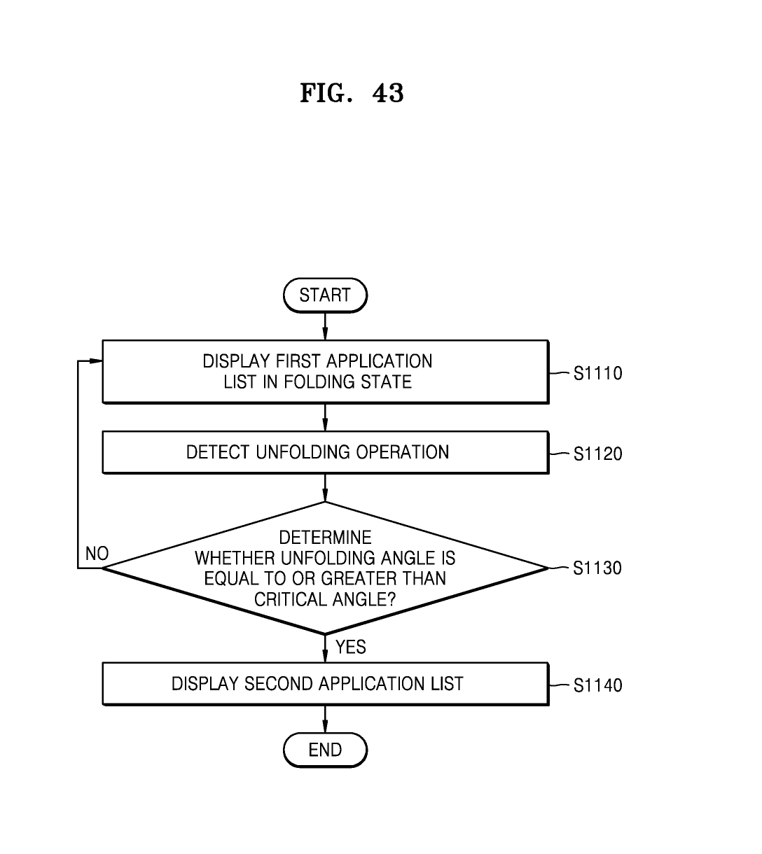

FIG. 43 is a flowchart illustrating a method performed by the electronic apparatus 100e to dynamically change an application list as the electronic apparatus 100e unfolds in a state where the application list is displayed on a screen of the electronic apparatus 100e, according to an exemplary embodiment. The application list may be a list in which identification values of applications (for example, names of the applications or icons representing the applications) that may be executed in the electronic apparatus 100e are arranged in a preset order on the screen of the electronic apparatus 100e.

Referring to FIG. 43, in operation S1110, when the electronic apparatus 100e is in a folding state, the controller 1010 controls a display to display a first application list. The first application list may include identification values of applications having a high frequency of use when the electronic apparatus 100e is in the folding state. Alternatively, the first application list may include identification values of applications suitable for a small screen that are preset by the electronic apparatus 100e. For example, the first application list may include identification values of a call application, a message application, a chatting application, a music player application, a e-book application, and a navigation application.

In operation S1120, the controller 1010 detects a user's operation of unfolding the electronic apparatus 100e. In this case, the controller 1010 may receive an unfolding angle at which the electronic apparatus 1010 unfolds from the sensor 1035. For example, the electronic apparatus 100e may measure an unfolding angle by using the state detection sensor 2801 or 2901 that is disposed on a folding line of the electronic apparatus 100e, like in FIG. 28A or 29A. Alternatively, the electronic apparatus 100e may measure an unfolding angle by using the state detection sensors 2802 and 2902 that are disposed on both ends of the flexible display 2710, like in FIG. 28B or 29B.

In operation S1130, it is determined whether the measured unfolding angle is equal to or greater than a critical angle. When it is determined in operation S1130 that the measured unfolding angle is equal to or greater than the critical angle, the method proceeds to operation S1140. In operation S1140, the controller 1010 controls the display to display a second application list. The second application list may be a list of applications having a high frequency of use when the electronic apparatus 100e is in an unfolding state. Alternatively, the second application list may be a list of applications suitable for a relatively large screen that are preset by the electronic apparatus 100e. For example, the second application list may include identification values of a note application, a message creation application, a movie reproduction application, a video reproduction application, a TV application, and a web application.

As such, the electronic apparatus 100e according to an exemplary embodiment may apply a list of applications suitable for a size of a screen of the electronic apparatus 100e to the user as the electronic apparatus 100e unfolds.

Although the above has been explained with the electronic apparatus 100e that is in a folding state gradually unfolding from the folding state, the present exemplary embodiment is not limited thereto. For example, in a state where the second application list is displayed on the screen of the electronic apparatus 100e, a user's operation of folding the electronic apparatus 100e may be detected. In this case, as the electronic apparatus 100e folds, the electronic apparatus 100e may change the second application list into the first application list.

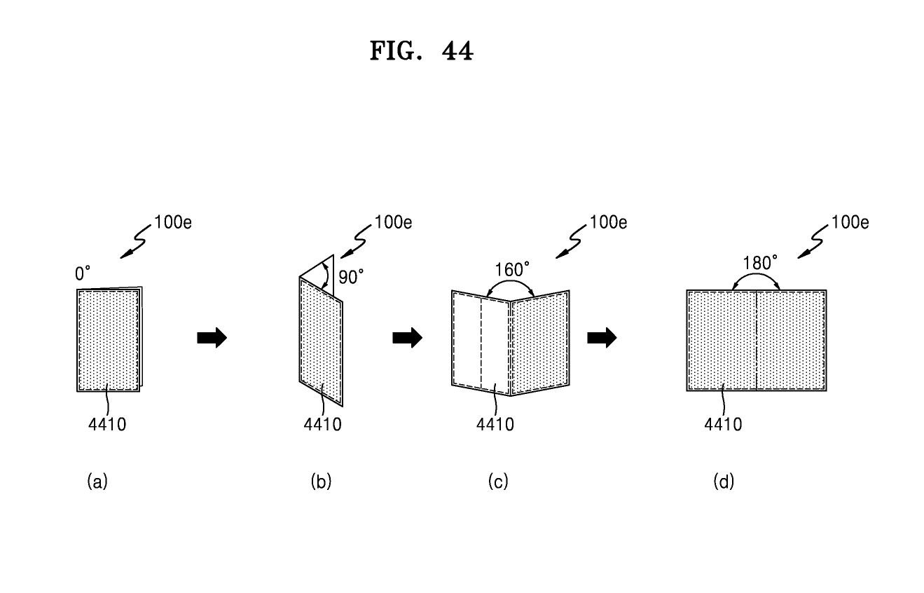

FIG. 44 is a view illustrating an example where as the electronic apparatus 100e unfolds, an application list that is displayed on a screen of the electronic apparatus 100e is dynamically changed, according to an exemplary embodiment.

As shown in (a) through (d) of FIG. 44, as the electronic apparatus 100e unfolds, a size of an activated screen 4410 may increase. Accordingly, the electronic apparatus 100e may change an application list that is displayed on a screen of the electronic apparatus 100e to be suitable for a size of the screen of the electronic apparatus 100e that gradually increases.

For example, when the user folds the electronic apparatus 100e to a size small enough for the user to easily carry the electronic apparatus 100e as shown in (a) of FIG. 44, the electronic apparatus 100e may display a first application list including icons of a call application, a message creation application, a chatting application, and a music player application. When the user completely unfolds the electronic apparatus 100e as shown in (d) of FIG. 44, the electronic apparatus 100e may display a second application list including icons of a note application, a message creation application, a movie reproduction application, and a video reproduction application, and an e-book application.

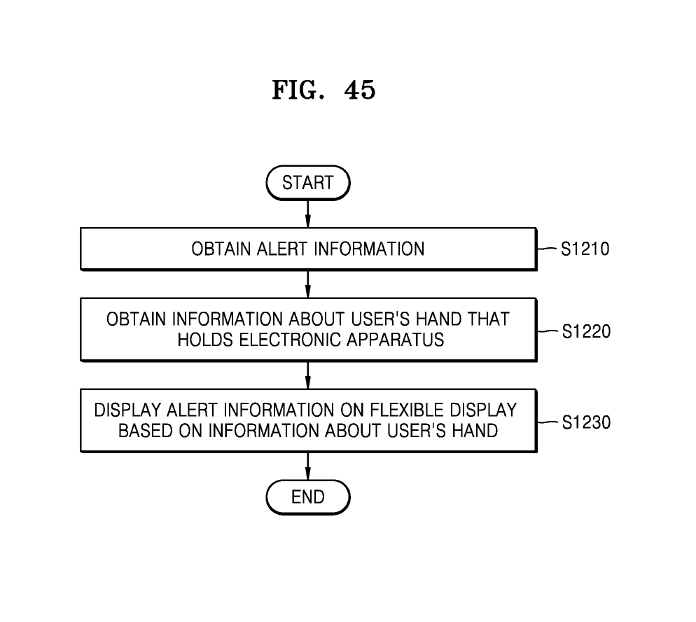

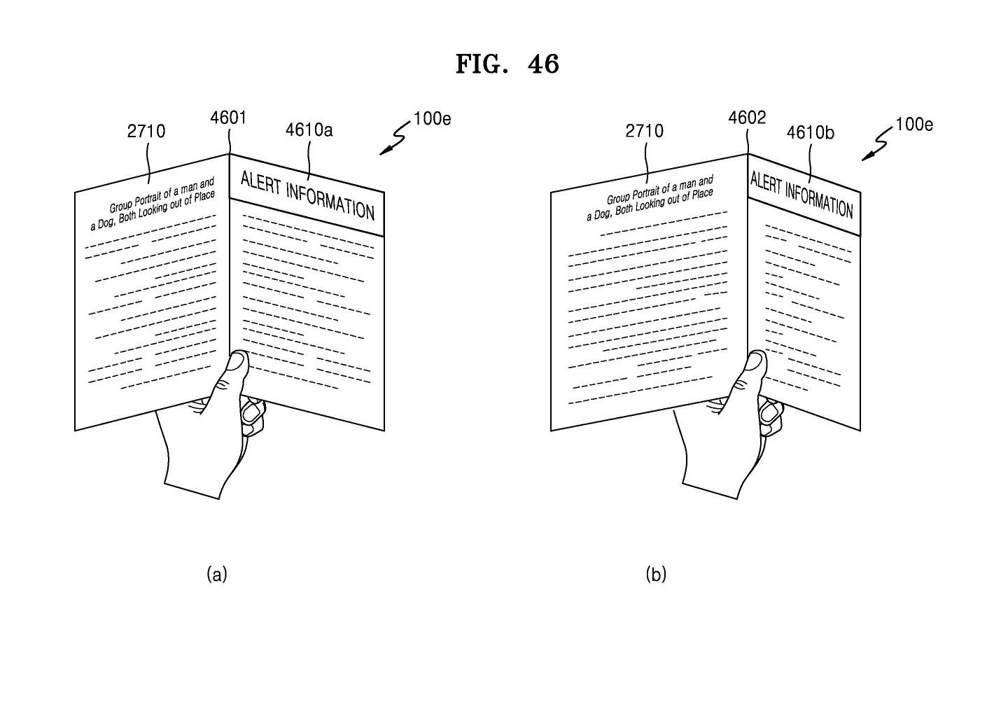

FIG. 45 is a flowchart illustrating a method performed by the electronic apparatus 100e to display alert information, according to an exemplary embodiment.

Referring to FIG. 45, in operation S1210, the controller 1010 obtains alert information when an entire region or a predetermined region of the flexible display 2710 is activated or turned on. Examples of the alert information may include a schedule alert, a time alert, and a warning that are processed in the electronic apparatus 100e as well as a voice call, a text message, a chat, and a social network service (SNS) message that are received from the outside. Also, when the entire region or the predetermined region of the flexible display 2710 is activated, it may mean that at least one object (e.g., an execution screen of an application or a home screen) is displayed on the entire region or the predetermined region of the flexible display 2710.

In operation S1220, the controller 1010 obtains information about a user's hand that holds the electronic apparatus 100e. For example, the sensor 1035 may include a grip sensor for obtaining information about a shape, a position, and a direction of the user's hand holding the electronic apparatus 100e. Examples of the grip sensor may include a camera, an infrared camera, a proximity camera, an infrared sensor, a touch sensor, a hovering sensor, and a light detection sensor. The controller 1010 may receive information sensed by the grip sensor and may obtain information about a position of the hand that holds the electronic apparatus 100e or a shape of the hand (e.g., whether the hand that holds the electronic apparatus 100e is the user's right hand, left hand, or both hands). Also, the grip sensor may sense the user's hand that approaches the electronic apparatus 100e as well as the user's hand that holds the electronic apparatus 100e.

In operation S1230, the controller 1010 controls the flexible display 2710 to display the alert information on the predetermined region of the flexible display 2710 based on the obtained information about the user's hand. For example, when the user holds the electronic apparatus 100e with one hand, the controller 1010 may determine a display region where the alert information is to be displayed from among display regions that are divided along a folding line, based on a shape of the hand. In detail, when the user holds the electronic apparatus 100e with his/her right hand, the controller 1010 may control the alert information to be displayed on a left region of the flexible display 2710 that folds along the folding line. In contrast, when the user holds the electronic apparatus 100e with his/her left hand, the controller 1010 may control the alert information to be displayed on a right region of the flexible display 2710 that folds along the folding line.

When the electronic apparatus 100e includes a plurality of folding lines, as a position of the user's hand that holds the electronic apparatus 100e varies, the electronic apparatus 100e may be deformed along a different folding line. Accordingly, the controller 1010 may vary a position where the alert information is to be displayed according to a position of the hand that holds the electronic apparatus 100e.

Alternatively, when the user holds the electronic apparatus 100e with his/her both hands, the electronic apparatus 100e may additionally sense the user's viewing direction in which the user views the flexible display 2710 and may determine a region where the alert information is to be displayed from among regions of the flexible display 2710 that are divided along a folding line. In this case, the sensor 1035 may include a viewing direction sensor for sensing the user's viewing direction. Examples of the viewing direction sensor may include a camera, an infrared camera, and an infrared LED.

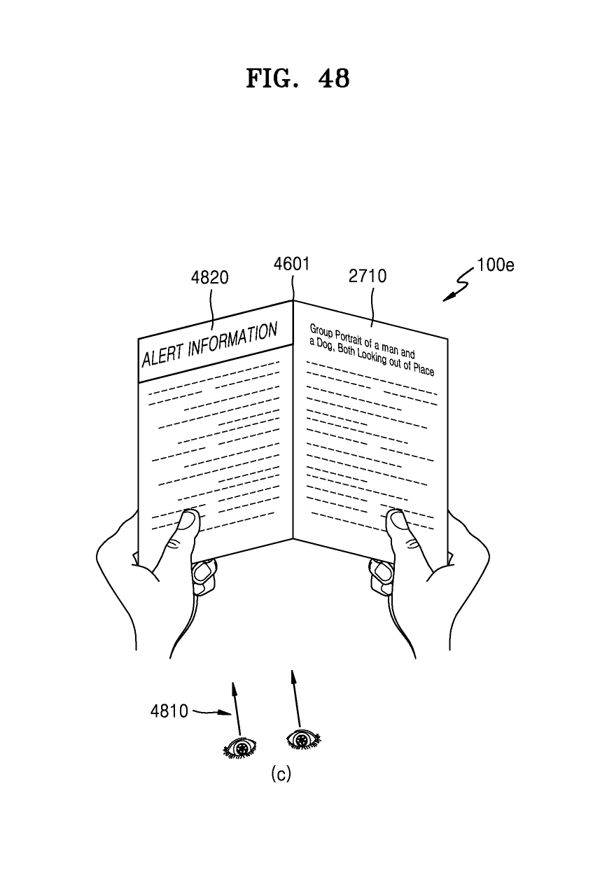

FIGS. 46 through 48 are views illustrating examples where the electronic apparatus 100e displays alert information based on information about a user's hand according to exemplary embodiments. Referring to FIGS. 46 and 48, the electronic apparatus 100e may receive message alert information when an entire region of the flexible display 2710 is activated.

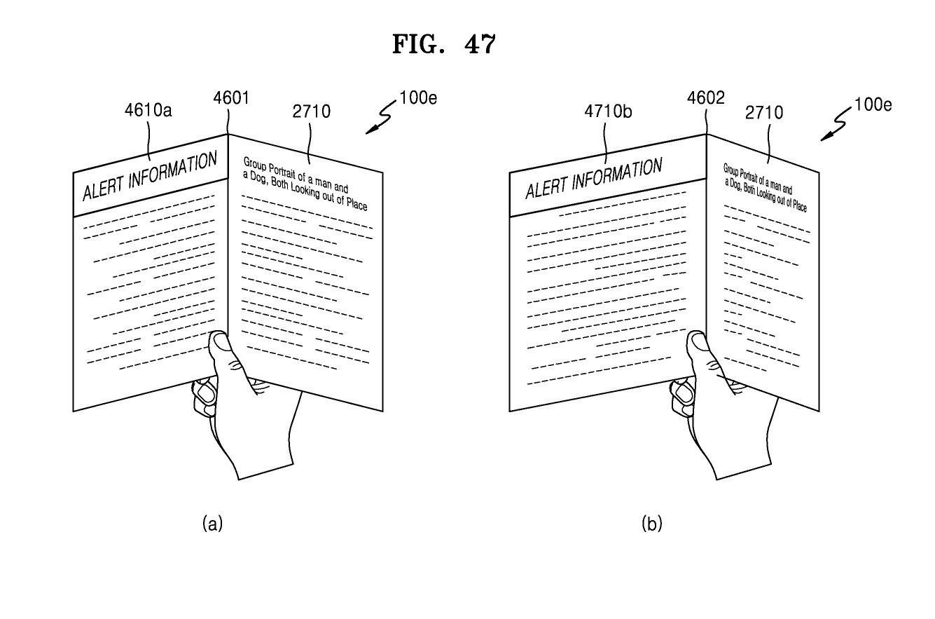

When the user holds the electronic apparatus 100e with one hand as shown in FIGS. 46 and 47, the electronic apparatus 100e may display alert information based on a shape and a position of the one hand that holds the electronic apparatus 100e. This is for the user to easily check and select the alert information by using the one hand that holds the electronic apparatus 100e without using both hands.

For example, because the user holds the electronic apparatus 100e with his/her left hand in (a) of FIG. 46, the electronic apparatus 100e may display alert information 4610a on a right region of the flexible display 2710 with respect to a folding line 4601. In contrast, when the user holds the electronic apparatus 100e with his/her right hand as in (a) of FIG. 47, the electronic apparatus 100e may display the alert information 4610a on a left region of the flexible display 2710 with respect to the folding line 4601.

If the electronic apparatus 100e includes a plurality of folding lines, a folding line may vary according to a position of the user's hand that holds the electronic apparatus 100e. When the user holds a portion other than a central portion of the electronic apparatus 100e as shown in FIGS. 46 and 47, the electronic apparatus 100e may display alert information on a right region or a left region of the flexible display 2710 with respect to a folding line 4602 that is close to a position of the user's hand. When the user holds the electronic apparatus 100e with his/her left hand, the electronic apparatus 100e may display the alert information 4610a on a right region of the flexible display 2710 as shown in (a) of FIG. 46. In contrast, when the user holds the electronic apparatus 100e with his/her right hand, the electronic apparatus 100e may display alert information 4710b on a left region of the flexible display 2710 as shown in (b) of FIG. 47. As such, a position and a size of a display region where alert information is displayed may vary according to a shape and a position of the user's hand that holds the electronic apparatus 100e.

When the user holds the electronic apparatus 100e with his/her both hands as shown in FIG. 48, the electronic apparatus 100e may sense the user's viewing direction 4810 in which the user views the flexible display 2710. The electronic apparatus 100e may determine whether the user views a right region or a left region of the flexible display 2710 with respect to the folding line 4601, based on the sensed user's viewing direction. When the user views the left region, the electronic apparatus 100e may display alert information 4820 on the left region. In contrast, when the user views the right region with respect to the folding line 4601, the electronic apparatus 100e may display alert information on the right region.

Although the electronic apparatus 100e displays alert information on an upper end portion of the flexible display 2710 in FIGS. 46 through 48, the present exemplary embodiment is not limited thereto. For example, the electronic apparatus 100e may display alert information on a lower end portion of the flexible display 2710, and may display alert information on a predetermined region of the flexible display 2710 that is adjacent to the user's hand, in consideration of a position of the user's hand.

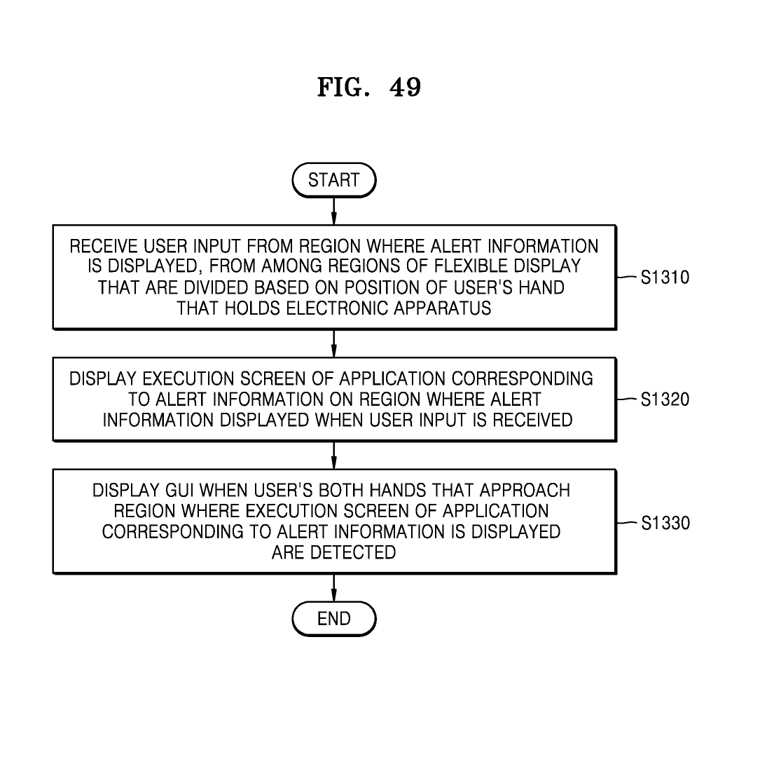

FIG. 49 is a flowchart illustrating a method performed by the electronic apparatus 100e to display an execution screen of an application corresponding to alert information, in response to a user input, according to an exemplary embodiment.

Referring to FIG. 49, in operation S1310, the interface 1050 receives a user input from a region where alert information is displayed, from among regions of the flexible display 2710 that are divided along a folding line. For example, in (a) of FIG. 46, the interface 1050 may receive a user input from a right region of the flexible display 2710. Alternatively, in (a) of FIG. 47, the interface 1050 may receive a user input from a left region of the flexible display 2710. For example, the interface 1050 may receive a touch input that touches alert information, a drag and drop input that drags alert information in a predetermined direction, and/or a drag input that drags in a predetermined direction a left region or a right region of the flexible display 2710 where alert information is displayed.

In operation S1320, the controller 1010 controls the flexible display 2710 to display an execution screen of an application corresponding to the alert information to be displayed on the region where the alert information is displayed, when the user input is received. The application corresponding to the alert information may be an application where the alert information is generated or the alert information is to be processed.

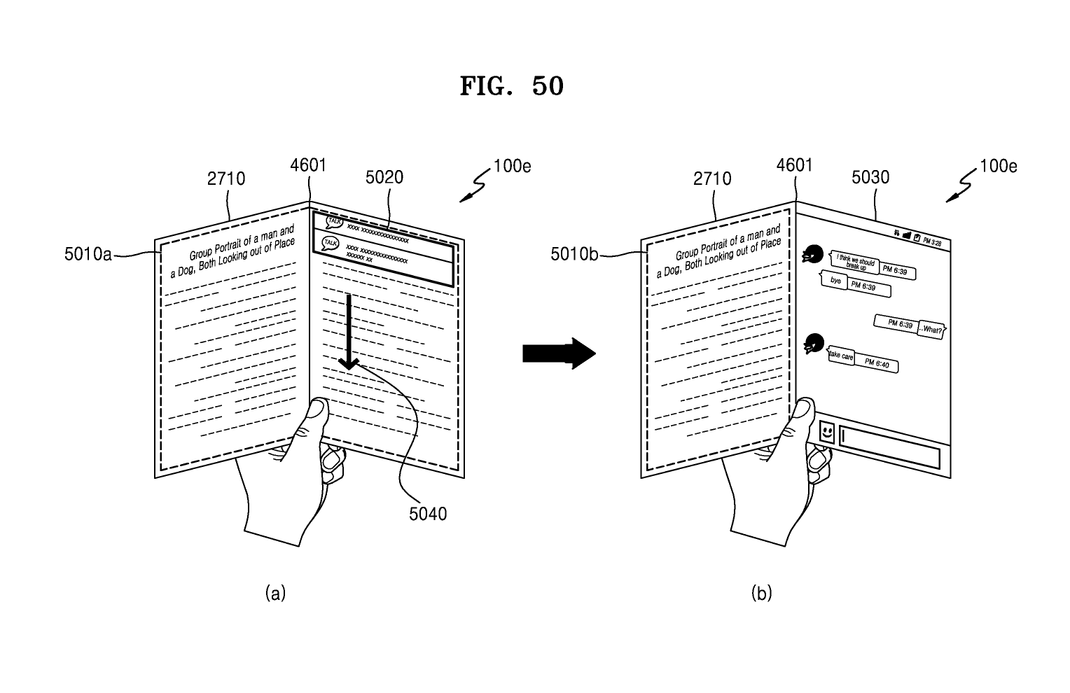

FIG. 50 is a view illustrating an example where the controller 1010 controls an execution screen of an application corresponding to alert information to be displayed, according to an exemplary embodiment.

Referring to (a) of FIG. 50, the controller 1010 may obtain message alert information 5020 while an execution screen 5010a of a first application is displayed on an entire region of the flexible display 2710. In this case, as described above, the controller 1010 may display the message alert information 5020 on a right region of the flexible display 2710 with respect to the folding line 4601, based on information about the user's hand that holds the electronic apparatus 100e.

Next, the interface 1050 may receive a user input 5040 that drags a screen from the right region of the flexible display 2710 where the message alert information 5020 is displayed. As the user input 5040 is received, the controller 1010 may display an execution screen 5030 of a message application corresponding to the message alert information 5020, on the right region of the flexible display 2710. In this case, a size of a region where an execution screen 5010b of the first application is displayed may be reduced.

Referring back to FIG. 49, in operation S1330, when user's both hands that approach the region where the execution screen of the application corresponding to the alert information is displayed are detected, the controller 1010 controls the flexible display 2710 to display a graphical user interface (GUI).

The sensor 1035 may detect the user's hand that approaches the flexible display 2710. For example, the sensor 1035 may detect the user's hand that approaches the flexible display 2710 by using a grip sensor (e.g., a hovering sensor, a proximity sensor, an infrared sensor, or a light detection sensor). Also, the controller 1010 may determine whether the user's hand that approaches the flexible display 2710 approaches the region where the execution screen of the application corresponding to the alert information is displayed. In this case, the user's other hand may hold the electronic apparatus 100e.

Next, when it is determined that the user's hand approaches the execution screen of the application corresponding to the alert information, the controller 1010 may provide a GUI. For example, the controller 1010 may provide a keypad GUI or an application menu GUI. Alternatively, the controller 1010 may provide an application menu GUI including icons of applications designated as favorites by the user, from among icons of applications installed in the electronic apparatus 100e. The controller 1010 may determine a position where the GUI is provided on the flexible display 2710, in consideration of at least one among a position of the user's hand that approaches the flexible display 2710 and a position of the user's hand that holds the electronic apparatus 100e.

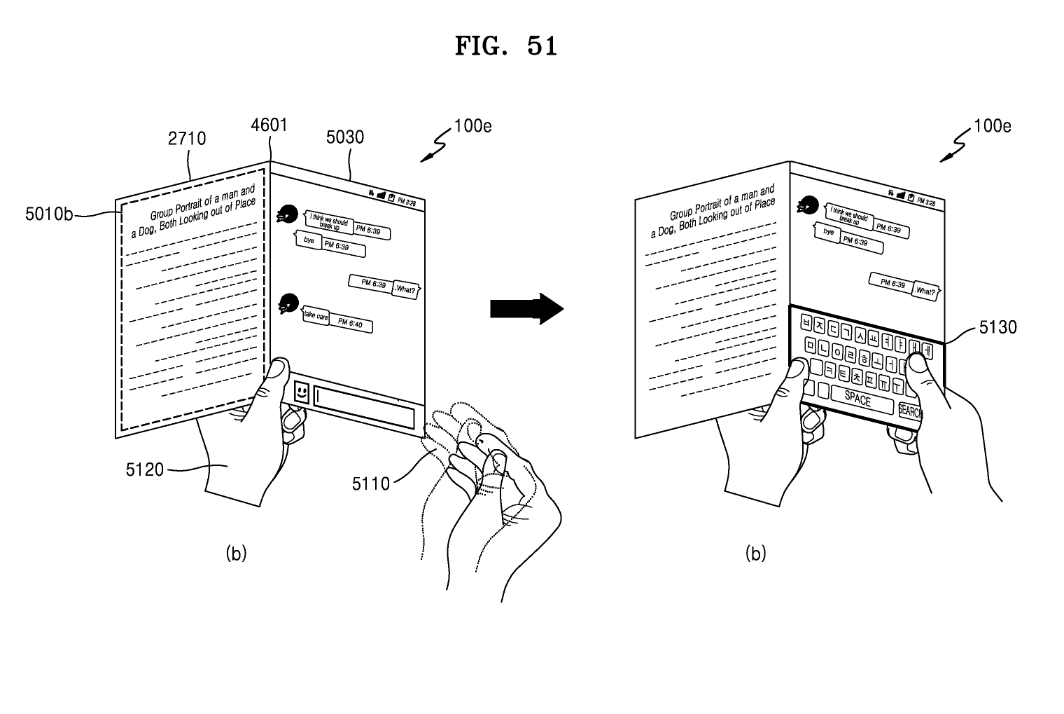

FIG. 51 is a view illustrating an example where the controller 1010 provides a GUI according to an exemplary embodiment.

Referring to (a) of FIG. 51, the electronic apparatus 100e may detect the user's hand 5110 that approaches the flexible display 2710. Also, the electronic apparatus 100e may determine whether the user's hand 5110 that approaches the flexible display 2710 approaches the execution screen 5030 of a message application corresponding to alert information. In this case, the user's other hand 5120 may hold the electronic apparatus 100e.

When it is determined that the user's hand 5110 approaches the execution screen 5030 of the message application, the electronic apparatus 100e may display a keypad GUI 5130 as shown in (b) of FIG. 51. In this case, the electronic apparatus 100e may determine a position where the keypad GUI 5130 is displayed, in consideration of positions of the user's both hands, that is, the user's hand that holds the electronic apparatus 100e and the user's hand that approaches the flexible display 2710.

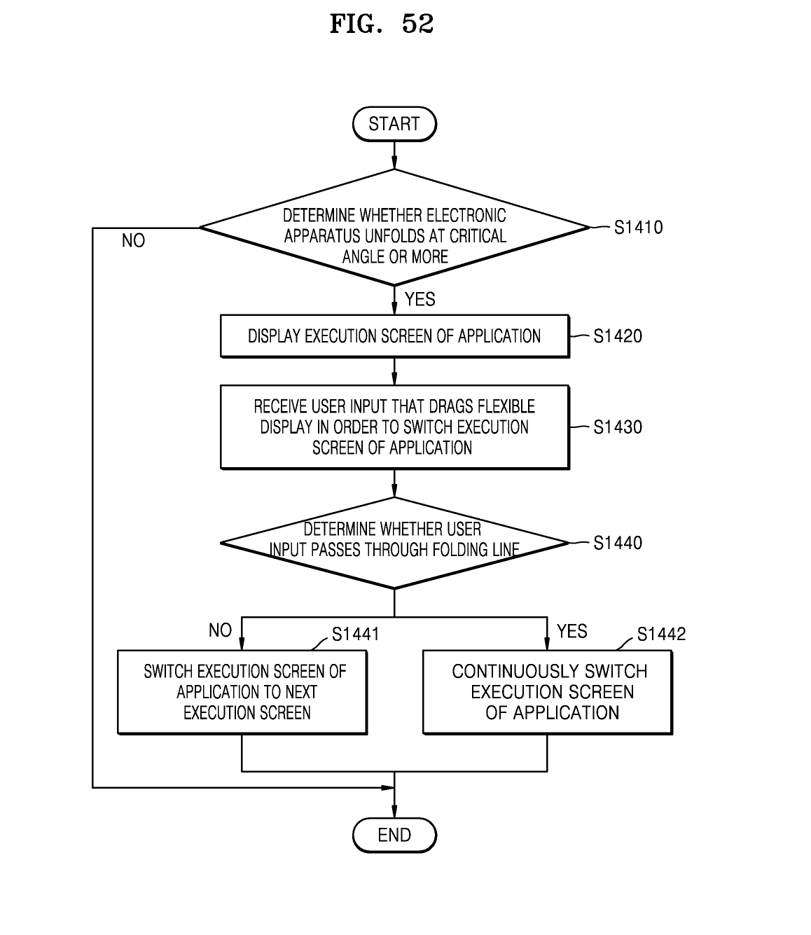

FIG. 52 is a flowchart illustrating a method performed by the electronic apparatus 100e to provide an execution screen of an application according to a user input, according to an exemplary embodiment.

Referring to FIG. 52, in operation S1410, the controller 1010 determines whether the electronic apparatus 100e unfolds at a critical angle or more. In this case, the critical angle may be an angle used by the controller 1010 to determine whether to activate or turn on an entire region of the flexible display 2710, and may be, for example, 90° or 100°. The controller 1010 may determine whether the electronic apparatus 100e unfolds at the critical angle or more, based on an unfolding angle sensed by the sensor 1035.

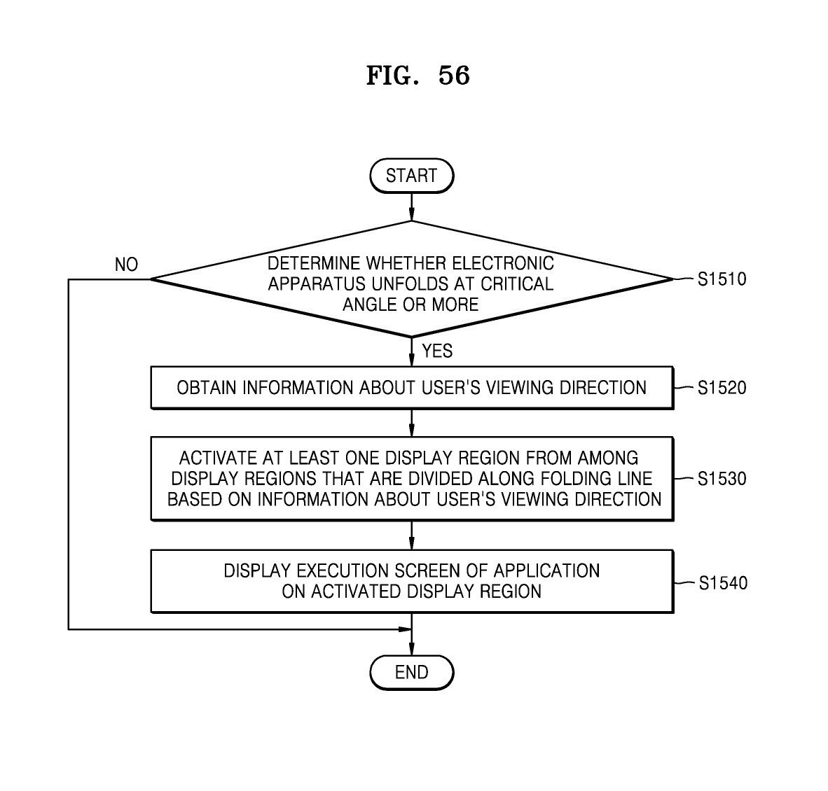

When the electronic apparatus 100e unfolds at an angle less than the critical angle, the controller 1010 may activate a predetermined region of the flexible display 2710 in consideration of the user's viewing direction. In this case, the controller 1010 may control an execution screen of an application to be displayed on the activated predetermined region of the flexible display 2710. Also, a non-activated region of the flexible display 2710 may be processed as a margin in black or white, and may be turned off to not be supplied with power. An exemplary embodiment in which the controller 1010 provides the execution screen of the application when the electronic apparatus 100e unfolds at the angle less than the critical angle will be explained below with reference to FIG. 56.

When it is determined in operation S1410 that the electronic apparatus 100e unfolds at the critical value or more, the method proceeds to operation S1420. In operation S1420, the controller 1010 controls the flexible display 2710 to display the execution screen of the application on the entire region of the flexible display 2710.

In operation S1430, in order to switch the execution screen of the application, the interface 1050 receives a user input that drags the flexible display 2710.

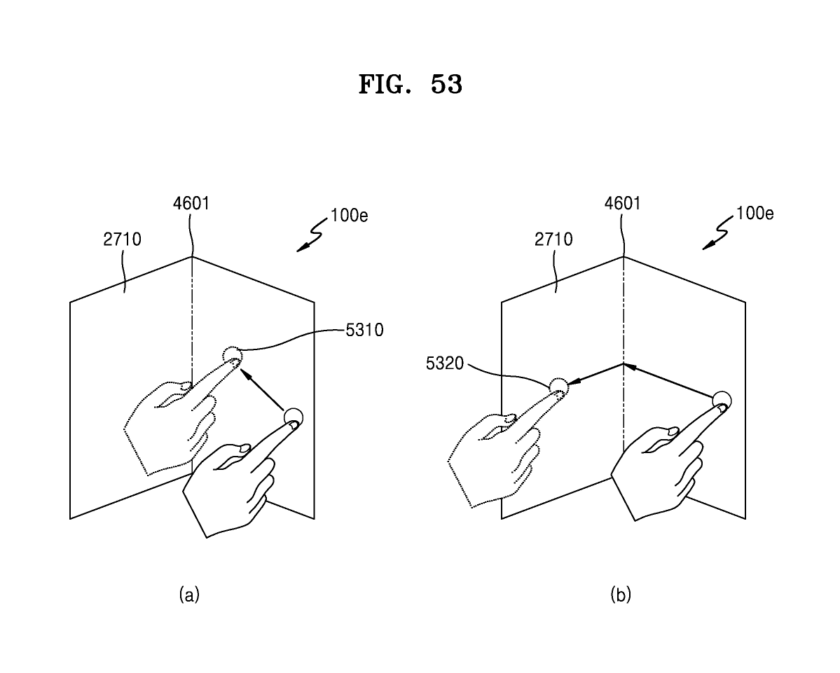

FIG. 53 is a view illustrating an example where the interface 1050 receives a user input, according to an exemplary embodiment. As shown in FIG. 53, the interface 1050 may receive a user input that drags a screen of the flexible display 2710 from right to left. In this case, the controller 1010 may perform different screen switch operations for a user input 5310 that does not pass through the folding line 4601 as shown in (a) of FIG. 53, and for a user input 5320 that passes through the folding line 4601 as shown in (b) of FIG. 53.

Referring back to FIG. 52, in operation S1440, the controller 1010 determines whether the user input passes through a folding line of the flexible display 2710. When it is determined in operation S1440 that the user input does not pass through the folding line, the method proceeds to operation S1441. In operation S1441, the controller 1010 switches the execution screen of the application to a next execution screen or a previous execution screen. For example, the controller 1010 may control a first page of the application to be switched to a second page of the application, in response to the user input. In detail, when the user input that does not pass through the folding line is received while a photograph album application is being executed, the controller 1010 may control a next photograph or a previous photograph of a photograph album to be displayed according to a drag direction.

When it is determined in operation S1440 that the user input passes through the folding line, the method proceeds to operation S1442. In operation S1442, the controller 1010 continuously switches the execution screen of the application while the user input is maintained. For example, while the user input is maintained, the controller 1010 may control a first page of the application to be continuously switched to a second page, a third page, a fourth page, . . . , of the application. In this case, when the user input ends, the controller 1010 may stop a screen switch operation. In detail, when the user input that passes through the folding line is received while the photograph album application is being executed, the controller 1010 may control photographs of the photograph album to be continuously displayed.

According to an exemplary embodiment, the controller 1010 may control a speed at which a screen is switched. For example, the controller 1010 may vary a speed at which a screen is switched according to a time for which a user input that drags the screen is maintained, a drag speed of the user input, and a distance by which the user input drags the screen.

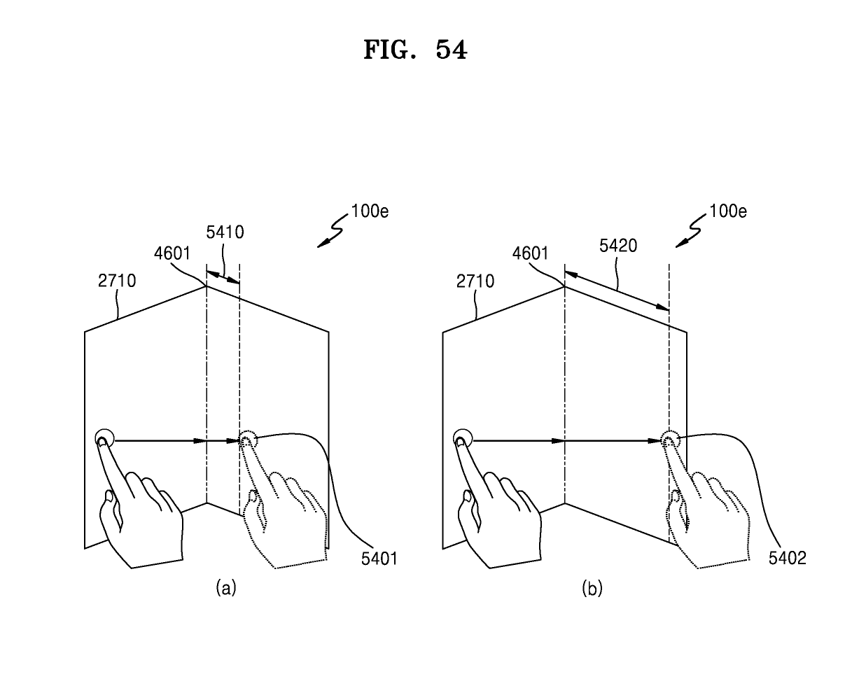

FIG. 54 is a view illustrating an example where the controller 1010 controls a speed at which a screen is switched according to a user input that passes through a folding line, according to an exemplary embodiment.

Referring to FIG. 54, the controller 1010 may cause a screen switch speed (e.g., 4 pages per second) according to a user input 5402 of (b) to be two times a screen switch speed (e.g., 2 pages per second) according to a user input 5401 of (a). This is because a distance 5420 by which the user input 5402 of (b) drags the screen past the folding line 4601 is ‘two times’ a distance 5410 by which the user input 5401 of (a) drags the screen past the folding line 4601.

Referring back to FIG. 52, when the user input passes through the folding line, the controller 1010 according to an exemplary embodiment may switch the execution screen of the application to an initial screen (i.e., a home screen of the application) of the application, a main menu screen of the application, or an exit screen of the application.

When the electronic apparatus 100e includes a plurality of folding lines, whether the user input passes through the folding line may be replaced with whether the user input passes through a specific folding line.

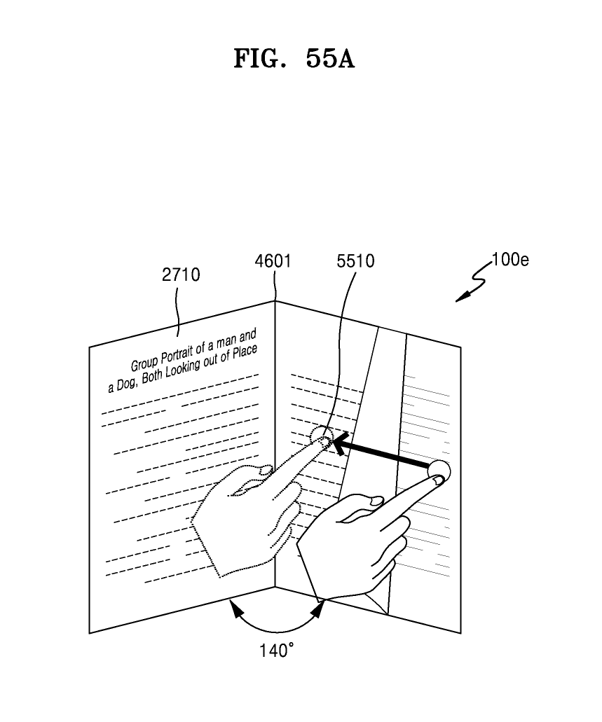

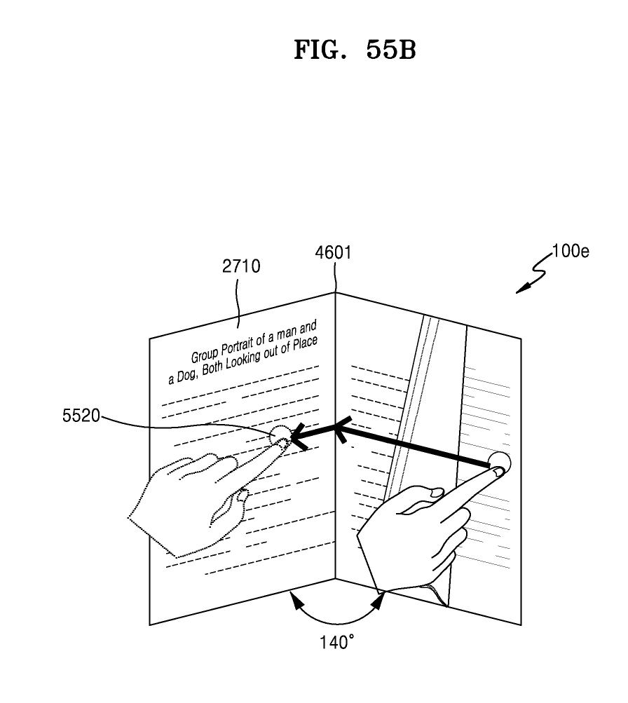

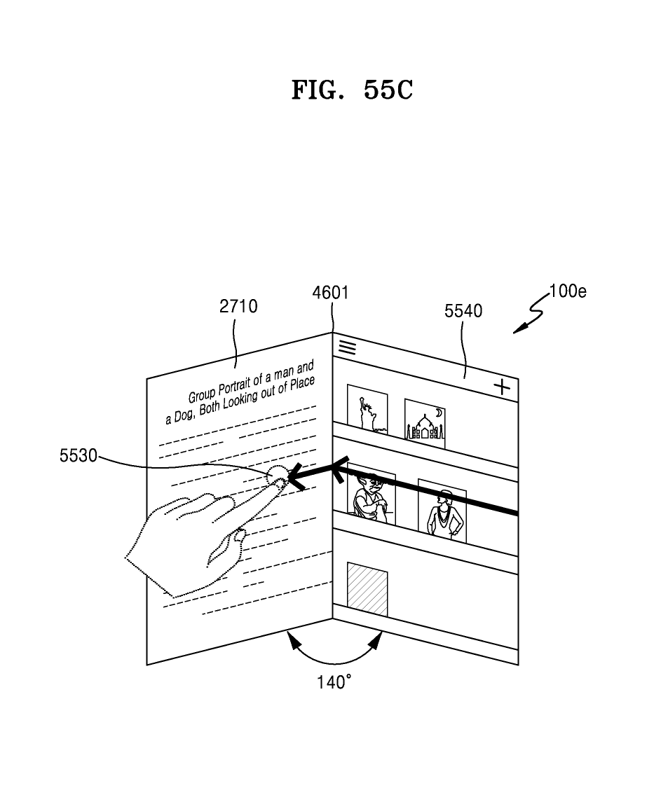

FIGS. 55A through 55C are views illustrating examples where the electronic apparatus 100e switches a screen according to a user input that is received while an e-book application is being executed, according to an exemplary embodiment. Referring to FIGS. 55A through 55C, because the electronic apparatus 100e unfolds at a critical angle or more (e.g., 140°), the electronic apparatus 100e may display an execution screen of the e-book application on an entire region of the flexible display 2710.

As shown in FIG. 55A, when a user input 5510 does not pass through the folding line 4601, the electronic apparatus 100e may display a next page of an e-book, in response to the user input 5510. In this case, when a drag direction of the user input 5510 is the opposite, the electronic apparatus 100e may display a previous page of the e-book.

Alternatively, as shown in FIG. 55B, when a user input 5520 passes through the folding line 4601, the electronic apparatus 100e may continuously display a plurality of next pages, in response to the user input 5520. In this case, when a drag direction of the user input 5520 is the opposite, the electronic apparatus 100e may continuously display previous pages.

Alternatively, the electronic apparatus 100e may display a plurality of pages (for example, 10 pages) at one time, in response to the user input 5520.

Alternatively, as shown in FIG. 55C, when a user input 5530 passes through the folding line 4601, the electronic apparatus 100e may display a home screen 5540 of the e-book. In this case, the electronic apparatus 100e may display the home screen 5540 on a predetermined region of the flexible display 2710.

FIG. 56 is a flowchart illustrating a method performed by the electronic apparatus 100e that unfolds at an angle less than a critical angle to provide an execution screen of an application, according to an exemplary embodiment.

Referring to FIG. 56, in operation S1510, the controller 100e determines whether the electronic apparatus 100e unfolds at an angle less than a critical angle. In this case, the critical angle may be an angle used by the controller 1010 to determine whether to activate or turn on an entire region of the flexible display 2710, and may be, for example, 90° or 100°. The controller 1010 may determine whether the electronic apparatus 100e unfolds at the critical angle or more based on an unfolding angle sensed by the sensor 1035.

When it is determined in operation S1510 that the electronic apparatus 100e unfolds at an angle less than the critical angle, the method proceeds to operation S1520. In operation S1520, the sensor 1035 obtains information about a user's viewing direction in which a user views the flexible display 2710. The sensor 1035 may include a viewing direction sensor for sensing the user's viewing direction. Examples of the viewing direction sensor may include a camera, an infrared camera, and an infrared LED. Also, the sensor 1035 may provide the information about the sensed viewing direction to the controller 1010.

In operation S1530, the controller 1010 activates at least one display region that is viewed by the user from among a plurality of display regions that are divided along a folding line, based on the information about the user's viewing direction provided from the sensor 1035. The controller 1010 may control an execution screen of an application to be displayed on the activated display region. In this case, a remaining region (i.e., a non-activated display region) of the flexible display may be processed as a margin in black or white, and may be turned off to not be supplied with power.

As such, the electronic apparatus 100e according to an exemplary embodiment may reduce power consumption of the electronic apparatus 100e by inactivating a display region that is not viewed by the user.

In operation S1540, the controller 1010 controls the flexible display 2710 to display the execution screen of the application on the activated display region.

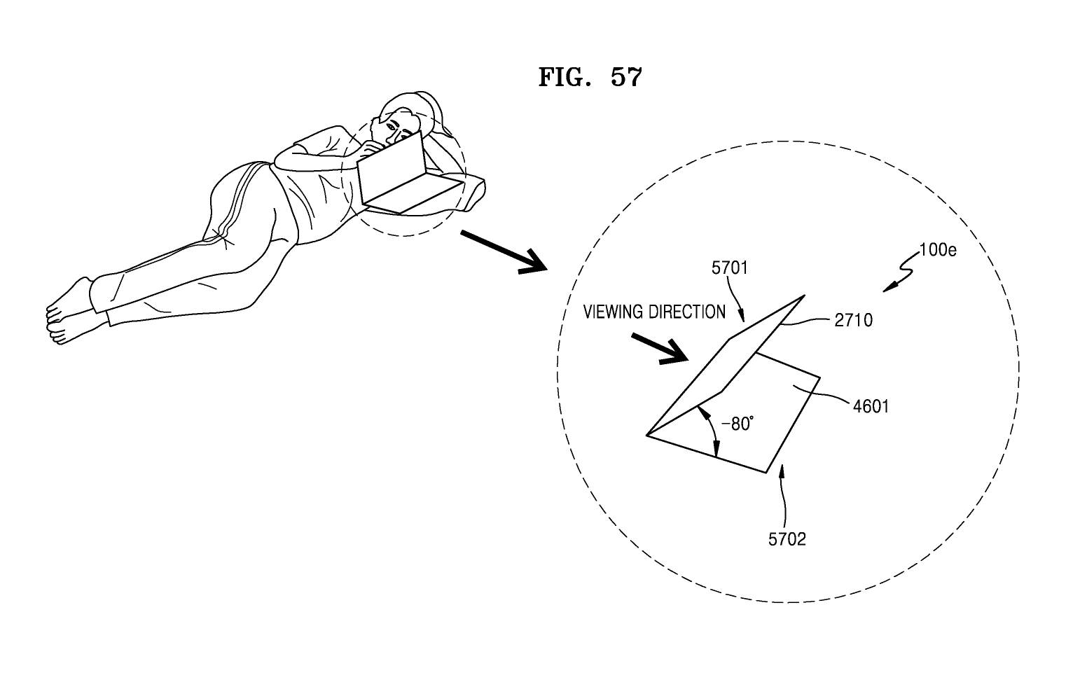

FIG. 57 is a view illustrating an example where the electronic apparatus 100e provides an execution screen of an application, according to an exemplary embodiment.

Referring to FIG. 57, a user who is lying may use the electronic apparatus 100e. In this case, the electronic apparatus 100e may unfold at an angle of about −80° with respect to the folding line 4601.

Because the electronic apparatus 100e unfolds at an angle less than 90° that is a critical angle, the electronic apparatus 100e may sense a user's viewing direction. The electronic apparatus 100e may activate a first display region 5701 from among the first display region 5701 and a second display region 5702 that are divided along the folding lines 4601, based on the user's viewing direction. In this case, the electronic apparatus 100e may inactivate the second display region 5702.

In addition, the exemplary embodiments may also be implemented through computer-readable code and/or instructions on a medium, e.g., a non-transitory computer-readable medium, to control at least one processing element to implement any above-described embodiments. The medium may correspond to any medium or media which may serve as a storage and/or perform transmission of the computer-readable code.

The computer-readable code may be recorded and/or transferred on a medium in a variety of ways, and examples of the medium include recording media, such as magnetic storage media (e.g., ROM, floppy disks, hard disks, etc.) and optical recording media (e.g., compact disc read only memories (CD-ROMs) or digital versatile discs (DVDs)), and transmission media such as Internet transmission media. Thus, the medium may have a structure suitable for storing or carrying a signal or information, such as a device carrying a bitstream according to one or more exemplary embodiments. The medium may also be on a distributed network, so that the computer-readable code is stored and/or transferred on the medium and executed in a distributed fashion. Furthermore, the processing element may include a processor or a computer processor, and the processing element may be distributed and/or included in a single device.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A foldable electronic apparatus comprising:
a display configured to be foldable;
a detector configured to detect whether the display is folded; and
a controller configured to control the display to display an interface on an accessible region of the display, in response to the detector detecting that the display is folded.

2. The foldable electronic apparatus of claim 1, wherein the detector is further configured to detect that the display is folded along a folding line so that surfaces of the display that face each other have different sizes.

3. The foldable electronic apparatus of claim 1, wherein the controller is further configured to, in response to the detector detecting that the display is folded:
activate the accessible region; and
inactivate a region other than the accessible region of the display.

4. The foldable electronic apparatus of claim 1, wherein the detector is further configured to detect a size of the accessible region, and
the controller is further configured to determine a size and a number of at least one interface element to be displayed in the interface, based on the detected size of the accessible region.

5. The foldable electronic apparatus of claim 1, wherein the interface comprises an interface element that indicates a missed call, and information about a caller of the missed call.

6. The foldable electronic apparatus of claim 1, wherein the interface comprises number interface elements for inputting a telephone number, or letter interface elements for inputting a name, and
the controller is further configured to control the display to change a number to be set in the number interface elements, or a letter to be set in the letter interface elements, based on a pressure intensity of a touch input.

7. The foldable electronic apparatus of claim 1, wherein the interface comprises an interface element that indicates address book information, and
the controller is further configured to control the display to change a speed at which the address book information is changed, based on a pressure intensity of a touch input.

8. The foldable electronic apparatus of claim 1, wherein the interface comprises an interface element that indicates an incoming call, and information about a caller of the incoming call, and
the controller is further configured to accept and block the incoming call, based on a pressure intensity of a touch input.

9. The foldable electronic apparatus of claim 1, wherein the interface comprises information about an incoming message, and
the controller is further configured to control the display to display, on the accessible region, content of the incoming message and information about a sender of the incoming message, as a pressure intensity of a touch input on the information about the incoming message increases.

10. The foldable electronic apparatus of claim 1, wherein the interface comprises at least one among a first icon that indicates time information, a second icon that indicates weather information, a third icon that indicates an alert mode, and a fourth icon that indicates a battery level of the foldable electronic apparatus, and
in response to an input selecting one among the first icon, the second icon, the third icon, and the fourth icon, the controller is further configured to control the display to display, on the accessible region, detailed information corresponding to the selected one among the first icon, the second icon, the third icon, and the fourth icon.

11. The foldable electronic apparatus of claim 1, wherein the interface comprises an interface element and a screen switch icon, and
the controller is further configured to control the display to move and change the interface element, in response to an input selecting the screen switch icon.

12. The foldable electronic apparatus of claim 1, wherein the display is further configured to receive a touch input comprising at least one among a tap gesture, a touch and hold gesture, a double tap gesture, a drag gesture, a panning gesture, a flick gesture, and a drag and drop gesture.

13. The foldable electronic apparatus of claim 12, wherein the controller is further configured to recognize the touch input, based on a pressure intensity of the touch input.

14. An interfacing method of a foldable electronic apparatus, the interfacing method comprising:
detecting whether a display of the foldable electronic apparatus is folded; and
displaying an interface on an accessible region of the display, in response to the detecting that the display is folded.

15. The interfacing method of claim 14, wherein the detecting comprises detecting that the display is folded along a folding line so that surfaces of the display that face each other have different sizes.

16. The interfacing method of claim 14, further comprising, in response to the detecting that the display is folded:
activating the accessible region; and
inactivating a region other than the accessible region of the display.

17. The interfacing method of claim 14, further comprising:
detecting a size of the accessible region; and
determining a size and a number of at least one interface element to be displayed in the interface, based on the detected size of the accessible region.

18. The interfacing method of claim 14, wherein the interface comprises an interface element that indicates a missed call, and information about a caller of the missed call.

19. The interfacing method of claim 14, wherein the interface comprises number interface elements for inputting a telephone number, or letter interface elements for inputting a name, and
the displaying comprises changing a number to be set in the number interface elements, or a letter to be set in the letter interface elements, based on a pressure intensity of a touch input.

20. The interfacing method of claim 14, wherein the interface comprises an interface element that indicates address book information, and
the displaying comprises changing a speed at which the address book information is changed, based on a pressure intensity of a touch input.

21. The interfacing method of claim 14, wherein the interface comprises an interface element that indicates an incoming call, and information about a caller of the incoming call, and
the interfacing method further comprises accepting and blocking the incoming call, based on a pressure intensity of a touch input.

22. The interfacing method of claim 14, wherein the interface comprises information about an incoming message, and
the displaying comprises displaying, on the accessible region, content of the incoming message and information about a sender of the incoming message, as a pressure intensity of a touch input on the information about the incoming message increases.

23. The interfacing method of claim 14, wherein the interface comprises at least one among a first icon that indicates time information, a second icon that indicates weather information, a third icon that indicates an alert mode, and a fourth icon that indicates a battery level of the foldable electronic apparatus, and
in response to an input selecting one among the first icon, the second icon, the third icon, and the fourth icon, the displaying comprises displaying, on the accessible region, detailed information corresponding to the selected one among the first icon, the second icon, the third icon, and the fourth icon.

24. The interfacing method of claim 14, wherein the interface comprises an interface element and a screen switch icon, and
the displaying comprises moving and changing the interface element, in response to an input selecting the screen switch icon.

25. The interfacing method of claim 14, further comprising receiving a touch input comprising at least one among a tap gesture, a touch and hold gesture, a double tap gesture, a drag gesture, a panning gesture, a flick gesture, and a drag and drop gesture.

26. The interfacing method of claim 25, further comprising recognizing the touch input, based on a pressure intensity of the touch input.

27. A computer-readable storage medium storing a program comprising instructions configured to control a computer to execute the interfacing method of claim 14.

28. A foldable electronic apparatus comprising:
a display configured to be foldable; and
a controller configured to:
control the display that is folded to display a first operating system on an accessible region of the display;
detect whether the display is unfolded; and
control the display to display a second operating system on the accessible region, in response to the controller detecting that the display is unfolded.

29. The foldable electronic apparatus of claim 28, wherein the controller is further configured to:
determine whether an angle at which the display is unfolded is greater than or equal to a value; and
control the display to display the second operating system on the accessible region, in response to the controller determining that the angle is greater than or equal to the value.

30. A foldable electronic apparatus comprising:
a flexible display;
a sensor configured to sense an asymmetrical folding of the flexible display; and
a controller configured to:
determine a dimension of the asymmetrical folding;
determine a portion of the asymmetrically folded flexible display that is accessible to a user for accepting an input, based on the dimension; and
display an interface on the portion.
